(19) United States
(12) Patent Application Publication
(10) Pub. No.: US 2024/0331883 A1
(43) Pub. Date: Oct. 3, 2024

(54) COMPACT MOBILE REACTOR SYSTEM USING HIGH DENSITY NUCLEAR FUEL

(71) Applicant: University of South Carolina, Columbia, SC (US)

(72) Inventor: Travis W. Knight, Blythewood, SC (US)

(73) Assignee: University of South Carolina, Columbia, SC (US)

(21) Appl. No.: 18/610,522

(22) Filed: Mar. 20, 2024

Related U.S. Application Data
(60) Provisional application No. 63/491,104, filed on Mar. 20, 2023.

(51) Int. Cl. G21C 7/08; G21C 7/103; G21C 15/28

(52) U.S. Cl. CPC G21C 7/08; G21C 7/103; G21C 15/28

(57) ABSTRACT

Described herein are mobile nuclear micro-reactors, systems for same, as well as methods of making mobile nuclear micro-reactors in the hundreds of kilowatt range, scalable to higher powers, capable of operating, at least, ten years without refueling while designed to eliminate fuel resupply tails that have proven so costly in conflicts over the past two decades or more.

### TECHNICAL FIELD

The subject matter disclosed herein is generally directed to mobile nuclear micro-reactors, systems for same, as well as methods of making mobile nuclear micro-reactors in the hundreds of kilowatt range, scalable to higher powers, capable of operating, at least, ten years without refueling while designed to eliminate costly fuel resupply tails that have complicated military operations over the past two decades or more.

### BACKGROUND

Most existing/newly constructed, three hundred Megawatt (MW) plus nuclear reactors are deployed at fixed locations. However, modern energy needs grow more diverse as more power needs develop and power usage expands across the globe. Most of the seventy (70) advanced nuclear reactor providers are focusing primarily on satisfying commercial (non-military) markets, which requires Nuclear Regulatory Commission (NRC) licensing approvals. Only NuScale's NRC “Design Certification” process is complete and just this process took 10 years and $500 M.

Deploying NuScale technology will still require a Detailed Design Engineering along with, a Combined Operations and Construction License which references the Design Certification, as well as contains the equivalent of an Environmental Impact Statement for eventual site deployment. Currently, the NRC is not prepared to receive and evaluate these new advanced reactor design applications. Most of the NRC's senior/experienced technical personnel recently retired or are considering retirement. The NRC will need to compete for talent along with these other 70 nuclear reactor providers.

Accordingly, it is an object of the present disclosure to develop and deliver a prototype, mobile, kW-scale nuclear reactor. “Rapid prototyping” techniques for developing a prototype reactor will be employed and focus on mobility which requires a unique, compact reactor core as well as, a unique, high density nuclear fuel. Also, satisfying military-specific requirements addressing safety, security, sustainability, scalability, resiliency, reliability, and operability.

Citation or identification of any document in this application is not an admission that such a document is available as prior art to the present disclosure.

### SUMMARY

The above objectives are accomplished according to the present disclosure by providing a mobile nuclear microreactor. The microreactor may include at least one reactor cavity cooling system at least partially surrounding at least one reactor pressure vessel, the at least one reactor pressure vessel itself including at least one active core having a plurality of hexagonal moderator blocks arranged in at least one hexagonal lattice array within the at least one active core. The plurality of hexagonal moderator blocks may have at least one hole drilled in each to contain either at least one fuel rod or at least one control rod and the at least one active core may be at least partially surrounded by at least one reflector. At least one control drum may be placed at an outer edge of the active core and the at least one control drum may include at least one neutron absorber arc. Further, the microreactor may include at least one upper plenum configured as an inlet for at least one coolant positioned above the at least one active core and at least one lower plenum configured as an outlet for the at least one coolant positioned below the at least one active core. Further, the reactor may be transportable from a first location to a second location without requiring disassembling the mobile nuclear microreactor. Still, the at least one reflector may comprise Beryllium Oxide. Further yet, the at least one coolant may comprise Helium. Still further, the at least one control drum may be configured to rotate to change position of the at least one neutron absorber arc with respect to the at least one active core to control power generation of the at least one active core. Yet again, the at least one control rod may be positioned within the at least one active core in combination with changing position of the at least one neutron absorber arc to control power generation of the at least one active core. Yet still, the at least one neutron absorber arc may comprise Boron Carbide. Further again, at least one coolant riser may be contained within the reactor pressure vessel. Still further, at least a subset of the plurality of hexagonal moderator blocks may define at least one annular channel configured to allow coolant to flow within the hexagonal moderator blocks containing the at least one annular channel. Further yet again, the at least one active core may be formed into at least two discrete sections with each discrete section having a unique Uranium-235 enrichment.

The disclosure also provides a method of making a mobile nuclear microreactor. The method may include configuring at least one reactor cavity cooling system to at least partially surround at least one reactor pressure vessel, configuring the at least one reactor pressure vessel to comprise at least one active core, arranging a plurality of hexagonal moderator blocks in at least one hexagonal lattice array within the at least one active core, forming at least one hole in each of the plurality of hexagonal moderator blocks to contain either at least one fuel rod or at least one control rod, at least partially surrounding the at least one active core with at least one reflector, placing at least one control drum at an outer edge of the active core, configuring the at least one control drum to include at least one neutron absorber arc, configuring at least one upper plenum as an inlet for at least one coolant and positioning the at least one upper plenum above the at least one active core; and configuring at least one lower plenum as an outlet for the at least one coolant and positioning the at least one lower plenum below the at least one active core. Still further, the method may include configuring the reactor as transportable from a first location to a second location without requiring disassembling the mobile nuclear microreactor. Still again, the at least one reflector may be comprised of Beryllium Oxide. Further yet, the at least one coolant comprises Helium. Again still further, the method may include configuring the at least one control drum to rotate to change position of the at least one neutron absorber arc with respect to the at least one active core to control power generation of the at least one active core. Moreover, the method may include positioning the at least one control rod within the at least one active core in combination with changing position of the at least one neutron absorber arc to control power generation of the at least one active core. Further yet still, the at least one neutron absorber arc may comprise Boron Carbide. Still again, the method may include configuring at least one coolant riser within the reactor pressure vessel. Even further, at least a subset of the plurality of hexagonal moderator blocks may be configured to define at least one annular channel configured to allow coolant to flow within the hexagonal moderator blocks containing the at least one annular channel. Further yet still, the at least one active core may be formed into at least two discrete sections with each discrete section having a unique Uranium-235 enrichment.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows Table 1, microreactor characteristics.

FIG. 2 shows one example of a microreactor of the current disclosure on a semi tractor-trailer.

FIG. 3 shows a top view (left) and side view (right) of a microreactor of the current disclosure.

FIG. 4 shows a 3D plot of a packet of neutrons.

FIG. 5 shows the effect of reactivity control on radial neutron flux distribution.

FIG. 6 shows an integral control rod (or drum) worth.

FIG. 7 shows a differential control rod (or drum) worth curve.

FIG. 8 shows axial and radial power peaking observed in the fuel rod and the reactor core, respectively.

FIG. 9 shows a schematic of fuel rod temperature distribution.

FIG. 10 shows a plot of temperature distributions in a fuel rod.

FIG. 11 shows temperature distributions along a reactor axis with uniform power

FIG. 12 shows temperature distributions along channel with (A) sine and (B) cosine power.

FIG. 13 shows prior art reactor designs: (a) Air-cooled RCCS design for the GT-MHR and MHTGR (b) Water-cooled RCCS design for the SC-HTGR.

FIG. 14 a graph of the decay of heat power level.

FIG. 15 shows a mobile reactor of the current disclosure with its core surrounded by reflector materials.

FIG. 16 a hexagonal lattice structure of solid-pin fuel assembly in the active core of a reactor of the current disclosure.

FIG. 17 shows an active core of a reactor of the current disclosure.

FIG. 18 an axial view of fuel column distribution for a reactor of the current disclosure in the core (left) and fuel column unit cell (right).

FIG. 19 shows a cut view of fuel column unit cell for a reactor of the current disclosure comprising fuel, gap, cladding, coolant, moderator, and lattice support.

FIG. 20 shows BeO reflectors surrounding a BeO core moderator of a reactor of the current disclosure.

FIG. 21 shows a cut view of a BeO reflector and moderator for a reactor of the current disclosure.

FIG. 22 shows a reactivity control system of the current disclosure.

FIG. 23 shows a primary shutdown mechanism with redundant reactivity control for a reactor of the current disclosure.

FIG. 24 shows a secondary shutdown mechanism with redundant reactivity control for a reactor of the current disclosure.

FIG. 25 shows a reactor of the current disclosure at full power operation mode with all control devices in their out position.

FIG. 26 shows an axial (left) and radial (right) see-through view of a reactor of the current disclosure.

FIG. 27 shows height and thickness of various parts of a reactor of the current disclosure.

FIG. 28 shows diameters of various parts of a reactor of the current disclosure.

FIG. 29 shows Table 2, base design for a reactor of the current disclosure.

FIG. 30 shows Table 3, core radial power density flattened for the current disclosure.

FIG. 31 shows Table 4, parametric cases analyzed (core radial power density not flattened).

FIG. 32 shows Table 5, unit cell geometry description for a reactor of the current disclosure.

FIG. 33 shows hexagonal lattice structure of annular-pin fuel assembly in active core (top) and a unit fuel assembly geometry and material specifications (bottom) for a reactor of the current disclosure.

FIG. 34 shows an axial midplane cross-section view of the fuel rod in MINION solid_pellet (top) and MINION annular_pellet (bottom) design.

FIG. 35 shows a MINION LEU_fuel core geometry including the side reflectors for one embodiment of the current disclosure.

FIG. 36 shows a MINION LEU_fuel primary shutdown mechanism with redundant reactivity control.

FIG. 37 shows a MINION LEU_fuel secondary shutdown mechanism with redundant reactivity control.

FIG. 38 shows a MINION LEU_fuel in full power operation mode with all control devices in their out position.

FIG. 39 shows Table 6, MINION LEU_fuel design summary.

FIG. 40 shows plots of thermal conductivity, heat capacity, and centerline temperature of UC, UN, and UO₂ as a function of temperature.

FIG. 41 shows swelling of UC as a function of average centerline irradiation temperature.

FIG. 42 shows radar charts showing arbitrary multivariate presentation for each design of the current disclosure.

FIG. 43 shows Table 7, simulation runtime depending on initial neutron distribution scheme.

FIG. 44 shows Table 8, core specific power calculations for MINION solid_pellet.

FIG. 45 shows Table 9, core specific power calculations for MINION annular_pellet

FIG. 46 shows Table 10, core specific power calculations for MINION solid_pellet (4.95% enriched).

FIG. 47 shows optimization of power density for radial power peaking for a reactor of the current disclosure.

FIG. 48 shows graphs of parametric analysis results of varying the cladding material and thickness, the reflector thickness, and the number of fuel rods in the core.

FIG. 49 shows Table 11, summary of the mesh cells in the fuel units.

FIG. 50 shows Table 12, mesh independence study summary for a single fuel cell.

FIG. 51 shows a diagram of plena introduced to the full-core model (left) to enable mixing of coolant (right: coolant velocity contour plot) after it has passed through the individual coolant channels with different densities and to accurately model gravity-driven free convection expected in a transient scenario.

FIG. 52 shows a graph of expected decay heat in MINION at BOL and EOL.

FIG. 53 shows illustrations of midplane cross section view of fluid velocity scalar (a) and vector (b, c, d) scenes seen in MINION coolant channels under free convection.

FIG. 54 shows Table 13, MINION mesh cells summary.

FIG. 55 shows Table 15, reactivity feedback of temperature for fuel.

FIG. 56 shows Table 16, reactivity feedback of temperature for moderator.

FIG. 57 shows Table 17, reactivity feedback of temperature for reflector.

FIG. 58 shows Table 18, results of reactor core reactivity.

FIG. 59 shows Table 19, estimated critical position (ECP) to determine drum/rod insertion limits (RIL).

FIG. 60 shows Table 20, reactivity change (+/−0.0015) as a function of drum movement.

FIG. 61 shows Table 21, reactivity change (+/−0.0015) as a function of rod movement.

FIG. 62 shows Table 22, summary of the base/final design, also referred to as MINION_{solid_pellet} design (UC—He—SiC—BeO) with the core radial power density flattened.

FIG. 63 shows Table 23, core radial power density flattened designs.

FIG. 64 shows Table 24, Reactor core reactivity results for MINION_{annular_pellet} and MINION_{LEU_fuel}.

FIG. 65 shows Table 25, parametric cases analyzed (core radial power density not flattened).

FIG. 66 shows Table 26, location of line probes reporting vertical temperature in various reactor parts.

FIG. 67 shows Table 27, nominal steady-state operational parameters and their average values.

FIG. 68 shows Table 28, steady-state operational parameters and their maximum values in the solid regions.

FIG. 69 shows Table 29, nominal steady-state operational parameters and their average values.

FIG. 70 shows, Table 30 normal operational parameters and their maximum values in the solid regions.

FIG. 71 shows, Table 31 nominal steady-state operational parameters and their average values.

FIG. 72 shows, Table 32 steady-state operational parameters and their maximum values in the solid regions.

FIG. 73 shows, Table 33 reactor parameters and their average and maximum values at t=100 hr for a PLOFC event.

FIG. 74 shows, Table 34 reactor parameters and their average and maximum values at t=100 hr for a DLOFC event.

FIG. 75 shows Table 35, reactor parameters and their average and maximum values at t=100 hr for an air ingress event.

FIG. 76 shows Table 36, reactor parameters and their average and maximum value at t=100 hr for a PLOFC, DLOFC, and air ingress event.

FIG. 77 shows Table 37, helium material properties definition.

FIG. 78 shows Table 38, thermal conductivity and temperature relationship of BeO.

FIG. 79 shows Table 39, thermal conductivity and temperature relationship of SiC.

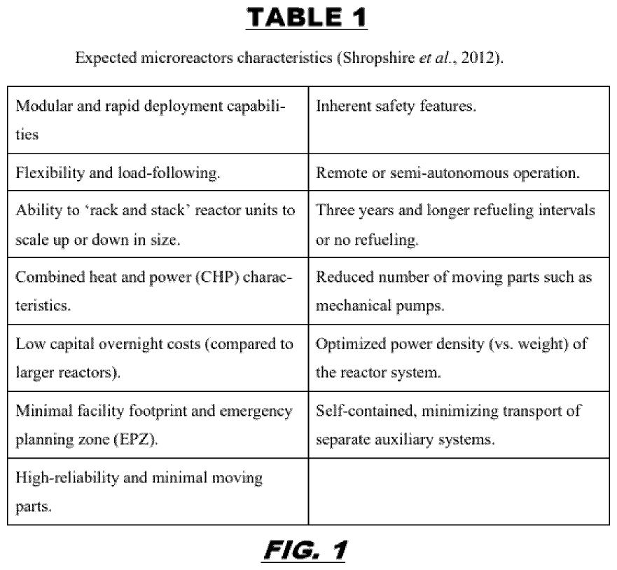

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ′y″’, where ‘x’ and ‘y’ are numerical values, includes “about ‘x’ to about ′y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a” “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +1-5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the compact reactor systems described herein can be presented as a combination kit. As used herein, the terms “combination kit” or “kit of parts” refers to the compact reactor systems, fuels, compounds, compositions, formulations, and any additional components that are used to package, sell, market, deliver, and/or provide the compact reactor systems of the current disclosure, such as the fuel and compact reactor systems described herein. Such additional components include, but are not limited to, packaging, housings, fuel rods/systems, couplings, and the like. When one or more of the compact reactor systems, fuels, compounds, compositions, particles, described herein or a combination thereof (e.g., fuel components) contained in the kit are provided simultaneously, the combination kit can contain the compact reactor and necessary accoutrement equipment in a single product or in separate products. When the compact reactor systems, fuels, compounds, compositions, particles, described herein or a combination thereof and/or kit components are not provided simultaneously, the combination kit can contain each agent or other component in separate packaging combinations. The separate kit components can be contained in a single package or in separate packages within the kit.

In some embodiments, the combination kit also includes instructions printed on or otherwise contained in a tangible medium of expression. The instructions can provide information regarding the content of the mobile reactor packages, fuel materials, safety information regarding the content of the compounds and fuel materials, information regarding maintenance, safety, indications for use, and/or recommended operation regimen(s) for the compact reactors and fuel materials contained therein. In some embodiments, the instructions can provide directions and protocols for activating and using the compact nuclear reactor and fuel materials described herein.

The current disclosure provides mobile nuclear micro-reactors in the hundreds of kilowatt range and scalable to higher powers capable of operating, at least, ten years without refueling. These micro-reactors are designed to address global climate, non-CO₂ emitting energy needs while first enhancing the military's agility, survivability and mission reach for joint forces thereby reducing/eliminating the fuel resupply tail that has proven so costly in terms of both numbers of casualties and commitment of logistics support assets over the past two decades or more.

The mobile reactors of the current disclosure provide a truly mobile, sustainable, safe, resilient, reliable, affordable, and non-CO₂ emitting power source for providing energy within initially “permissive environments” (e.g. humanitarian missions, disaster relief and storm restoration efforts) and for enhancing military facilities' energy security, surety of supply, and grid resiliency while also, if eventually required, for ‘Semi-Permissive or Non Permissive Environments” (combat conditions).

The following definitions are provided for this disclosure:

Mobile is defined as “able to move or be moved freely, easily and quickly”

“Mobile” as opposed to “transportable” and “stationary”: Transportable is defined as “able to be carried or moved”. Stationary means “permanently fixed and not capable of being moved”.

Conceptual design and preliminary safety analysis of a proposed helium-cooled Micro Nuclear reactor In ONe megawatt (MINION) thermal output is done through three-dimensional computational analysis. Compared with the conventional high temperature gas-cooled reactors (HTGR) that use tri-structural or bi-structural isotropic (TRISO or BISO) fuel particles, MINION uses traditional clad fuel pellets. This greatly simplifies the core design and allows for a substantially more compact design thanks to the fuel's significantly higher U-235 atom density. Uranium carbide (UC) enriched up to 19.75% in U-235 is used as fuel. In the power-flattened design, U-235 enrichment varies radially between 19.75% and 10.5% in four concentric rings. An additional design is investigated that uses 4.95% enriched U-235. A variety of reactor materials have been investigated. The reference design uses a combination of UC as fuel, SiC as cladding, BeO as moderator and reflector, and He as coolant. The Pareto optimization methodology is used to optimize reactor core design in a multi-dimensional trade space of competing parameters. The final reactor is 2 m tall, including the reactor pressure vessel (RPV). The reactor core is a 0.96 cm³ right circular cylinder with the axial and radial reflector components. Six control drums and four control rods ensure redundant reactivity control to satisfy the single failure criterion (SFC) and to provide defense-in-depth (DiD). The core has a lifetime of at least 10 years with enough excess reactivity. Full-core neutronic and thermal-hydraulic simulations done using nuclear safety analysis and design modeling suite SCALE and computational fluid dynamics (CFD) code STAR-CCM+ modeled fuel depletion, heat generation, v and heat transfer performance in a soft-coupled iterative manner. Thermal energy generation is modeled for individual fuel rods to account for the hot channel factor (HCF) as well as the power peaking factor (PPF). MINION operates at the lower end of the typical HTGR operating pressure (3 MPa) to ensure increased safety and portability for mobile applications. During nominal operation, an average coolant inlet mass flow rate of 0.557 kg/s provides an average coolant exit temperature of 670° C. At the steady state, the maximum allowable cladding temperature is maintained at ˜1000° C., resulting in a peak fuel centerline temperature of ˜1250° C. An additional design is investigated using annular fuel pellets to improve the bulk coolant exit temperature. This modification led to a 15% increase in coolant exit temperature (760° C.). Failure modes and effects analysis (FMEA) is carried out by investigating pressurized and depressurized loss of forced cooling (PLOFC and DLOFC) and air ingress accident scenarios under the influence of decay heat. The low power density (6 W/cc) of MINION, along with the large thermal inertia provided by the beryllia moderator and reflector, as well as the large surface-to-volume ratio of the core ensure passive removal of decay heat through conduction and radiation. The peak fuel and cladding temperature do not exceed their nominal operating values at any point during the transient events. Thus, no external cooling mechanism is required for MINION under postulated accident scenarios, equipment failures, or malfunctions.

Advanced reactors are often referred to as “Generation IV” nuclear technologies, as opposed to commercial reactors constituting “Generation III” or “Generation III+” for the most recently constructed reactors. According to the legislation enacted in the US in 2018 (P.L. 115-248), an advanced nuclear reactor is “a nuclear fission reactor with significant improvements over the most recent generation of nuclear fission reactors,” or a reactor using nuclear fusion. Many of these advanced designs are considered small modular reactors (SMRs), which the US Department of Energy (DOE) defines as reactors with an electricity generating capacity of 300 MW and below, in contrast to an average of about 1,000 MW for existing commercial reactors.

Traditionally, nuclear power is generated using light water reactors (LWR) to heat water and create steam to drive a turbine. However, these water-cooled and water-moderated reactors have inherent limitations leading to low thermal output and safety concerns. With the 1979 Three Mile Island (TMI) nuclear accident in the US, the 1986 Chernobyl nuclear accident in Russia, and the 2011 Fukushima Daiichi nuclear accident in Japan, nuclear reactors with inherent safety features have become a significant design consideration. The advanced nuclear reactor concept extends beyond the traditional reactor concept, offering the opportunity for safer, cheaper, and more efficient generation of emissions-free electricity, as well as heat for industrial processes. Advanced nuclear reactors usually operate at lower and safer pressure levels due to the special coolants they use. Additionally, they can utilize passive safety mechanisms instead of relying on active safety features that rely on backup power or human intervention to function. This passive safety system in advanced reactors enables them to withstand broader accident conditions without causing damage. Higher burn-up, along with the application of helium and supercritical CO₂ Brayton thermal cycle, has allowed for power generation with much-improved conversion efficiency and reduced plant size. Some advanced reactors convert up to 95% of the energy in the fuel to usable electricity (traditional reactors convert less than 5%). This increased energy efficiency of many advanced reactors results in less nuclear waste. Additionally, the waste created can be less toxic and may remain toxic for a shorter period. Advanced reactors also resolve some key feasibility and performance challenges and reduce fabrication, construction, and operating costs. While conventional nuclear reactors are typically built on-site, many small advanced nuclear reactors can be built in a factory and transported to the installation site. Constructing certain types of reactors in a factory could enable quicker manufacture and deployment than traditional reactors, which may be crucial in achieving low carbon energy generation objectives. The US DOE supports a variety of advanced reactor designs, including gas, liquid metal, molten salt- and heat pipe-cooled concepts. In 7 2001, the Generation IV International Forum formulated a roadmap that identified Generation IV technologies, i.e., advanced nuclear technologies, as “a system with potential for near-term economic development compatible with advanced electricity and hydrogen production, and high-temperature process-heat applications.” Innovative technology concepts like this are crucial to achieving the world's greenhouse gas emissions aspirations reliably.

Typically defined as a subset of advanced non-light water reactors, microreactors are an exciting concept that offers a combination of reliability and operational flexibility that no other small power-generating systems can match (microreactors are 100 to 1,000 times smaller than conventional nuclear reactors). According to International Atomic Energy Agency (IAEA), microreactors are considered to have a capacity of less than 20 MWe. According to the US DOE (ONE, 2022), microreactors are identified by having three characteristics: factory fabricated, transportable, and self-adjusting. Microreactors address many, if not all, drawbacks that have made traditional nuclear reactors unpopular or inconvenient. Along with their inherent safety features as an advanced nuclear reactor, the amount of radioactive material from a microreactor is much less. The capital investment for microreactors is much less than for a conventional nuclear power plant. The physical footprint of a microreactor is much smaller. The modular construction of microreactors would appear to be less intrusive than the construction of a shopping mall. If multiple microreactors are operating at one site, a single reactor failure would not significantly impact other reactors operating at the same site. Whether located at the same site or different sites, using identical microreactor modules would simplify the Nuclear Regulatory Commission's (NRC) approval process for additional microreactors. Due to their simplified control systems and modular construction, the period from final approval to having the reactor on the grid could be under 12 months.

Microreactors can operate as part of the electric grid, independently from the electric grid, or as part of a microgrid for 10-20 years without refueling. They are being designed to be transported in standard 40-foot containers (like CONEX Boxes) that are frequently used in commerce via road, rail, barge, or air. Due to their modular construction, all major components of microreactors can be assembled off-site and then transported to the operational site for final assembly. Additionally, microreactors can be quickly removed from their installation sites and replaced with new ones. Such reactors will be particularly helpful to remote, rural communities that fly or truck in diesel to run generators and for an emergency response to restore power to areas hit by natural disasters. The Nuclear Alternative Project (NAP) considered microreactor designs for application in Puerto Rico (NAP, 2020). The US Department of Defense (DOD) is actively pursuing the microreactor concept, as its military operations become more energy-intensive and require portable, dense power sources.

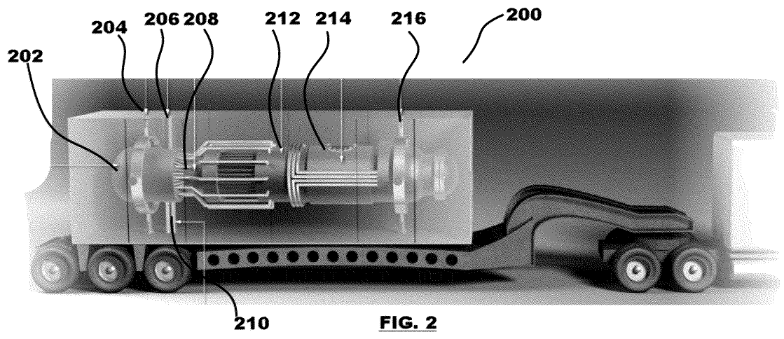

FIG. 2 shows one example of a microreactor of the current disclosure on a semi-tractor-trailer. Reactor 200 may include heat dissipater 202, first shock absorbent mount 204, heat outlet 206, turbine 208, electrical output 210, heat exchanger 212, reactor 214 and second shock absorbent mount 216.

This disclosure aims to provide the conceptual design, performance analysis, and benchmark of a well-defined helium-cooled MIcro Nuclear reactor In ONe megawatt (MINION) thermal output. This requires determining the dimensional and operational parameters of the reactor, such as reactor core size, fuel rod pitch, fuel rod dimension, cladding thickness, coolant flow area, coolant flow rate, flow current type, coolant inlet and outlet temperature, operating pressure, cycle choice accurately. Since the individual component performance interacts strongly with the steady-state and transient performance of the design, the overall behavior must be adequately understood. This will be accomplished by combining neutronic and thermal-hydraulic (TH) codes and studying the power generation and heat transfer profile through three-dimensional (3D) computational analysis.

### Design Objective

### (1) Compact Design—as Small and Lightweight as Possible

A small reactor core is helpful for various reasons. A smaller core means smaller reactor mass, smaller shielding mass, easier handling, and enhanced transportability, eventually leading to lower costs. Specific design objectives include designing a core no larger than 100 cm tall or wide.

### (2) Use of HALEU Fuel, i.e., 10-20% U-235 Enriched Fuel

The high assay low enriched uranium (HALEU) fuel increases the plant capacity factor by increasing the core lifetime, thereby decreasing fuel supply costs, and reducing the levelized cost of electricity (LCOE). HALEU poses a decreased security and proliferation risk, reducing the licensing process time and cost. The reduced concentration of U238 in fresh fuel, thereby reducing contents of Pu-239 and Pu-241 in HALEU's higher burnup spent nuclear fuel (SNF), can benefit nonproliferation. The prolonged core lifetime is expected to decrease high-level radioactive waste (HLW) in the form of SNF. The decay heat of HALEU fuel is estimated to be lower than that of less enriched fuel, mainly due to a reduction in fissile material in higher burnup fuel. HALEU provides a negative Doppler reactivity coefficient, providing the most rapid reactivity compensation.

### (3)>10 Years Core Life.

A long core life, i.e., the time a reactor is operational without refueling and contains sufficient reactivity to maintain 100% rated thermal power, is beneficial for several reasons. It increases the plant's capacity factor, eliminates the concern for an outage, and reduces spent fuel handling, thus increasing the probability of fuel handling and movement accidents. Less refueling also means fewer dose limits at the exclusion area boundary (EAB). Sufficient initial excess reactivity is crucial for achieving the core 13 design lifetime goal, as it maintains core criticality at full power operating conditions by compensating for the depletion of the fissile material and the neutron absorption properties of the fission products (FPs)

### (4) Use of Mature Technology

Incorporating existing and mature technology into the design has a two-fold benefit—not only does it lower the design and manufacturing cost, but it also paves the way for minimum licensing hurdles. The gap between the design state-of-the-art and regulatory state-of-the-art is less likely to become a limiting factor if the technology is a proven one.

### (5) Economically Competitive Design

Competitive Costs are Necessary for the Success of Microreactors and Nuclear Reactors in general. Studies have shown that microreactors will face immense challenges competing for energy shares in centralized markets. Thus, achieving deep penetration in markets will mean achieving specific aggressive cost targets for microreactors. Using existing technology or technology that can be satisfactorily established has the potential to lower the cost of a microreactor. If the microreactors can use key components from readily available technology (e.g., LWR fuels), this will substantially reduce the cost.

### (6) Safe Design

Sufficient shutdown margin is essential for achieving a safe subcritical condition. The minimum shutdown margin (SDM) under normal operating conditions makes the core subcritical rapidly enough to prevent exceeding acceptable fuel damage limits. Additionally, a safe subcritical condition accounts for the prohibited or unintended motion of individual control drums or control rods, which can excite convergent azimuthal power oscillations in the reactor core. Therefore, a minimum SDM according to the core operating limits report (COLR) is required for all modes of plant operation: power operations, startup, hot standby, hot shutdown, cold shutdown, and refueling conditions. Additionally, the design can be deemed safe and reliable if the reactor can cool itself down without overheating and without human intervention during anticipated operational occurrences and postulated accident conditions.

### (7) State-of-the-Art Design

The designs of nuclear reactors are constantly undergoing improvement and modernization. The advanced nuclear reactor design concept promotes exploring alternative reactor designs and state-of-the-art techniques and approaches. This research aims to develop a state-of-the-art design with an economical, robust, well-defined safety envelope based on best-practice guidelines, well-documented codes, models, and standards. In conjunction with the larger scientific community, this research aims to enable the design and analysis of nuclear microreactors to facilitate the contribution of advanced nuclear reactors to a clean energy future.

### Analysis Objective

Detailed analysis of reactor performance is needed to support the safety of reactor operations. Performance analysis of MINION involves providing an understanding in the following key areas.

### (1) Knowledge Base

Determining the detailed physics and conditions of the reactor system and providing adequate knowledge of the heat generation and heat transfer profile in the reactor core under normal and accident conditions.

### (2) Performance

Evaluating the core's steady state TH behavior under forced convection cooling. Specific objectives include studying conditions under which the reactor ensures maximum performance while operating within the safety limit. This will include scoping the viability of different design approaches and reactor materials. The specific thermal performance goal during nominal operation includes achieving a coolant exit temperature of >600° C.

### (3) Safety

Determining the extent to which heat transfer failure will compromise the reactor's safe operation based on limits approved by the regulatory authority. Failure scenarios of interest include pressurized and depressurized loss of forced circulation (PLOFC and DLOFC) followed by an air ingress event. The reactor is assumed to be in a vertical position, standing upright, or in a horizontal position, lying on its side during the accident events.

### Model Development Path

In order to establish the technical basis for MINION, physics design and performance modeling of the critical reactor parts are needed. This is accomplished by conducting the proposed design's neutronic and TH analysis. First, the design parameters are benchmarked based on comparable experimental and modeled data. Once a baseline design is established, criticality and depletion calculations are done to confirm the design's neutronic feasibility and core performance. Heat transfer characteristics of the Pareto optimal design are evaluated under normal operating conditions. The steady-state temperature distribution across the core is then incorporated into the neutronic model to account for reactivity feedback of temperature. The initial design is subsequently re-optimized for neutron transport, and the updated geometry information is fed back into the TH model. This soft and iterative coupling between the neutronic and TH models allowed for a mapping between the neutron transport and the TH schemes. Simple coupling, such as this, can provide powerful insight into the interplay between neutron transport, fluid dynamics, and heat transfer phenomena and the overall behavior of the system, while fully resolving the non-linear nature of the coupling terms appearing in the equations solved by each code. The following computer codes are used.
(1) SCALE code system's Monte Carlo (MC) code KENO for eigenvalue neutronic calculations such as neutron transport and flux distributions.
(2) SCALE code system's 3D depletion sequence TRITON for fuel depletion calculations.
(3) Fluid dynamics analysis code STAR-CCM+ for TH calculations.

### High Temperature Gas Cooled Reactors

The history of gas-cooled reactors dates to the early days of nuclear energy development. From the beginning, the greater benefits of gas-cooling were recognized for achieving higher gas temperatures, thereby permitting more highly efficient electricity production. The goal was later coupled with the vision that such higher gas temperatures could lead to even broader nuclear energy applications, such as industrial process heat for hydrogen production, and low-temperature applications, such as district heating and seawater desalination. This potential for efficient electricity generation and CHP generation, or cogeneration, applications propelled the development of the HTGRs. Most of the early developments were focused on relatively low-temperature systems using graphite moderators, metal-clad fuel, and CO₂ coolant. Commercial deployment of such reactor systems started in the mid-1950s, primarily in the United Kingdom (UK) and France. Development work on HTGRs started in the US and the Federal Republic of Germany in the mid-1950s, as a result of effective cooperative agreements between the governments and industrial entities. However, the first HTGR prototype, Dragon, was built in the UK. The first commercial gas-cooled power reactor, Magnox, operated in the UK in 1956. These graphite moderated reactors used natural uranium metallic fuel clad in a magnesium alloy and were cooled by circulating CO₂ at 0.8 MPa with an outlet temperature of 335° C. The Magnox 18 reactors had a low power density of 0.1 to 0.5 MWe/m³. The first prototype was built in 1962 in the UK, and it produced 32 MWe. The reactor went critical in 1964. In March 1976, the reactor was decommissioned after a long full power operation. The Dragon reactor was built to test fuel, fuel elements, and structural materials for HTGRs. The reactor's success led to more HTGR designs in Europe, the US, and Japan. The rest of the Magnox reactors were built in the 1970s and 1980s and generated approximately 600 MWe per reactor. To improve the thermodynamic efficiency and fuel utilization of the Magnox reactors, advanced gas-cooled reactors (AGRs) were developed. Compared to the Magnox reactor, the AGRs used more enriched fuel, had higher power density, higher burnup rate, and were 10% more efficient. The 2.5% enriched UO2 fuel in the AGRs led to outlet temperature increases to 675° C. from the 350 to 400° C. of the Magnox reactors. Like Magnox, the AGRs used CO₂ as a primary coolant. Based on the experiences of Magnox and AGR reactors, corrosion of steel components due to CO₂ and carbon corrosion by CO₂ remain as areas of concern (Melse & Katz, 1984). Twenty-six Magnox reactors and fourteen AGRs have been constructed in the UK, and eight Magnox reactors in France (Melse & Katz, 1984; Brey, 2000). The two pioneering programs with some of the early Magnox stations are no longer operational. The final AGR stations at Heysham-2 and Torness have recently been put into service. The first HTGR prototype in the US was Peach Bottom Unit 1, which achieved criticality in 1966 and went into commercial operation in 1967 but was decommissioned in 1974. Germany built its first HTGR, the AVR, which operated from 1966 to 1988, and then built the THTR-300, which connected to the electrical grid in 1985 but shut down permanently in 1989. The US built its second HTGR, Fort St. Vrain, which generated electricity from 1976 to 1990, but was shut down due to problems with the helium 19 circulator. Japan and China have also built and currently operate HTGR test reactors. The Japanese HTTR achieved criticality in 1998, and the Chinese HTR-10 achieved its first criticality in 2000. Many HTGR research and development projects are ongoing in member states of the European Union (EU), Kazakhstan, Indonesia, South Africa, Russia, Japan, China, and the US.

The second generation of gas-cooled reactors, known as high-temperature reactors (HTR), was also aimed at development rather than deployment. This resulted in the construction of various HTR prototypes and demonstration plants in Germany, Britain, and the US. The focus of these plants was on gradual improvements in coolant exit temperature and plant efficiency. HTRs used chemically inert helium as a coolant and graphite as its moderator. Furthermore, the early HTRs utilized particle fuel, which uses ceramic coatings to contain FPs at high temperatures, as a significant characteristic. The combination of ceramic fuel, graphite core structure, and inert helium allows extremely high operating temperatures. The unique ability of this coated particle fuel was later employed in the design of modular HTGRs (MHTGR), such as the HTR module in Germany and the MHTGRs in the US. The MHTGR concept was proposed in the early 1980s with a deliberate decrease in the power level and reconfiguring of the reactor. Between 1963 and 1991, Russia conceptualized three MHTGRs with detailed designs: 136 MWt VGR50, 1060 MWt VG400, and 200 MWt VGM. A joint US-Russian Federation program worked on developing the 600 MWt/286 MWe Gas Turbine-Modular Helium Reactor (GT-MHR) project for burning weapon-grade plutonium (LaBar, 2002; Kiryushin & Kodochigov, 2002). Another commercial MHTGR was developed by ESKOM in South Africa—Pebble bed modular reactor (PBMR) (Kumar et al., 2000) with 265 MWt/116.3 MWe power output.

### Microreactors

Nuclear microreactors originated in the United States Navy's nuclear submarine project in 1939 (USNRL, 2000). The concept was proposed by Ross Gunn of the United States Naval Research Laboratory and adapted by Admiral Hyman Rickover. The first US nuclear submarine, USS Nautilus, launched by Admiral Rickover in 1955, had a 10 MWe pressurized water type reactor—Westinghouse's S2W reactor (Nautilus, 2018). The US also developed its space nuclear reactor in the 50s. The main milestone of the US program was the 43 KWt SNAP-10A launch in 1965, which operated for 43 days (IAEA, 2005). The Soviet Union, however, was the leader in space reactor utilization until the late 1980s, launching 34 cosmos spacecraft powered by 32 BUK and 2 TOPAZ reactors between 1970 and 1988. Today, the US is the leading nuclear energy developer for space exploration. Several US laboratories are conducting research and development efforts to establish a permanent base on the Moon and launch a human-crewed mission to Mars. In 2018, NASA successfully demonstrated a kilowatt-scale microreactor based on its Kilopower technology, which uses airtight heat pipes to transfer reactor heat to engines that convert the heat to electricity (IAEA, 2006). Commercial microreactors are at the earliest stage of their development. More than ten companies are working on different microreactor designs. These designs feature different heat removal systems, such as heat pipes, and novel forms of fuel, such as TRISO fuel particles, that have not previously been licensed. These concepts are mainly at the preliminary stages of the design process, and little information is available. The US DOD scheduled the deployment of the first microreactor by the end of 2027 (NEI, 2018). It has been estimated that the realization of the first microreactor, from license application to commercial operation and power generation, will likely take 5 to 10 years. Only five of these reactors use helium as coolant: 3-100 MWe Holos Generators, 1 MWe Xe-Mobile, 4 MWe U-Battery, 5 MWe Micro Modular Reactor (MMR), and 1-5 MWt Pylon.

MHTGR Vs. Minion

### Power Output and Core Life

All commercial-scale HTGRs to date had a thermal output of more than 100 MW. Only five helium-cooled microreactors (MHTGR) with a power output of <10 MWe (<˜30 MWt) are currently at an advanced design stage. Compared to these MHTGRs, MINION is the most compact design with a comparable core life

### Core Type and Fuel Type

HTGRs have two principal designs: the pebble bed and the prismatic block. The pebble bed technology uses ceramic fuels, typically oxides or carbides that are contained in spherical graphite pebbles. The pebbles are smaller than the size of a tennis ball and are made of pyrolytic graphite, which acts as the primary neutron moderator. In the “prismatic block” design, the fuel assembly containing cylindrical fuel compacts is inserted into hexagonal graphite blocks. In both cases, the fuels are small spherical kernels coated with multiple successive layers of refractory materials—pyrocarbon and silicon carbide. In Germany, the fuel element designs incorporate the coated particle fuel in six-centimeter (diameter) spherical fuel element balls and are continuously fueled. In US designs, fuel rods are used with similar coated fuel particles and inserted into blind holes drilled in hexagonal graphite fuel element blocks using a graphitic binder.

To date, all HTGRs have incorporated either of these designs discussed above. These designs, however, have few limitations and are expected to face some challenges. The pebble-bed reactor (PBR) design's unique components introduce more complexity than standard components. This necessitates more detailed design and cost estimates to validate assumptions. The field activities on PBR design have resulted in low learning about the complexity, automation, and mechanization of the fabrication process. Some other key technical challenges include demonstrating fuel performance, the US infrastructure knowledge base, the regulatory system, and the balance of plant design components. The gap between the design state-of-the-art and regulatory state-of-the-art will likely become a limiting factor for the PBR designs. Licensing hurdles are expected due to different designs. The IAEA safeguards criteria do not fit the PBR since the nuclear fuel is dispersed across a large bulk of the material. There are additional safeguards concerns regarding the production and diversion of a significant quantity of plutonium from the PBR core and/or spent fuel storage and the diversion of a significant U-235 from the fresh core or spent PBR fuel. Collaboration with the IAEA, DOE/NNSA, and the DOE national laboratories are necessary to develop a safeguards strategy that can address the unique features of the PBR. One of the unique natures of the PBR, i.e., continuous on-load refueling with nuclear fuel in bulk form, could increase reactivity during defueling due to the displacement of pebbles. The core can produce graphite dust from fuel damage, which can transport FPs throughout the primary loop. In the prismatic block design, dust is also a concern due to the movement and shifting of the blocks during operation. Past experiences in reactor design, construction, and operation must be considered to prevent fuel damage and graphite dust formation. Reports from the second International Topical Meeting on High-Temperature Reactor Technology mention a need for irradiated TRISO fuel data (Kendall, 2004). Although TRISO particle fuel is designed to retain its radioactive material even at very high temperatures, tests at Oak Ridge National Laboratory (ORNL) have revealed fuel failures and release of highly radioactive Cs-137 at temperatures above 1500° C. (Hunn et al., 2021). Additionally, the fabrication of TRISO fuel is expensive and complex. The fuel volume fraction and U-235 rod density in TRISO fuel are significantly lower (approximately 15 and 30 times) than conventional fuel pellets (Sterbentz, 2007), making it harder for the reactors to be economically competitive. Despite these difficulties, there have been no HTGR—commercial-scale or modular—design attempts outside these two core types.

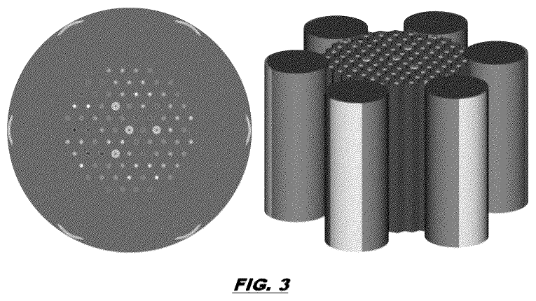

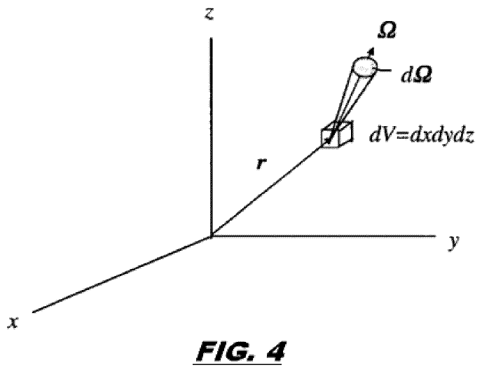

In contrast, MINION greatly simplifies the core design using LWR-type clad fuel pins. This also allows for a significantly more compact design due to the higher power density of the core. Unlike some past HTGR designs that use HEU adding complexity to fuel handling and design licensing, MINION uses 19.75% enriched HALEU. FIG. 3 at (A) shows a top view and at (B) a side view of the MINION core 300.

COST According to the Nuclear Energy Institute (NEI), the cost for a first-of-a-kind (FOAK) microreactor is estimated to be between $0.14/kWh and $0.41/kWh based on a two-unit 5 MWe plant (costs are expected to fall when more reactors deployed). The cost target for initial market entry before 2030 is less than $0.60/kWh based on the first nine units for government uses. After ten units, the cost would reduce to $0.50/kWh by the early 2030s. Costs are expected to decline further through factory scale-ups and improvements in producibility. The DOE Nuclear Energy Systems Analysis and Integration (SA&I) campaign extended the NEI analysis to produce bottom-up cost estimates for microreactors based on an “Economics-by-Design” approach. Potential design modifications to reduce costs include reactor size, neutron spectrum, fissile inventory, plant lifetime, refueling interval, reflector, reactor building, instrumentation and control (I&C), and operations staffing. According to a recent study, for microreactors to achieve deep penetration in markets will require achieving specific aggressive cost targets (Shropshire et al., 2012). Using existing technology or technology that can be satisfactorily established can potentially lower the cost of a microreactor. If the microreactors can use key components from readily available technology (e.g., LWR fuels), the cost will substantially reduce.

### Neutronics

### Neutron Transport

Neutron transport behavior in both space and time domain and multiplying and non-multiplying medium can be studied using theoretical models based on deterministic or stochastic approaches. The nuclear properties and isotopic composition of the transport medium are specified by the number densities of isotopes, which represent the number of nuclei of each isotope present in a cubic centimeter.

$${ND}^{i} = \frac{{ρ}^{i} {N}_{A}}{{A}^{i}} \qquad ( 3.1 )$$

with the Avogadro number N_{A}=6.023×10²³, ρⁱ is the density of the isotope i in grams per cubic centimeter, and Aⁱ is the atomic number. The nuclear characteristics of the transport medium are defined by its microscopic cross sections, a measure of the probability of interaction, σ^{x}, for reactions of type x. The macroscopic cross sections, Σ^{x} (r, E), of an isotope i, is expressed as a product of its microscopic cross section and its number density, NDⁱ, at position r.

$${\sum }^{x , i} ( r , E ) = {ND}^{i} ( r ) {σ}^{x , i} ( E ) \qquad ( 3.2 )$$

If the medium contains multiple isotopes, the total macroscopic cross section of the medium is the sum of the cross sections for each isotope.

$${\sum }_{medium}^{x} ( r , E ) = {\sum }_{i} {\sum }^{x , i} ( r , E ) = {\sum }_{i} ( {ND}^{i} ( r ) {σ}^{x , i} ( E ) ) \qquad ( 3.3 )$$

The total cross section of a neutron at position r with energy E is the likelihood of neutron interaction per unit distance traveled by a neutron. This likelihood is measured as the sum of the partial cross sections for all possible types of neutron-nucleus collisions or interactions and has the dimension of a reciprocal length.

$${\sum }_{m}^{tot} ( r , E ) = {\sum }_{x} {\sum }_{m}^{x} ( r , E ) \qquad ( 3.4 )$$

The average distance of neutron travel between two consecutive collisions is called mean free path and is reciprocal of the total cross section, λ.

$${\sum }_{m}^{tot} ( r , E ) = {\sum }_{x} {\sum }_{m}^{x} ( r , E ) \qquad ( 3.5 )$$

The cross sections for initial direction Q‘ and energy E’ emerging in a collision in the interval dΩ about Ω with energy dE about E. Neutrons emerge from this differential cross section defined for collisions.

$${\sum }^{x} ( r , E ) {f}^{x} ( r ; {Ω}^{′} , {E}^{′} \to Ω , E ) \qquad ( 3.6 )$$

For a reaction of type x and neutrons of energy E′, the cross section is Σ^{x}. If a neutron of energy E′ and direction Q′ has a collision of type x, the probability of another neutron emerging in the direction interval dΩ about Ω with energy dE about E is given by the following expression.

$${f}^{x} ( r ; {Ω}^{′} , {E}^{′} \to Ω , E ) d Ω dE \qquad ( 3.7 )$$

For elastic scattering, integrating f^{x} over all directions and energies results in unity. For elastic scattering of neutrons from initially stationary nuclei, f^{x} depends solely on Ω ′ Ω, which represents the cosine of the scattering angle between the directions of motion of the neutron before and after the collision. Assuming isotropic neutron flux for fission, it is possible to write:

$${f}^{x} ( r ; {Ω}^{′} , {E}^{′} \to Ω , E ) d Ω dE = \frac{1}{4 π} \cdot κ ( r ; {E}^{′} \to E ) d Ω dE \qquad ( 3.8 )$$

where K(r; E′→E)dE is the probability that a fission caused by a neutron at r with energy E′ will lead to a neutron within dE about E. The spectrum of the fission neutrons, K(r; E′ →E)dE, is normalized such that its integration over the full angle equals K(r; E′). This is the average number of neutrons at r caused by fission with a neutron of energy E′. The neutron velocity, v, may be used instead of the neutron energy, E.

$$v = v \cdot Ω \qquad ( 3.9 )$$

where v=|v| is the speed at which the neutron is travelling and is related to the energy by a standard equation

$$E = {mv}^{2} / 2 \qquad ( 3.1 )$$

where m is the mass of neutron. The rate of neutron transfer through interactions of type x into final directions within the interval dΩ around Ω and final energies within the interval dE around E is expressed in neutrons per unit volume and time at position r and time t.

$${v}^{′} {\sum }^{x} ( r , {E}^{′} ) {f}^{x} ( r ; {Ω}^{′} , {E}^{′} \to Ω , E ) N ( r , {Ω}^{′} , {E}^{′} , t ) d {Ω}^{′} {dE}^{′} d Ω dE \qquad ( 3.11 )$$

The total rate of neutron transfer can be calculated by integrating the aforementioned quantity over all initial neutron energies and directions and summing over all reactions. A population of neutrons can be described by the neutron angular density denoted by

$${v}^{′} {Σ}^{x} ( r , {E}^{′} ) {f}^{x} ( r ; {Ω}^{′} , {E}^{′} \to Ω , E ) N ( r , {Ω}^{′} , {E}^{′} , t ) d {Ω}^{′} {dE}^{′} d Ω dE \qquad ( 3.12 )$$

N(r,Ω, E,t)dVdΩdE is the probable number of neutrons in the volume element dV at position r, having directions within dΩ about Ω and energies in dE about E at time t. The number of neutrons in an infinitesimal volume is sometimes called a packet of neutrons. The energy dependent neutron density is calculated as the integral of the neutron angular density over all directions.

$$n ( r , E , t ) = {\int }_{4 π} N ( r , Ω , E , t ) d Ω \qquad ( 3.13 )$$

The integral is taken over all directions. Therefore, n(r, E,t) is the probable number of neutrons per unit volume per unit energy, with energy E at r at time t. The neutron angular flux is then calculated as a product of the neutron speed v and the neutron angular density.

$$Φ ( r , Ω , E , t ) = v \cdot N ( r , Ω , E , t ) \qquad ( 3.14 )$$

The total neutron flux is estimated by taking integral over all directions of the neutron angular flux.

$$Φ ( r , E , t ) = v \cdot N ( r , E , t ) \qquad ( 3.15 )$$

When the neutron flux is multiplied by the macroscopic cross section, it gives the number of reactions undergone by neutrons per second, per cubic centimeter and per eV.

The neutron current is the net number of neutrons crossing a surface per unit energy per unit time.

Finally, the neutron transport equation is obtained by considering the neutron balance within a neutron packet. This involves accounting for the number of neutrons remaining in the packet, the number of neutrons that enter the packet due to collisions, and the number of neutrons that enter the packet from external sources. The resulting equation is:

$${\{ RR \}}^{x} = {Σ}^{x} ( r , E ) \cdot Φ ( r , E , t ) \qquad ( 3.16 )$$

The neutron current is the net number of neutrons crossing a surface per unit energy per unit time.

$$J ( r , E , t ) = v {\int }_{4 π} Ω N ( r , Ω , E , t ) d Ω \qquad ( 3.17 )$$

Finally, the neutron transport equation is obtained by considering the neutron balance within a neutron packet. This involves accounting for the number of neutrons remaining in the packet, the number of neutrons that enter the packet due to collisions, and the number of neutrons that enter the packet from external sources. The resulting equation is:

$$\frac{\partial N}{\partial t} + v Ω ∇ N + Σ vN = \int \int {Σ}^{′} {f}^{′} {v}^{′} {N}^{′} {dE}^{′} d {Ω}^{′} + Q \qquad ( 3.18 )$$

Where

The neutron transport equation may be also expressed in terms of the angular flux Φ, which is equal to v.N.

$$N = N ( r , Ω , E , t ) , {N}^{′} = N ( r , {Ω}^{′} , {E}^{′} , t ) , Σ = Σ ( r , {E}^{′} ) , f = f ( r ; {Ω}^{′} , {E}^{′} \to Ω , E , Q = Q ( r , Ω , E , t )$$

The neutron transport equation may be also expressed in terms of the angular flux Φ, which is equal to v.N.

$$\frac{1}{v} \frac{\partial Φ}{\partial t} + Ω ∇ Φ + ΣΦ = \int \int {Σ}^{′} f Φ {dE}^{′} d {Ω}^{′} + Q \qquad ( 3.19 )$$

### Criticality

Depending on the behavior of the neutron population over time, a system containing fissile nuclides can be subcritical, critical, or supercritical. In a subcritical system, an expected neutron population dies out over time without an external neutron source. In a supercritical system, an expected neutron population diverges over time from any initial nonzero population. A system is said to be critical if a steady, time-independent neutron population can be maintained in the absence of a source. The algebraic sum of all core reactivities must be zero to achieve criticality in a reactor. The ratio between the numbers of neutrons in successive generations is assumed to be one. In elementary reactor theory, this ratio is termed as effective multiplication factor and is expressed by k_{eff}. The effective multiplication factor for a reactor can be evaluated based on the neutron transport equation discussed in the previous section. The neutron transport equation with boundary conditions can be used to define an initial value problem. In principle, if the initial neutron angular density is known at time t=0, the expected density at any future time can be determined by solving the neutron transport equation. The homogenous (source-free) neutron transport equation can be expressed in the form of an operator.

$$\frac{\partial N}{\partial t} = - v Ω ∇ N - Σ vN = \int \int {Σ}^{′} {fv}^{′} {N}^{′} {dE}^{′} d {Ω}^{′} = L N \qquad ( 3.2 )$$

where L is the transport operator and no incoming neutrons is assumed. If we express the solution of the equation as N=N(r,Ω, E)e^{at} from which aN(r, Ω, E)e^{at}=LN(r,Ω, E), there may exist many eigenvalues a of the operator L. These eigenvalues are represented by aj and have corresponding eigenfunctions Nⱼ.

$${α}_{j} {N}_{j} = L {N}_{j} \qquad ( 3.21 )$$

In practical situations, there exists a real eigenvalue that is greater than the real part of all other eigenvalues. This eigenvalue is denoted as a₀ and has an associated eigenfunction N0 (r, Ω, E). If a0 is negative, the solution of Eq. (3.23) will decrease asymptotically, and the system is subcritical. If a₀ is positive, the solution will tend asymptotically to infinity, and the system is supercritical. By applying the Laplace transform, an asymptotic solution can be obtained as

$$N ( r , Ω , E , t ) = A exp ( {α}_{0} t ) {N}_{0} ( r , Ω , E ) , as t \to ∞ \qquad ( 3.22 )$$

where A is a constant determined by the initial conditions. Therefore, the problem of criticality involves finding the conditions for which a₀=0. The homogeneous neutron transport equation has a time-independent solution when a₀=0, or the system is critical, LN₀=0. By dividing the spectrum of fission neutrons K(r; E′→E) by a variable k and changing its value, the stationary solution can be obtained with k=k_{eff}, which is referred to as the effective multiplication factor. This means that the number of neutrons produced per fission is multiplied by a factor of 1/k_{eff}. The term k_{eff} represents a distinct value of the equation according to its definition.

$$v Ω ∇ {N}_{k} + Σ v {N}_{k} = \int \int {Σ}_{x \neq f} {Σ}^{x ′} {f}^{x} {v}^{′} {N}_{k}^{′} d {Ω}^{′} {dE}^{′} + \frac{1}{{k}_{eff}} \int \int \frac{1}{4 π} κ ( r ; {E}^{′} \to E ) {Σ}^{f ′} {v}^{′} {N}_{k}^{′} d {Ω}^{′} {dE}^{′} \qquad ( 3.23 )$$

where the summation over x refers to collisions that do not involve fission and Nk are eigenfunctions independent of time. For a critical system, the corresponding eigenfunctions satisfy the same equation. For any other system, however, the two eigenfunctions are different.

### Reactor Shape

Nuclear reactor cores come in different shapes and sizes: cubic, spherical, cylindrical, and parallelepiped. MINION core has the shape of a right circular cylinder, i.e., a cylinder of equal height and diameter. There are several advantages to employing a right circular cylindrical reactor core. It minimizes neutron leakage, lowers core flow resistance, and simplifies modeling efforts. Using a buckling correction to approximate the leakage from the system is simpler. This can be observed from the Helmholtz diffusion equation. Neutron diffusion in simple multiplying media could be described in terms of buckling by the Helmholtz equation,

$${∇}_{φ}^{2} + {B}_{φ}^{2} = 0 \qquad ( 3.24 )$$

also called the reactor equation. The buckling B₂, a measure of neutron leakage and the difference between neutron production and neutron absorption, has two forms: one depending on materials—materials buckling Bₘ² and the other on shape and size—geometric buckling B_{g}². For criticality,

$${B}_{m}^{2} = {B}_{g}^{2} \qquad ( 3.25 )$$

The geometric buckling for a cylinder of height H and radius R can be described as,

$${B}_{g}^{2} = {( \frac{π}{H} )}^{2} + {( \frac{2.405}{R} )}^{2} \qquad ( 3.26 )$$

For a right circular cylinder, this equation simplifies to,

$$\begin{matrix}{B}_{g}^{2} & = & {( \frac{π}{H} )}^{2} + {( \frac{2 \times 2.405}{H} )}^{2} & ( 3.27 ) \\ & = & \frac{33}{{H}^{2}} & ( 3.28 )\end{matrix}$$

### Reactivity

Reactivity is the measure of the departure of a reactor system from criticality. A positive addition in reactivity indicates a shift toward a supercritical state, while a negative addition indicates a shift toward a subcritical state. Since the power level is directly proportional to the neutron density, whenever the effective multiplication factor (k_{eff}) is unity, the reactor is critical and operates at a constant power level. If k_{eff} <1.0, the reactor is subcritical, and the power level decreases. If k_{eff} >1.0, the reactor is supercritical and the power level is rising. The difference between a given value of k_{eff} and 1.0 is the “excess” multiplication factor, Δk.

$$Δ k = {k}_{eff} - 1 \qquad ( 3.29 )$$

Δk may be either positive or negative, depending upon whether k_{eff} is greater or less than 1.0 and is related to reactivity, ρ, as follows.

$$ρ = \frac{{k}_{eff} - 1}{{k}_{eff}} = \frac{Δ k}{{k}_{eff}} \qquad ( 3.3 )$$

It is desirable for a reactor to operate with initial excess reactivity to compensate for reactivity losses and provide a reactivity margin for operation. Reasons that can cause reactivity losses include the following:
Transitioning from a cold shutdown state to a rated power operation state
Depletion of fissile material and build-up of heavy metal isotopes
Build-up of rapidly saturating FPs, e.g., 135Xe and 149Sm
Build-up of slowly saturating FPs
Reactivity margin of irradiation tests

A measure of the net reactivity change following a power change is called the power coefficient of reactivity (Δρ/ΔP). To ensure stability, the power coefficient of reactivity must be negative. In thermal reactors, the coefficient of reactivity, a measure of reactivity feedback of the reactor, may arise from various other phenomena, as discussed below.

Doppler effect: Doppler reactivity is primarily caused by the epithermal capture of neutrons in fertile materials. The resulting reactivity effect is negative and significant for low-enriched fuel because it has a larger fraction of U-238. The fuel temperature reactivity coefficient arising from the Doppler effect is prompt.

Fuel expansion effect: The nuclear fission process generates energy that drives the thermal expansion and mechanical interactions within nuclear reactors. As the temperature rises, the fuel expands, reducing its density and making it less likely for a neutron to interact with it. This leads to reduced resonance absorption and a positive effect on reactivity.

Moderator expansion effect: An increase in moderator temperature causes a decrease in the ratio of moderator atom density to fuel atom density. This results in spectral hardening, which increases leakage and resonance absorption and leads to a negative reactivity effect. However, the increase in fast fission factor due to spectral hardening would add positive reactivity. If a reactor is over-moderated, an increase in temperature will cause an increase in reactivity. On the other hand, if the reactor is under-moderated, an increase in temperature will cause a decrease in reactivity.

Coolant expansion effect: Reduction in coolant density may lead to a reduction in neutron moderation and reduction in neutron absorption. In HTGR, however, which uses a gas coolant, the reduction in coolant density due to temperature rise is not significant enough to affect the reactivity.

Fuel self-shielding effect: Significant reduction in resonance absorption occurs due to increased spatial self-shielding in the fuel cluster, which increases reactivity. This is because the self-shielding phenomenon is enhanced by reducing the fuel radius and negatively affecting the fission cross section of the fuel.

It is evident from the above discussion that changes in reactor temperature play a crucial role in reactor stability, potentially leading to a change in the system's reactivity. This is defined as the reactivity temperature coefficient. In general, if there is negative feedback, an increase or decrease in temperature would have the opposite effect on reactivity. In contrast, positive feedback occurs when an increase or decrease in temperature has the same effect on reactivity. The following formula defines the temperature coefficient of reactivity.

$${α}_{T} = \frac{Δρ}{Δ T} = \frac{ρ ( T ) - ρ ( {T}_{o} )}{T - {T}_{o}} \qquad ( 3.31 )$$

where a_{T} is the temperature coefficient of reactivity and Δₚ is the change in reactivity as a result of the temperature change Δ_{T}. Changes in reactivity induced by external means (such as a control drum or a control rod) in a power reactor also trigger power changes and reactivity feedback effects. If the feedback effects are all negative, the reactor power will eventually settle at a level where the externally induced reactivity change is canceled out by feedback reactivity, resulting in a net reactivity of zero for a steady state.

### Reactivity Control

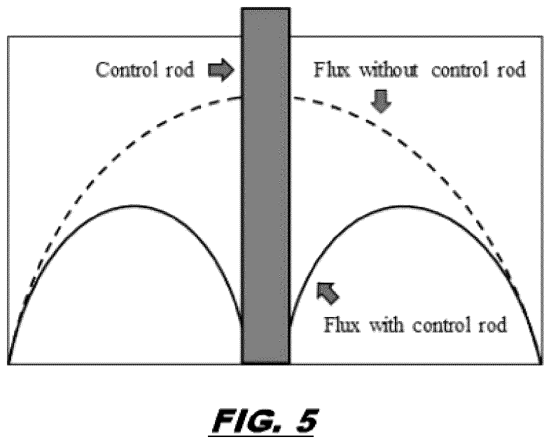

Reactor safety and control systems are designed to control the reactor's power and prevent accidents. In order to have a controlled approach to criticality during startup, nuclear engineers and operators must determine the core reactivities at the expected startup time. During the startup, the operators change the reactivity values of specific parameters (drum/rod position, boron concentration) to achieve criticality and an estimated critical position (ECP). An ECP is a calculation to ensure criticality occurs above the drum rotation or rod insertion limits (RIL). The control banks must adhere to the rotational/insertion sequence and overlap constraints stated in the COLR. The change in reactivity resulting from the motion of a control drum/rod is referred to as its worth, and it is used to define the safety margin of the reactor. The efficiency of a control drum/rod is mainly determined by the ratio of the neutron flux at its location to the average neutron flux across the reactor. If the control drum/rod is placed in an area with a higher neutron flux, it has a more significant impact (produces greater negative reactivity). Control rods are usually located in the center of the core, where the neutron flux is highest. After the center of the core, neutron flux is highest at the periphery of the core due to neutron backscattering by the reflector and is a good place for the control drums to be inserted. Numerous control drums and/or control rods are required for a reactor with a large amount of excess reactivity, i.e., more than necessary for criticality. The exact amount of reactivity that each control drum/rod inserts depends upon the reactor design. The effect of reactivity control on neutron flux is illustrated in FIG. 5. The reactivity change as a function of drum/rod movement can be described in terms of differential drum/rod worth and/or integral drum/rod worth. Differential control drum/rod worth is the reactivity change per unit movement of a drum/rod and can be expressed as per movement, or pcm per movement. The differential reactivity worth can be determined using the following formula:

$$control drum / rod reactivity worth , ( \frac{\$}{◦} ) = \frac{Δρ}{Rotation ( ° C . ) or movement ( inch )} \qquad ( 3.32 )$$

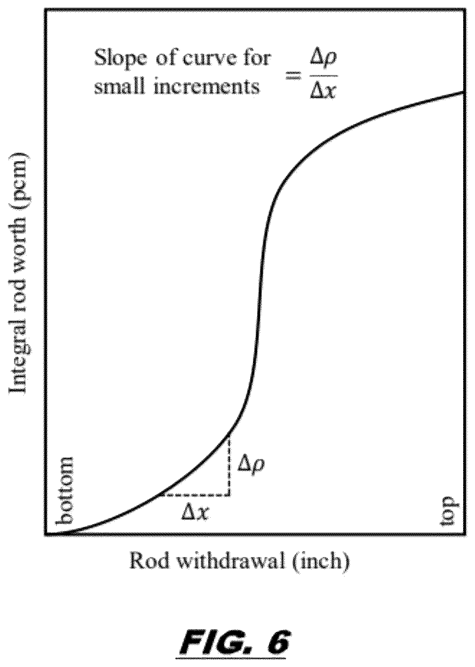

The integral worth of a control drum/rod at a particular withdrawal position is the sum of all the differential worths up to that point. It is also the area under the differential worth curve at that withdrawal position. The integral worth of a control drum/rod represents its overall reactivity worth at a given withdrawal point. It is generally highest when the drum/rod is completely removed or rotated. The exact effect of control drums/rods on reactivity can be determined through experiments, such as gradually rotating a control drum/rod and measuring the resulting change in reactivity after each rotation. By plotting the reactivity versus the drum/rod position, a graph similar to FIG. 6 can be produced.

The slope of the curve

$$( \frac{Δρ}{Δ°} )$$

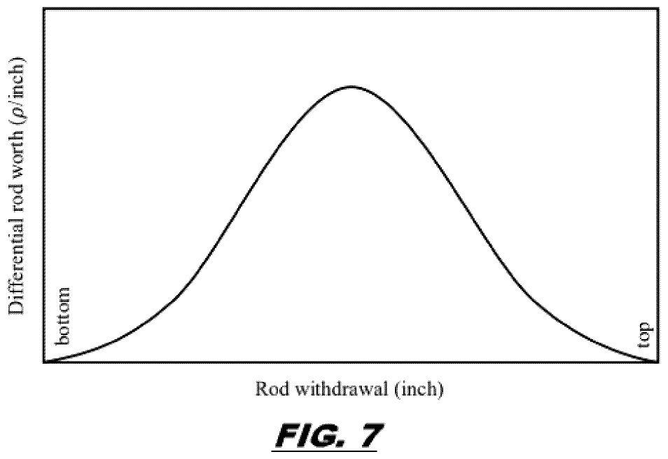

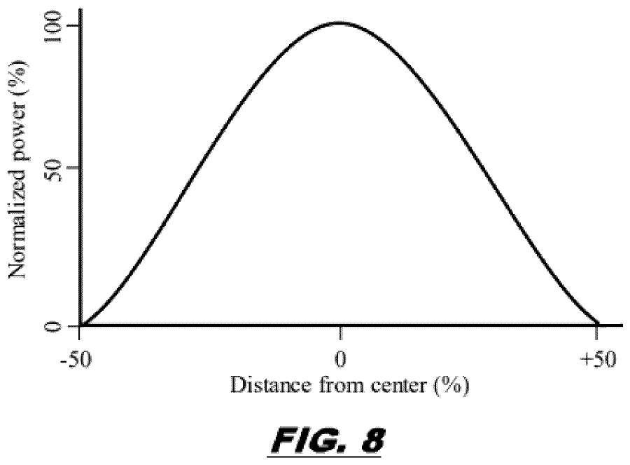

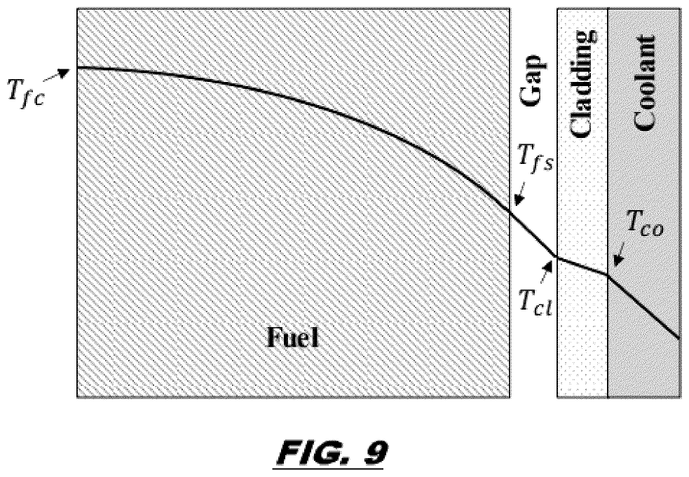

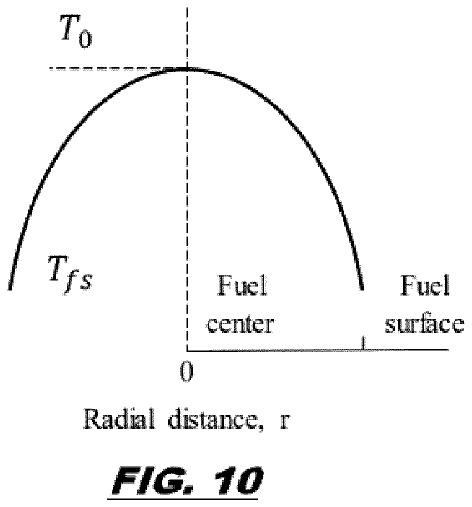

for a control drum/rod, and therefore, the amount of reactivity inserted per unit of rotation/movement, is greatest when the drum/rod is rotated/moved halfway. This phenomenon occurs because the region with the highest neutron flux is located near the core's center, resulting in a greater impact on neutron absorption in this area. If the slope of the differential worth curve is taken, it provides information on the rate of change in the control drum/rod worth in relation to the drum/rod position. A plot of the slope of the differential drum/rod worth curve is shown in FIG. 7. At the radial boundary of the reactor, where there are fewer neutrons compared to the core, drum movement has little effect, so the change in drum worth per degree varies little. As the absorber region in the control drum approaches the core, its effect becomes greater, and the change in drum worth per degree rotation is greater. When the drums directly face the core, the differential drum worth is greatest and varies little with drum motion. For the second 180-degree.

### Power Peaking

The distribution of neutrons as a function of time, position, and energy determines power production. Thus, power distribution in the reactor core is calculated by the neutron diffusion equation discussed herein. The rate of energy production in a given region of the core is directly proportional to the neutron flux density in that region. The highest neutron flux density is observed at the center of the core, while the lowest is at the surface. Therefore, the local power density (LPD) differs across the core. Monitoring LPD is essential to ensure that a number of safety limits imposed on the fuel pellets and fuel-clad barriers are not violated during normal reactor operation. LPD at the hottest part of the core poses a major concern from a safety perspective. Furthermore, a highly nonuniform power density in the reactor core leads to less power generation and a shorter reactor life. LPD at the hottest part of the heated fuel rod is expressed by the power peaking factor (PPF).

The PPF is a measure of the highest LPD in the reactor core, divided by the average power density in the core. Three PPFs are important for steady-state operation:
hot rod peaking factor, PPFₕᵣ
axial power peaking factor, PPF_{z}
total power peaking factor, PPFᵣₒₜ

These factors are used to determine the total power and power peaking value of a fuel element, which are essential parameters for TH analysis. The hot rod PPF is the ratio of the maximum power released by one fuel element, (P_{rod})ₘₐₓ, to the average power per element in the core, (P_{rod})ₐᵥ, and is denoted as PPFₕᵣ.

$$P P {F}_{hr} = \frac{{( {P}_{rod} )}_{ma x}}{{( {P}_{rod} )}_{av}} \qquad ( 3.33 )$$

$${( {P}_{rod} )}_{av} = \frac{{P}_{core}}{{N}_{rod}} \qquad ( 3.34 )$$

where N_{rod} is number of fuel elements (rods) in the core. Assuming that all fuel elements have the same volume of fissionable material, the concept of PPFₕᵣ can also be applied to the ratio of the average power density of a hot rod to the average power density of the entire core. PPFᵣₒₜ, on the other hand, is the ratio between the maximum power density in the core, Pₘₐₓ and the average power density in the core, P_{average}.

$$P P {F}_{total} = \frac{{P}_{ma x}}{{P}_{average}} \qquad ( 3.35 )$$

PPFₜₒₜ can be split into two sub-factors, PPFz and PPFᵣ, axial and radial power peaking factor, such that

$$P P {F}_{total} = P P {F}_{z} \cdot P P {F}_{r} \qquad ( 3.36 )$$

### Neutronics Design Criteria

In nuclear reactor design, safety is the number one priority. The DOE Standard (DOE-STD-1189-2016) provides requirements and guidance for integrating safety into the design process as defined in the 10 Code of Federal Regulations (CFR) Part 830, Nuclear Safety Management. DOE-HDBK-1132-99, Design considerations, provides safety-in-design considerations for the major systems. These guidelines set forth the design process and criteria to ensure that safety structures, systems, and components (SSC) are integrated into the design effectively and efficiently. A systematic design development process is outlined using a graded approach: pre-conceptual, conceptual, preliminary, and final. During the conceptual design phase, efforts are made to ensure that safety issues and resolutions are well thought out for effective integration into the design details and the design is best suited for technology readiness, security, constructability, and operability and adhere to inherently safer design concepts. MINION conceptual design integrates safety into the design process according to the requirements and guidelines outlined in the DOE STD.

### Reactivity Control

The reactivity control mechanism shapes the core's neutron flux distributions and fission power generation profiles and may affect the lifetime of the reactor. Changes in the power generation profiles affect fuel utilization and the amount of excess reactivity and fissile inventory. Therefore, it is particularly important to investigate the effectiveness of the control mechanism and its effect on spatial neutron flux distributions and fission power generation profiles. To ensure safe operation and assure examination of upper bounds on ultimate damage, it is important to analyze a sufficient number of initial reactor states to completely bracket all possible operating conditions of interest. In areas of uncertainty, using appropriate minimum or maximum parameters relative to nominal or expected values assures a conservative evaluation. Thus, the initial reactor states should include consideration of at least the following:

| | |
|---|---|
| Zero power (hot standby) | Beginning of Life (BOL) |
| and End of Life (EOL) | |
| Low power BOL and EOL | |
| Full power BOL and EOL | |

When analyzing the impact of failed reactivity control, it is important to consider how the loss of primary system integrity will affect the situation. The single SFC is used as a design and analysis tool to improve reliability and ensure safety. The SFC requires redundant systems to perform safety functions and assumes that any major component within or in a supporting system could fail. In the analysis of postulated reactivity accidents, failures such as rod ejection, rod dropout, and changes in reactor coolant temperature and pressure must be taken into account. The NRC's regulatory guide provides guidance on how the general design criteria (GDC) may be adapted in these scenarios for non-LWR designs, especially two specific non-LWR design concepts: sodium-cooled fast reactors (SFRs) and MHTGRs. The guidelines can be found in Appendix A, “General Design Criteria for Nuclear Power Plants,” of Title 10 of the Code of Federal Regulations Part 50, “Domestic Licensing of Production and Utilization Facilities,” (Ref. 1). A summary of the GDC outlines relevant to MINION conceptual design is included.

The GDC criteria for Protection and Reactivity control Systems. Criterion 26: Reactivity control system redundancy and capability—Two independent reactivity control systems of different design principles shall be provided. —One of the systems shall use control rods, preferably including a positive means for inserting the rods, and shall be capable of reliably controlling reactivity changes to assure that under conditions of normal operation, including anticipated operational occurrences, and with appropriate margin for malfunctions such as stuck rods, specified acceptable fuel design limits are not exceeded. —The second reactivity control system shall be capable of reliably controlling the rate of reactivity changes resulting from planned, normal power changes (including xenon burnout) to assure acceptable fuel design limits are not exceeded. —One of the systems shall be capable of holding the reactor core subcritical under cold conditions.

Criterion 27: Combined reactivity control systems capability The reactivity control systems shall be designed to have a combined capability, in conjunction with poison addition by the emergency core cooling system, of reliably controlling reactivity changes to assure that under postulated accident conditions and with appropriate margin for stuck rods the capability to cool the core is maintained.

Criterion 28: Reactivity limits The reactivity control systems shall be designed with appropriate limits on the potential amount and rate of reactivity increase to assure that the effects of postulated reactivity accidents can neither result in damage to the reactor coolant pressure boundary greater than limited local yielding nor disturb the core, its support structures or other reactor pressure vessel internals to impair significantly the capability to cool the core.

The control rod drive system (CRDS) requirements/acceptance criteria. GDC 1 The CRDS be designed to quality standards commensurate with the importance of the safety functions to be performed. GDC 2 The CRDS be designed to withstand the effects of an earthquake without loss of capability to perform its safety functions. GDC 14 The reactor coolant pressure boundary (RCPB) portion of the CRDS be designed, constructed, and tested for the extremely low probability of leakage or gross rupture. GDC 26 The CRDS be one of the independent reactivity control systems that is designed with appropriate margin to assure its reactivity control function under conditions of normal operation, including anticipated operational occurrences GDC 27 The CRDS be designed with appropriate margin, and in conjunction with the emergency core cooling system, be capable of controlling reactivity and cooling the core under postulated accident conditions. GDC 29 The CRDS, in conjunction with reactor protection systems, be designed to assure an extremely high probability of accomplishing its safety functions in the event of anticipated operational occurrences.

### Shutdown Margin

A sufficient SDM is essential for achieving a safe subcritical condition. The minimum shutdown margin under normal operating conditions makes the core subcritical rapidly enough to prevent exceeding acceptable fuel damage limits. Additionally, a safe subcritical condition accounts for prohibited or unintended motion of individual control drums and/or rods, which can excite convergent azimuthal power oscillations in the reactor core. Therefore, minimum SDM as specified in the COLR is required for all modes of plant operation: Power operations, startup, hot standby, hot shutdown, cold shutdown, and refueling conditions. One of the accidents that may occur in the reactor core is the congestion of a control drum or control rod resulting in less than expected decrease in core reactivity values. The highest safety standard demands that the core stays subcritical even during the worst possible stuck drum incident. This condition is based on the so-called “stuck rod criterion” that assumes that the highest-worth control rod is stuck in the fully withdrawn position upon reactor trip. The NRC's Standard Technical Specifications 3.1.1 (STR, 2018) define SDM as the instantaneous amount of reactivity by which the reactor is subcritical or would be subcritical from its present condition assuming:
The reactor is xenon free,
The moderator temperature is 68° F., and
All control rods are fully inserted except for the single control rod of highest reactivity worth, which is assumed to be fully withdrawn.

With control rods not capable of being fully inserted, the reactivity worth of these control rods must be accounted for in the determination of SDM. Therefore, the SDM for an operating reactor can be defined as follows:

$$S D M = \vert {ρ}_{rods} \vert - \vert {ρ}_{m od} \vert - \vert {ρ}_{fuels} \vert \qquad ( 3.37 )$$

According to the Standard Technical Specifications (STS), SDM shall be:
≥[0.38] % Δk/k, with the highest worth control rod analytically determined or
≥[0.28] % Δk/k, with the highest worth control rod determined by test.

Although the NRC guidelines do not require redundant reactivity control in the secondary shutdown mechanism, MINION includes redundant reactivity control in both primary and secondary shutdown mechanisms to ensure enhanced safety, especially considering its potential mobile applications.

### Heat Transfer

Heat, a primary form of energy, is transmitted by conduction, convection, and radiation. In conduction, molecular motion in a substance leads to the flow of energy from a region of high temperature to a low temperature. The rate of flow is proportional to the temperature gradient. In convection, molecules of a cooling agent gain energy from a heated surface and return to the coolant to raise its temperature. The rate at which heat is removed from a system depends on the difference in temperature between the surface and the surrounding medium, as well as the circulation of the coolant. Radiative heat transmission occurs when heated objects emit and receive electromagnetic radiation. However, for nuclear reactors, radiative heat transfer is typically less important unless for accident conditions. The rate of fission in a nuclear reactor is limited by the need to transfer the energy released as heat from the fuel to the coolant while keeping temperatures within safe limits imposed by the properties of the materials used. The heat generation and transfer processes in a typical reactor can be summarized as follows:
Energy released by fission within the fuel is transferred by heat conduction to the surface of the fuel.
Energy at the surface of the fuel is transferred to the cladding through the gap region by conductive and radiative heat transfer.
From the surface of the cladding heat is transferred by convection to the coolant and through conjugate heat transfer process.

The rate of heat transfer across the fuel surface can be defined as,

$$Q = hS ( {T}_{f} - {T}_{c} ) \qquad ( 3.38 )$$

where, S is the fuel surface area, H is heat transfer coefficient, Tₛ is fuel surface temperature, and T_{c} is coolant temperature. In order to promote effective heat transfer (a high heat transfer coefficient), the coolant is circulated at high velocity across the surface of the cladding so that heat transfer is by forced convection to a turbulently flowing fluid. As coolant flows through the channels surrounding fuel rods, it absorbs thermal energy and rises in temperature. To avoid melting the metal cladding, the following are needed:
   large heat transfer area,
   large heat transfer coefficient
   high coolant flow rate
   high coolant thermal conductivity
   low coolant viscosity

Finally, the energy released by fission, having been transferred to the coolant, is transported out of the reactor as the coolant passes from the core to external heat exchangers in which steam may be generated for a thermodynamic power system.

Heat Transfer within the Fuel Rod

To achieve a steady-state condition in a nuclear reactor, the amount of heat lost by the fuel must be equal to the amount of heat gained by the cladding, which is then transferred to the coolant. This steady-state heat transfer process can be described by the following two expressions:

$$- ∇ \cdot [ {k}_{f} ( T ) ∇ {T}_{f} ( r , θ , z ) ] = {{q}^{}}_{f} ( r , θ , z ) \qquad ( 3.39 )$$

$$- ∇ \cdot [ {k}_{c} ( T ) ∇ {T}_{c} ( r , θ , z ) ] = {{q}^{}}_{c} ( r , θ , z ) \qquad ( 3.4 )$$

where r, θ, z are positions in radial, angular, and axial direction, k_{f} and k_{c} are thermal conductivities of fuel and cladding, T_{f} and T_{c} are temperatures of fuel and cladding, and q̅_{f} and q̅_{c} are volumetric heat source of fuel and cladding. In steady-state fuel-rod performance computer codes, assumptions and approximations are almost always employed to simplify these equations. Some of the crucial assumptions are as follows:

There is no source of heat within the cladding, i.e., gamma heating, so that q̅_{c}=0.

This is typically a minor approximation in standard fuel rod designs.

There is no variation in fuel heat generation along the azimuthal direction, so that q̅_{f}(r, θ, z)=q̅_{f}(r,z). This approximation may not always be accurate, but its practical effects are typically insignificant.

Cladding-to-coolant heat transfer is uniformly distributed in the azimuthal direction.

Fuel-to-cladding conductance is uniformly distributed in the azimuthal direction. The practical effects of this for clad fuel rods with helium as filling gas is small.

Axial gradients are generally two orders of magnitude smaller than radial gradients, and hence axial heat flow can be disregarded.

With these assumptions, heat transfer occurs only in the radial direction, and as a result, the fuel and cladding temperatures at a specific axial location are functions of radius alone. This reduction leads to the heat transfer equations being simplified to:

$$\frac{1}{r} \frac{d}{dr} ( {k}_{f} \frac{{dT}_{f}}{dr} ) + {{q}_{f}}^{} = 0 \qquad ( 3.41 )$$

$$\frac{1}{r} \frac{d}{dr} ( {k}_{c} \frac{{dT}_{c}}{dr} ) = 0 \qquad ( 3.42 )$$

These equations require a total of four boundary conditions:

$${( \frac{{dT}_{f}}{dr} )}_{r = {r}_{fi}} = 0 \qquad ( 3.43 )$$

$$- {{k}_{c} ( \frac{{dT}_{c}}{dr} )}_{r = {r}_{ci}} = \frac{P}{2 π {r}_{ci}} \qquad ( 3.44 )$$

$$\frac{P}{2 π {r}_{fs}} = h ( {T}_{fs} - {T}_{ci} ) \qquad ( 3.45 )$$

$$- {{k}_{c} ( \frac{{dT}_{c}}{dr} )}_{r = {r}_{cs}} = {h}_{film} ( {T}_{cs} - {T}_{co} ) \qquad ( 3.46 )$$

where, r_{fi} and r_{fs} are fuel inner and outer/surface radii, r_{ci} and r_{cs} are cladding inner and outer/surface radii, hfiln is film conductance, and P is linear power, r_{fi} will generally zero. The equation above relates to linear power and the thermal conductivities of fuel and cladding. The thermal conductivities vary with fuel density and burn-up and appear constant when they are function of temperature. The gap conductance is dependent on both the fuel and cladding temperatures, leading to non-linear equations. This complexity necessitates the use of performance modeling codes and iterative solution procedures to determine the temperature distribution that satisfies both the heat transfer equations and gap conditions. The typical temperature distribution in a fuel pin is shown in FIG. 10.

### Gap Conductance

Heat transfer from the fuel and to the cladding can be broken down into three components.
heat transfer across the gap by conduction through the fillgas, h_{gas}
solid conductance through points of contact between fuel and cladding, hₛₒlid
a radiative heat transfer term, h_{radiation} so that

$$h = {h}_{gas} + {h}_{solid} + {h}_{radiation} \qquad ( 3.47 )$$

The convective heat transfer within the gap can be ignored. It is typically assumed that the gas composition is uniform throughout the fuel rod, though thermal diffusion can lead to a concentration gradient if more than one gas is present. The gap between the fuel and cladding is typically small, about 1 to 2% of the fuel radius. The hot gaps become even smaller due to differential thermal expansion during operation. As a result, for light gases like helium, the assumption is

$${h}_{gas} = \frac{{k}_{gas}}{d} \qquad ( 3.48 )$$

where k_{gas} is the gas thermal conductivity and d is the open gap width. The width of the gap being inadequate must be replaced by a form such as

$${h}_{gas} = \frac{{k}_{gas}}{d + {d}_{min} + {g}_{fuel} + {g}_{cladding}} \qquad ( 3.49 )$$

where dmin is related to the roughness's of the two surfaces and gf and gc are ‘temperature jump distances’ at the fuel and cladding surfaces, respectively. In practical applications, fuel rods often contain a mixture of several gases, which requires consideration of gas mixture conductivity and temperature jump distance. Additionally, imperfect energy transfer between the gas and the surface, as well as the significant variability in the probabilities of gas molecules colliding with other gas molecules and solid surfaces, can cause discontinuities.

The thermal conductivity of a gas increases with temperature and can be described by equations that accurately model the temperature dependence for most gases used in fuel rod performance analysis.

$${k}_{gas} = {h}_{gas} Δ x \qquad ( 3.5 )$$

where Δx is the total effective gap width described as follows (Beyer et al., 1975)

$${h}_{gas} = \frac{{k}_{gas}}{Δ x} \qquad ( 3.51 )$$

where, d is open fuel-cladding gap size, b=1.397×10⁻⁶ (m), P is fuel-cladding interfacial pressure (kg/cm²), and d

$$\begin{matrix}{d}_{eff} = {( {R}_{fuel} + {R}_{cladding} )}^{- 0.00125 \times P} for closed fuel - cladding gaps ( m ) , \\ = ( {R}_{fuel} + {R}_{cladding} ) for open fuel - cladding gaps ( m ) \\ ( {R}_{fuel} + {R}_{cladding} ) = cladding plus fuel surface roughness ( m )\end{matrix} \qquad ( 3.53 )$$

$$\begin{matrix}{g}_{fuel} + {g}_{cladding} = temperature jump distances at fuel and cladding surfaces ( m ) \\ = A \times [ \frac{{k}_{gas} \sqrt{{T}_{gas}}}{{P}_{gas}} ] [ \frac{1}{\sum {a}_{i} {f}_{i} / \sqrt{{M}_{i}}} ]\end{matrix}$$

where A=0.0137, k_{gas} is gas conductivity (W/m-K), P_{gas} is gas pressure (Pa), T_{gas} is average gas temperature (K), aᵢ is accommodation coefficient of iₜₕ gas component, Mᵢ is gram-molecular weight of iₜₕ gas component (g moles), and fᵢ is mole fraction of iₜₕ gas component. Conduction through points of contacts between the fuel and cladding can be estimated using the contact conductance model by Mikic-Todreas (Todreas and Jacobs, 1973). The heat flux from the fuel to the cladding through the gap can be estimated using the general radiant heat transfer equation by Kreith (1964).

$$q = σ F ( {T}_{fs}^{4} - {T}_{cl}^{4} ) \qquad ( 3.54 )$$

where σ is the Stefan-Boltzman constant 5.6697×10⁻⁸ (W/m²-K4) and

$$F = \frac{1}{{e}_{f} + ( \frac{{r}_{fs}}{{r}_{ci}} ) \times ( \frac{1}{{e}_{c} - 1} )} \qquad ( 3.55 )$$

where, e_{f} is fuel emissivity, e_{c} cladding emissivity, T_{ci} is fuel surface temperature (K), T_{fs} is cladding inner surface temperature (K), r_{fs} is fuel outer surface radius (m), r_{ci} is cladding inner surface radius (m). The conductance due to radiation, h_{radiation}(W/m²-K), is defined by

$$F = \frac{1}{{e}_{f} + ( \frac{{r}_{fs}}{{r}_{ci}} ) \times ( \frac{1}{{e}_{c} - 1} )} \qquad ( 3.55 )$$

Combining Equations (3.54) and (3.56) gives

$${h}_{radiation} = σ F ( {T}_{fs}^{2} - {T}_{ci}^{2} ) ( {T}_{fs} + {T}_{ci} ) \qquad ( 3.57 )$$

### Conductive Heat Transfer Through the Cladding

The heat generated in the fuel is transferred to the coolant through the cladding mostly via conduction. Therefore, the inner surface of the cladding is hotter than the outer surface. Since there is azimuthally uniform fuel-to-cladding conductance and the axial gradients are typically two orders of magnitude less than radial gradients, axial heat flow can be ignored. This symmetry in the z-direction and azimuthal direction simplifies the heat transfer to a one-dimensional phenomenon. If there is no heat generation inside the cladding and the thermal conductivity remains constant, the cylindrical heat equation can be expressed as follows:

$$\frac{1}{r} \frac{d}{dr} ( r \frac{{dT}_{c}}{dr} ) = 0 \qquad ( 3.58 )$$

The heat transfer from fuel to the inner cladding is then

$$q ( r ) = - k \frac{{dT}_{c} ( r )}{dr} \qquad ( 3.59 )$$

$${q}_{L} = - 2 π rk \frac{dT ( r )}{dr} \qquad ( 3.6 )$$

where, q is the local heat flux density (W/m², q_{L} is the local linear heat flux density (W/m), and k is the materials thermal conductivity (W/m-K).

### Conjugate Convective Heat Transfer to the Coolant

The heat transfer from the outer surface of the cladding to the coolant by convection can be calculated using the basic relationship for heat transfer by convection:

$$q = h ( {T}_{cladding} - {T}_{coolant} ) \qquad ( 3.61 )$$

$${q}_{L} = 2 π {r}_{cladding} h ( {T}_{cladding} - {T}_{coolant} ) \qquad ( 3.62 )$$

where, q is the local heat flux density (W/m²) and L is the local linear heat flux density (W/m). When it passes through the active core, the coolant heats up, and the temperature is higher than the temperature of the surrounding bulk coolant. Due to this temperature, thereby density, gradient a different buoyant head is created, providing the driving force for natural circulation. This effect is known as a virtual chimney. At the top of the chimney, the coolant temperature and density are again equal to the bulk coolant.

### Conductive Heat Transfer Through Core Materials

Conductive heat transfer through solid core materials follows the same conductive heat transfer mechanism discussed above. In a nuclear reactor, conductive heat transfer is the most common mode of heat transfer.

### Radiative Heat Transfer to Surrounding

Although radiative heat transfer is generally of less significance for nuclear reactors, this mode of heat transfer needs to be considered during reactor transient analysis when passive decay of heat becomes important. Generally, about 80% of the reactor pressure vessel (RPV) heat is transported by radiation to the reactor cavity cooling system (RCCS) and the remaining 20% is transported by convection of the gas in the cavity. The Stefan-Boltzmann law describes the radiation emittance H of an ideal black body surface of constant emissivity F at temperature T according to the following formula:

$$H = \int {H}_{v} dv = ε {{\int }^{∞}}_{0} \frac{2 π {hv}^{3} dv}{{c}^{2} ( {e}^{hv / kT} - 1 )} = ε \frac{2 {π ( kT )}^{4}}{{h}^{3} {c}^{2}} {{\int }^{∞}}_{0} F ( x ) dx \qquad ( 3.63 )$$

The dimensionless integral has an explicit value of

$$\frac{{π}^{2}}{15} ,$$

and the final equation takes the following form:

$$H = ε \frac{2 {π}^{5} {k}^{4}}{15 {h}^{3} {c}^{3}} {T}^{4} = εσ {T}^{4} \qquad ( 3.64 )$$

where E is the emissivity of the surface and the Stefan-Boltzmann constant σ is empirically determined to be 5.57×10⁻⁸ W/K⁴ m². This formula is valid for a black surface, which is a perfect absorber and emitter of radiation. A more realistic approximation is that of a nonblack surface. For a real surface, e.g., the RPV, the emissivity is a function of temperature, radiation wavelength, and direction and a useful approximation is that of a diffuse-gray surface. Its value is 1 for black bodies and less than 1 for grey bodies.

### Heat Removal

Heat Removal from Fuel

When discussing the thermal behavior of fuel rods, it is necessary to differentiate between heat production and removal scenarios during normal operation and transient situations. Normal steady-state operation involves constant power levels in the reactor and the rod, as well as the continuous removal of heat from the fuel through the cladding to the coolant. Transient situations, on the other hand, involve rapid changes in power and heat transfer from the cladding to the coolant. In both cases, it is assumed that heat flows radially only. This allows the concept of gap conductance to describe the heat flow across the boundary between fuel and cladding. If the coolant of specific heat Cₚ enters the reactor at temperature Tᵢₙ and leaves at Tₒᵤₜ, with a mass flow rate m, then the reactor thermal power Q_{R}, according to the principle of conservation of energy, is

$${\dot{Q}}_{R} = {\dot{m}}_{R} {C}_{p} ( {T}_{out} - {T}_{i n} ) = {\dot{m}}_{R} {C}_{p} Δ T \qquad ( 3.65 )$$

This equation is applicable when the coolant does not change state, which is true for HTGRs. Using the energy conservation equation discussed earlier, one can also determine the temperature of the coolant as it moves through the channel. Most thermal energy produced in nuclear fuel comes from the kinetic energy of fission fragments. Therefore, the heat generated per unit volume is proportional to the fraction of fissionable nuclear fuel burned over a certain period. The linear power generation in a fuel rod generally changes with its position in the reactor due to variations in neutron flux shape, and the volumetric heat generation rate is related to the nuclear fission process via the following equation.

$${q}^{′′′} = ω {\sum }_{f} Φ \qquad ( 3.66 )$$

The coolant mass flow rate for each fuel rod is given by

$$\dot{m} = \frac{{\dot{m}}_{R}}{{N}_{R}} \qquad ( 3.67 )$$

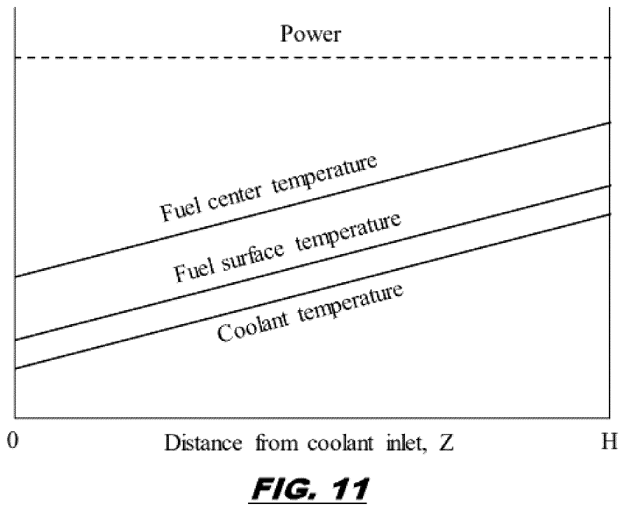

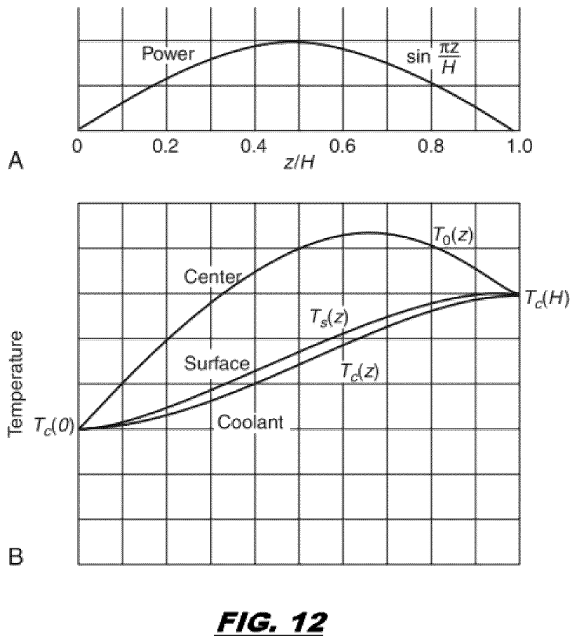

For a special case of uniform power along the z-axis with the core midplane as the origin, see FIG. 11, the power per unit length can be determined as

$${q}^{′} = \frac{{\dot{Q}}_{R} / {N}_{R}}{H} \qquad ( 3.68 )$$

The temperature rise of a nonboiling coolant at z is then

$${T}_{c} ( z ) = {T}_{c , i n} + \frac{( z + \frac{H}{2} ) {q}^{′}}{\dot{m} {C}_{p}} - \frac{H}{2} \leq z \leq \frac{H}{2} \qquad ( 3.69 )$$

This shows that the temperature increases linearly as you move further down the channel, as illustrated in FIG. 12. With a constant power distribution, the temperature difference between the fuel surface and coolant remains the same throughout the channel, and the temperature difference between the center and surface of the fuel is uniform. The highest temperatures are reached at the exit of the reactor coolant. If the axial power is shaped as a cosine function with

$${q}^{′} ( z ) = {q}_{m ax}^{′} cos ( \frac{π z}{H} ) \qquad ( 3.7 )$$

the application of conduction and convection yield temperature curves as shown in FIG. 12. The coolant temperature distribution can be used to determine the fuel surface and center temperatures.

$${T}_{c} ( z ) = {T}_{c , i n} + \frac{{q}_{ma x}^{′} H}{π \dot{m} {C}_{p}} [ 1 + sin ( \frac{π z}{H} ) - \frac{H}{2} \leq z \leq \frac{H}{2} \qquad ( 3.71 )$$

In this scenario, the temperatures of the fuel surface and center reach their peak values between the midpoint and the exit of the coolant.

### Forced and Natural Convection

The heat dissipation from a surface caused by convection is defined by Newton's law of cooling as

$$Q = hS ( {T}_{f} - {T}_{c} ) \qquad ( 3.72 )$$

where, S is the fuel surface area, h is the heat transfer coefficient, T_{f} is fuel surface temperature, and T_{c} is the mean fluid or coolant temperature. The dimensionless heat transfer coefficient can be determined from the Nusselt number as

$$\begin{matrix}Nu = \frac{hD}{{k}_{f}} \\ = f ( R e , Pr … ) for forced convection \\ = f ( R a , Pr … ) for natural convection\end{matrix} \qquad ( 3.73 )$$

for natural convection where k_{f} is the thermal conductivity of the fluid, Rₑ is the Reynold's number, Rₐ is the Rayleigh number, and Pᵣ is the Prandtl number. The ellipses on the right side of the equations stand for additional dimensionless parameters such as L/D, which is the ratio of the tube length to its diameter. The Nusselt number's heat transfer coefficient is typically the average value over the heat transfer surface and is influenced by the flow conditions. Generally, the dependence is minimal for free convection but much greater for forced convection. Gaseous flows have lower convection coefficients than liquid flows. Due to increased boundary layer mixing, the convection coefficient is typically low for laminar flows and high for turbulent flows. The Reynolds number measures the relative significance of viscous and inertial forces and governs the transition from laminar to turbulent flow.

$$R e = \frac{ρ {VD}_{h}}{μ} = \frac{( \frac{\dot{m}}{A} ) {D}_{h}}{μ} \qquad ( 3.74 )$$

where ρ is the fluid density, V is the average velocity of the fluid, m is the mass flow rate of the fluid, μ is the dynamic viscosity of the fluid, and Dₕ is the hydraulic diameter defined as follows:

$${D}_{h} = \frac{4 A}{P} \qquad ( 3.75 )$$

where A is the cross-sectional area and P is the inlet perimeter. The mass flow rate m is related to the volumetric flow rate Ω via the following equation.

$$\dot{m} = ρ Q \qquad ( 3.76 )$$

However,

$$Q = \frac{π}{4} {D}_{h}^{2} V \qquad ( 3.77 )$$

Therefore, the Reynolds number can also be defined as

$$R e = \frac{4 Q}{π {D}_{h} ϑ} = \frac{4 \dot{m}}{π {D}_{h} μ} \qquad ( 3.78 )$$

When the Reynolds number is below 2,300, the flow is considered laminar. When the Reynolds number is between 2,300 and 4,000, the flow is in transition, and when it is greater than 4,000, the flow is considered turbulent. The primary difference between laminar and turbulent flow in heat transfer is that turbulent flow includes an additional mechanism of heat transfer in the radial and azimuthal directions. This is referred to as “eddy transport.” Unsteady, time-dependent fluctuations in velocity and pressure characterizing the turbulent flow is much more efficient than the transfer of energy in laminar flow, where the only method of transfer is through conduction in transverse directions. One key difference, however, is the extent of the “thermal entrance region”, where the temperature distribution becomes fully developed. In turbulent flow, the “thermal entrance region” is shorter due to the intense transverse transport of energy. However, the Reynolds number is not appropriate for natural convection scenarios where fluid motion is not imposed. The Prandtl number is crucial in heat transfer and represents the ratio of the fluid's kinematic viscosity, v, to its thermal diffusivity, a. The physical significance of the Prandtl number can be inferred from this definition.

$$\\ \begin{matrix}Pr = \frac{v}{α} = \frac{\begin{matrix}Ability of a fluid to transport momentum \\ by molecular means\end{matrix}}{\begin{matrix}Ability of that fluid to transport energy \\ by molecular means\end{matrix}} & ( 3.79 )\end{matrix}$$

While the Prandtl number for most liquids is much larger than unity, gases typically have Prandtl numbers in the range of 0.7-1. Another variable, the Peclet number, encapsulates the relative importance of convective thermal energy transport when compared with conductive (molecular) thermal energy transport. The Peclet number is related to the Reynolds number and the Nusselt number as follows:

$$\\ \begin{matrix}Pe = Re \times Pr = \frac{DV}{v} \times \frac{v}{α} = \frac{DV}{α} & ( 3.8 )\end{matrix}$$

The Rayleigh number (Ra) determines the transition to turbulence under convection. Convection induces fluid flow around an object through buoyancy forces caused by changes in fluid density due to heating or cooling. The Rayleigh number expresses the relationship between buoyancy and viscosity in the fluid resulting from convection.

$$\\ \begin{matrix}Ra = \frac{g β ( {T}_{f} - {T}_{c} ) {L}^{3}}{ϑ α} & ( 3.81 )\end{matrix}$$

where g is the gravitational constant, β is the coefficient of thermal expansion, T_{f} is the surface temperature of the fuel rod, T_{c} is the bulk fluid temperature, L is the characteristic length and a is the thermal diffusivity.

The Grashof number is another parameter that approximates the ratio of buoyancy to viscous forces and is defined as

$$\\ \begin{matrix}Gr = \frac{Ra}{Pr} = \frac{g β ( {T}_{f} - {T}_{c} ) {L}^{3}}{{ϑ}^{{}_{} 2}} & ( 3.82 )\end{matrix}$$

In mixed convection, where both fluid flow and heating/cooling are present, the Richardson number (Ri) is used to determine the relative effects of each. In the case of mixed convection, where both forced fluid flow and heating/cooling are present, the relative effects of each are determined using the Richardson number Ri.

$$\\ \begin{matrix}Ri = \frac{Gr}{{Re}^{{}_{} 2}} & ( 3.83 )\end{matrix}$$

Natural convection is considered insignificant when Ri<0.3, forced convection is considered insignificant when Ri>16, and both impacts are non-negligible when 0.3<Ri<16 (Kay et al., 2005).

### Finite Element Analysis

The finite element method (FEM) is a numerical technique for solving partial differential equations (PDE) in two or three space variables. To solve a problem, the FEM breaks down a complex system into smaller, simpler parts known as finite elements. To achieve this, the FEM uses discretization in space dimensions by creating a mesh of the object with a finite number of points. The boundary value problem is then formulated into a system of algebraic equations. These simple equations are combined to form a larger system of equations that models the entire problem. Finally, the FEM approximates the solution by minimizing the error function through the calculus of variations. This method of studying and analyzing the FEM is called finite element analysis (FEA) and is used to effect a solution of the Navier-Stokes equations. In fluid mechanics, the Navier-Stokes equations provide a general description of a fluid's mechanical behavior. The equations consist of two equations that ensure the conservation of mass and momentum. An additional equation accounts for the fluid's temperature and ensures the conservation of total system energy. Eq. 3.84 is the equation of motion for the fluid, equivalent to Newton's second law of motion, and provides a general way to describe the motion of a compressible viscous fluid subject to external body forces.

$$\\ \begin{matrix}ρ {v}_{t} - μ Δ v + ρ ( v \cdot ∇ ) v + ∇ p = f & ( 3.84 )\end{matrix}$$

where v is the velocity vector, p is the pressure, p is the fluid density, p is the dynamic viscosity, f represents body forces such as gravity. Another equation that explains the behavior of fluids is the continuity equation, which states that fluid mass is conserved during motion. It can be expressed as the sum of the divergence of the product of density and velocity.

$$\\ \begin{matrix}{ρ}_{t} + ∇ \cdot ( ρ v ) = 0 & ( 3.85 )\end{matrix}$$

Finally, the relationship between density, pressure, and temperature in a compressible flow is provided by an equation of state, which is the following equation.

$$\\ \begin{matrix}p = ρ RT & ( 3.86 )\end{matrix}$$

where, R is the gas constant. Although the Navier-Stokes equations are complex and numerical methods only approximate the real behavior of fluids, modem CFD simulation applications can produce very accurate results. This is often achieved by reducing the dimensions or simplifying the Navier-Stokes equations based on fluid flow behavior. A numerical mesh captures the system's boundaries and curvature so that the FEM can be applied to the geometry. Finally, an iterative solver with boundary conditions is used to solve the discrete equations and report the significant aspects of fluid behavior as it interacts with the system.

### Cfd Turbulence Model

In HTGR, the flow becomes turbulent despite being laminar in the core piping. Once the fluid jets enter the upper plenum, mixing causes the flow to become turbulent. As the fluid jets continue to mix, the turbulence intensity (TI) increases near the outlet. TI is a useful indicator for predicting how turbulent the flow is and is defined as the standard deviation of the velocity fluctuation divided by the average velocity over the same time period. Turbulent jets and plumes created in the bulk fluid region are free shear flows that are inhomogeneous and separated from the solid body. These jets and plumes exhibit similar turbulent motion characteristics, such as efficient mixing with the surrounding fluid, dissipation of kinetic energy to turbulence, conservation of momentum, and changes in jet/plume velocity and width as they move away from the source. However, the fundamental mechanism that drives them is different. Jets are driven by the source's momentum, while plumes are driven by buoyancy. If both momentum and buoyancy drive the mechanism, it is called a buoyant jet or forced plume. A state of universal equilibrium is reached when the rate of energy received from larger eddies is nearly equal to the rate of energy when the smallest eddies dissipate into heat. To capture the velocity and temperature fields, both globally and locally, in recirculation zones, advanced CFD techniques are utilized. However, current modeling approaches often employ multiscale averaging processes that can be limiting when trying to capture unsteady phenomena. This limits the ability of commercial CFD codes to capture unsteady turbulence multiscales encountered during transients in HTGRs. These complexities are dealt with by employing Reynolds-averaged Navier Stokes (RANS) methods that enable large scales of motion to be directly calculated while finer scales are characterized by a physics-based model. The k-epsilon (k-s) turbulence model is the most common model used in CFD to simulate mean flow characteristics for turbulent flow conditions. It belongs to the RANS family of turbulence models, where all the effects of turbulence are modeled. It is a two-equation model that describes turbulence using two transport equations viz. PDEs. The first transported variable in this model is the turbulent kinetic energy (k), while the second is the rate of dissipation of turbulent kinetic energy (F). Unlike earlier turbulence models, the more recent k-F model focuses on the mechanisms that impact turbulent kinetic energy and has more generality than the mixing length model. An underlying assumption of this model is that turbulent viscosity is isotropic, meaning that the ratio between Reynolds stress and the mean rate of deformation is the same in all directions. The exact k-F equations contain many unknown and unmeasurable terms. For a much more practical approach, the standard k-F turbulence model (Launder & Spalding, 1974) is used. This model reduces the number of unknown variables and uses our current knowledge of the relevant processes to create a set of equations that can be applied to various turbulent applications. For turbulent kinetic energy, k,

$$\\ \begin{matrix}\frac{δ ( ρ k )}{δ t} + \frac{δ ( ρ {ku}_{i} )}{δ {x}_{i}} = \frac{δ}{δ {x}_{j}} [ \frac{{μ}_{t}}{{σ}_{k}} \frac{δ k}{δ {x}_{j}} ] + 2 {μ}_{t} {E}_{ij} {E}_{ij} - ρ ε & ( 3.85 )\end{matrix}$$

For dissipation, F,

$$\\ \begin{matrix}\frac{δ ( ρ ε )}{δ t} + \frac{δ ( ρ ε {u}_{i} )}{δ {x}_{i}} = \frac{δ}{δ {x}_{j}} [ \frac{{μ}_{t}}{{σ}_{ε}} \frac{δ ε}{δ {x}_{j}} ] + {C}_{1 ε} \frac{ε}{k} 2 {μ}_{t} {E}_{ij} {E}_{ij} - {C}_{2 ε} ρ \frac{{ε}^{{}_{} 2}}{k} & ( 3.86 )\end{matrix}$$

Where ui is velocity component in corresponding direction, Eᵢⱼ is component of rate of deformation, μₜ is eddy viscosity, and σₖ, σₑ, C_{iE}, and C_{2E} are constants obtained by data fitting for a wide range of turbulent flows. The eddy viscosity can be defined as,

$$\\ \begin{matrix}{μ}_{t} = ρ {C}_{μ} \frac{{k}^{{}_{} 2}}{ε} & ( 3.85 )\end{matrix}$$

The value of the constants included in the above equations are as follows.

$$\\ {C}_{μ} = 0.09 , {σ}_{k} = 1. , {σ}_{ε} = 1.3 , {C}_{1 ε} = 1.44 , {C}_{2 ε} = 1.92$$

In summary, the above equations and the related phenomena can be described as the following.

Rate of change of k or ε in time+Transport of k or ε by advection=Transport of k or ε by diffusion+Rate of production of k or ε−Rate of destruction of k or F.

For the portion of the flow that is close to the wall (less than 20% of the height of the flow), the law of the wall (also called the logarithmic law of the wall) relates the velocity of a turbulent flow to wall distance. According to the law, the average velocity of a turbulent flow at a certain point is proportional to the logarithm of the distance from that point to the boundary of the fluid region. Although this law is only technically applicable to parts of the flow that are close to the wall, it is nonetheless a good approximation for the entire velocity profile. In CFD simulations, the y+ is a dimensionless quantity for the distance from the wall up to the center of the first fluid grid cell. In terms of the y+, the inner fluid layer near the wall boundary can be divided into three regions: the viscous sublayer (y+<5), the buffer layer (5<y+<30-50) and the log-law region (y+>30-50). Without wall functions, the quantity of y+ is typically around 1.

### Reactor Normal Operation

During normal operation, the reactor is at a steady state. A steady state is a situation in which all state variables are constant and do not change with time, or that maintains a state of relative equilibrium even after undergoing fluctuations or transformations. In nuclear reactors, a steady state must be achieved regarding criticality and heat transfer. Reactor criticality is the state in which a reactor is stable and self-sufficient to sustain a nuclear chain reaction. At the steady state, the reactivity of the system is zero, and the core power is constant. In terms of heat transfer, a reactor is at a steady state when the exchange of heat (thermal energy) between the physical systems in the reactor is constant even after fluctuations or transformations in the system variables. For a reactor to maintain a steady state, the amount of heat being produced within the system must be removed at the same rate. To achieve this, a liquid or gaseous coolant is circulated throughout the core and areas where heat is generated. The heat transfer capacity of the coolant must be equal to or greater than the rate of heat generation to prevent overheating and damage to the fuel. In designing a nuclear reactor, the TH involving the coupling of heat transfer and fluid dynamics and the nature and operation of the coolant system to accomplish the desired heat removal rate from the core under normal operation (and accident conditions) are some of the most important considerations.

### Reactor Off-Normal Events

The safety of a nuclear reactor design is ensured by several factors, such as the capability of the cladding to contain the FPs in both normal and off-normal situations, the neutron physics behavior of the core, the chemical stability of the core, and the design's ability to remove decay heat through natural heat transport mechanisms, preventing the fuel from overheating. To effectively judge the safety of designs, it is important to investigate all plausible transient scenarios and address complex and integrated plant responses. A reactor transient is a change in the reactor coolant system temperature, pressure, or both, attributed to a change in the reactor's power output caused by
adding or removing neutron poisons,
increasing or decreasing the electrical load on the turbine generator, or
accident conditions.

Loss of offsite power, fires, floods, earthquakes, and other external events may contribute to the initiation of some of the postulated transients and accident events. A typical set of transient event classifications typically studied while designing a nuclear reactor can be summarized as follows.

Anticipated Operational Occurrence (AOO): An AOO is an expected event that may occur one or more times during a plant's lifespan, typically with a mean frequency of occurrence of 10-2 per plant year or higher.

Design Basis Accident (DBA): A DBA is an infrequent event not expected within the lifespan of the plant but may occur once during the lifespan of a collection of plants. DBAs typically have a mean frequency between 10-2 and 10-4 per plant year.

Beyond Design Basis Accident (BDBA): A BDBA is a very rare event that is not expected to happen even during the collective lifetimes of a large number of similar plants.

However, plants are designed to mitigate the consequences of BDBAs by using safety-related equipment, operator actions, and even non-safety-related equipment while also considering long periods for corrective actions. BDBAs are usually associated with events that have a frequency between 10-4 and 5×10⁻⁷ per plant year. Typically, events with a frequency lower than 5×10⁻⁷ per plant year are not required to be considered or analyzed.

Gas-cooled reactor design has a long history of transient scenario analysis. The early US gas-cooled reactor designs including GCRE-1, EGCR, EBOR, and UTHREX, and early commercial power generation gas reactor designs such as Peach Bottom 1 and Fort. St. Vrain analyzed DBA scenarios and their safety impact (Melese & Katz, 1984). Before Fort St. Vrain's safety plant's closure (due to continual issues and poor availability; August & Hunter, 2008), significant operational experience and design knowledge was already gathered and documented (Copinger et al., 2004), and is now being expanded using more modem computer systems and software. However, these safety studies were limited in scope compared to modern DBA analyses. Nonetheless, these studies show that considering only one accident sequence, even if it is assumed to be the worst-case scenario, may not be enough. Instead, a comprehensive approach based on the defense-in-depth (DiD) principle should be explored to reduce the likelihood and impact of accidents. Under postulated accident scenarios, transient heat transfer from the core to associated systems, the reactor building, and the environment must be predicted reliably. This is done by coupled fluid flow calculations for temperatures and pressures in these systems. General Atomics and DOE laboratories performed accident analysis calculations for HTGRs (GT-MHR and MHTGR) for high-pressure conduction cool down (HPCC) and low-pressure conduction cool down (LPCC) transients in the past. In this dissertation, these scenarios will be referred to as pressurized loss of forced cooling (PLOFC) and depressurized loss of forced cooling (DLOFC). PLOFC and DLOFC accidents are also referred to, though less commonly, as LOFA (Loss of Flow Accident) and LOCA (Loss of Coolant Accident).

The normal operation and accident characteristics of modular HTGRs are very different from those of most standard power reactor designs. In transient scenarios, gas-cooled reactors, as opposed to conventional LWR designs, have many inherent safety features. These features include but are not limited to low power density, long transient time, passive safety and reliance on conduction, radiation, and some potential natural circulation. The slim core shape with a low power density and a high heat capacity gives it a long “grace period” during accident events, lasting tens or hundreds of hours. In case of forced cooling loss, the decay heat from the core is naturally conducted and radiated through the outer reflector and RPV to the ultimate heat sink. Thus, the plant response for HTGRs is less sensitive than conventional LWR designs to human factors and active mitigating system performance. Spent fuel accidents are possible in HTGRs but generally do not affect the reactor or primary system. Traditional DBA events such as loss of coolant or flow do not lead to the release of FPs, which makes the use of probabilistic safety assessment (PSA) and risk-informed decision-making different from that of LWRs.

### Plofc Accident

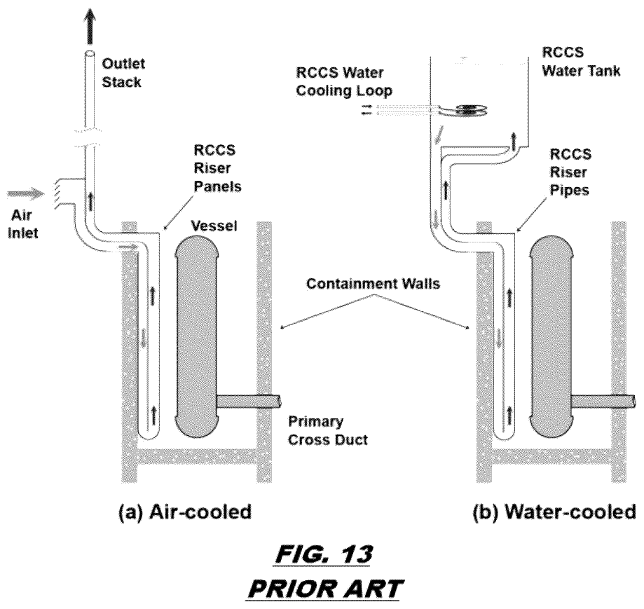

During normal operation, the coolant enters the reactor at the same temperature and density as the bulk coolant in the reactor tank. When passing through the active core, the coolant heats up and leaves at a higher temperature and lower density, creating a buoyant head that drives natural circulation in the absence of forced circulation. Natural circulation, or natural convection, or free convection refers to the spontaneous flow that arises from non-uniform volumetric forces such as gravitational, centrifugal, and Coriolis forces. In the event of a PLOFC accident caused by an abnormal trip of the primary helium circulator or turbine in the power conversion system or other mechanical failures, natural circulation caused by buoyancy-driven “chimney effect” distributes the core temperature, lowering peak temperatures from normal operational levels. To maintain acceptable core temperatures during accident events, the core decay heat needs to be removed by a combination of heat conduction, natural circulation or convection, and finally, thermal radiation to the RCCS. Such passive heat removal methods do not require any external power or operator intervention, making them more reliable. FIG. 13 shows the air-cooled and water-cooled RCCS design adopted by General Atomics and AREVA for the GT-MHR and MHTGR and the SC-HTGR design.

Events involved in a PLOFC transient.
Blower trip or mechanical failure leads to loss of forced flow through the core.
Circulator pump coast down, followed by scram. Control drums and rods are moved to shut down the reactor immediately.
Doppler broadening of the resonance capture cross sections in uranium reduces neutron resonance escape probability shutting down fission reaction.
Chimney effect causes the upper head and upper vessel temperatures to be higher than lower elevation temperatures. Forced down flow of coolant quickly yields to gravity-driven flow through coolant channels; the transition flow is complex.
Stable natural circulation is established when the driving force caused by gas density difference is sufficient to overcome the resistance along the path.
Core increases in temperature over many hours, then cools through passive heat decay.
Lower vessel structures drive ‘plenum-to-plenum’ currents and complex recirculation patterns.
Natural circulation at high pressure evenly distributes core temperatures, lowering peak temperatures from normal operational levels.
Assuming that the reactor shutdown cooling system (SCS) fails, the reactor core materials absorb part of the reactor decay heat, and the RCCS removes the rest by carrying vessel heat to the ultimate heat sink.

### DLOFC Accident

The DLOFC accident is the worst-case credible (or plausible) accident. Followed by an incident of air ingress or not, the DLOFC event belongs to the type of BDBA. During the DLOFC accident, depressurization events in the primary system may occur when there is a leak or break in one of the pipes in the primary system. Breaks can vary from small leaks (5 mm) to large pipe breaks (65 mm), leading to rapid depressurization within seconds or slow depressurization over hours.

Events involved in a DLOFC transient.
Circulation pump trip and coast down followed by control rod scram.
Helium in the reactor quickly bursts into the reactor cavity due to the large pressure difference, increasing the pressure of the cavity.
Break geometry/location inhibits air ingress. The pressure of the primary circuit gradually decreases until it equals the pressure of the reactor cavity.
After the pressure equilibrium is reached between the outside (reactor cavity) and the inside (primary circuit), the diffusion process begins.
Heat conduction is the primary heat removal mechanism since buoyancy-driven flow is reduced at low pressure. —Peak vessel temperatures occur near the center or “beltline” elevation.
RCCS functions normally and carries vessel heat to the ultimate heat sink.

The beltline of the reactor vessel is defined in Appendix G, 10 CFR Part 50 in NRC's design criteria as “the region of the reactor vessel that directly surrounds the effective height of the active core and the adjacent regions of the reactor vessel that are predicted to experience sufficient neutron damage to be considered in the selection of the limiting material with regard to radiation damage.”

### Air Ingress Accident

After a DLOFC event caused by a leak or break in one of the pipes in the primary system, air may enter from outside the primary system that occurs through natural convection mechanisms. This event is known as air ingress. The worst-case scenario is when the cross vessel that links the reactor vessel and power conversion unit breaks at both ends. The vessel and containment operate at pressures of approximately 3-7 and 0.1 MPa, respectively. In the HTGR, the RPV is situated within an air-filled reactor cavity during normal operation. As a result, after the depressurization process, the air-helium mixture in the cavity could infiltrate the RPV.

Events involved in air ingress transient.
After depressurization of the primary system, air slowly diffuses into the reactor.
The equilibrium pressure of the primary system with the reactor building is achieved.
Stable natural circulation is slowly established due to the difference in gas density between the coolant channel and reactor core.
Once stable circulation is achieved, air enters the reactor and flows from the bottom reflector, passing through the core, to the top reflector.
The air then passes through the circular channel to the cavity between the core barrel and RPV before exiting to the RCCS.

### Decay Heat

After a reactor trip (scram) from the hot full power (HFP) state, the actual thermal power drops more slowly due to a background power. This component of power is called “decay heat,” or “after heat,” or “afterglow.” Decay heat is primarily a result of the natural decay of radioactive FPs. In a fission reactor, FPs are initially formed with known concentrations, which change after the fission events. It is a random process and is governed by the radioactive decay law.

$$\\ \begin{matrix}\frac{dN}{dt} = - λ N & ( 3.87 )\end{matrix}$$

$$\\ \begin{matrix}N = {N}_{0} {e}^{{}_{} - λ t} & ( 3.88 )\end{matrix}$$

where No is the size of an initial population of radioactive atoms at time t=0 and λ is the decay constant that can be calculated from the half-life of individual nuclides. Gamma and beta decay energies released from the natural decay of the FPs contribute approximately 7% to 12% to the total energy generated through the fission process. The rate of negative beta particles emission by the FP is described by the following equation.

$$\\ \begin{matrix}{R}_{β} ( T ) = 3.8 \times {10}^{- 6} \frac{particles}{sec . fission} & ( 3.89 )\end{matrix}$$

where T is the time after the fission event in days. The second decay heat source from the rate of gamma photons emissions by the FP is given by:

$$\\ \begin{matrix}{R}_{{}_{} γ} ( T ) = 1.9 \times {10}^{- 6} \frac{particles}{sec . fission} & ( 3.9 )\end{matrix}$$

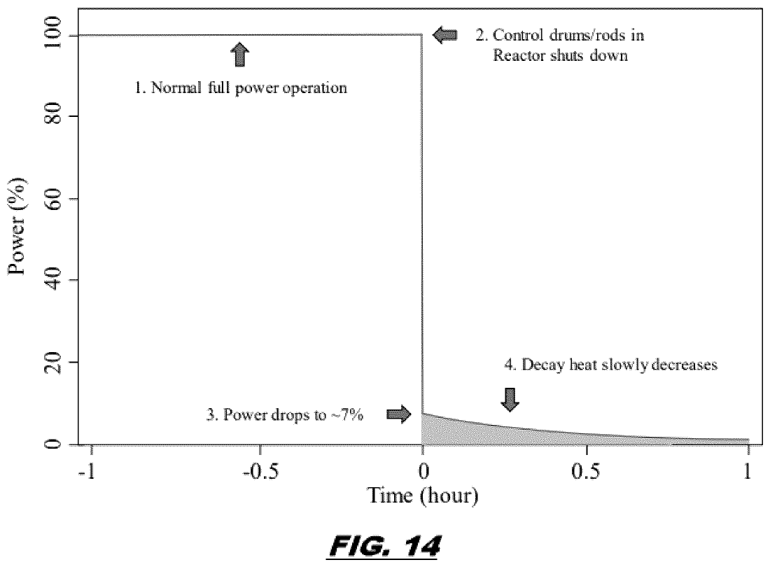

It can be noticed that the rate of beta emissions is twice the rate of gammas emissions. After a reactor is shut down, this source of radioactive decay energy still remains and cumulatively increases. Thus, the application of a heat removal system is necessary for maintaining the safety level of temperature inside the reactor core. The amount of heat produced by the reactor after shutdown is directly affected by two factors: the reactor's power history, which includes the accumulation of FPs prior to shut down, and the level of fuel burnup, which refers to the accumulation of actinides. Fission fragments with short half-lives are highly radioactive when produced and contribute significantly to decay heat, but they decay quickly. In contrast, fission fragments and transuranic elements with long half-lives are less radioactive when produced and produce less decay heat, but they decay more slowly. To estimate decay heat production, the Wigner-Way formula provides a rough approximation by using a single half-life that represents the overall decay of the core during a specific period.

$$P ( t ) = 6.48 \times {10}^{- 3} {P}_{0} [ {t}^{- 0.2} - {( {t}_{0} + t )}^{- 0.2} ] \qquad ( 3.91 )$$

where P(t) is thermal power generation due to beta and gamma rays, P₀ is thermal power before the shutdown, t₀ is time, in seconds, of thermal power level before the shutdown, and t is time, in seconds, elapsed since the shutdown. The decay heat power level is usually about 6-7% of the full power of the reactor immediately after a shutdown and diminishes to about 1% approximately one hour after shutdown and continues to drop, see FIG. 14. This recoverable energy release rate from the decay of radioactive FP is of great importance in the safety analysis of power reactors.

### Design

### Reactor Geometry

### Reactor Core

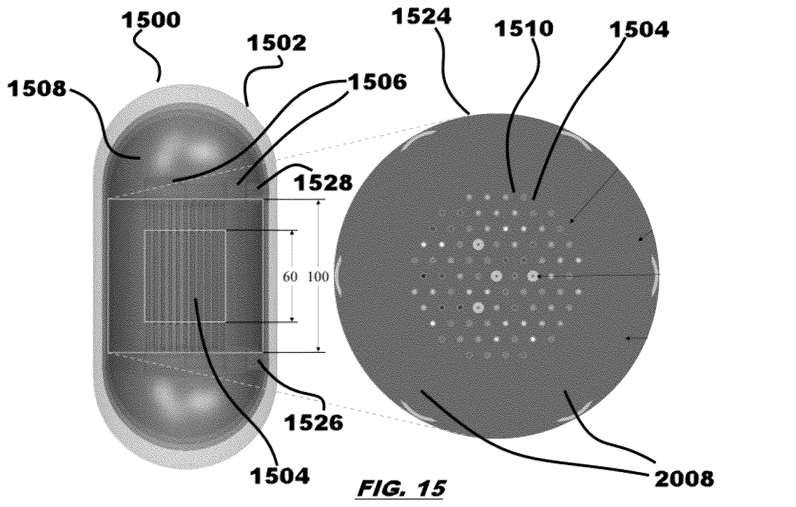

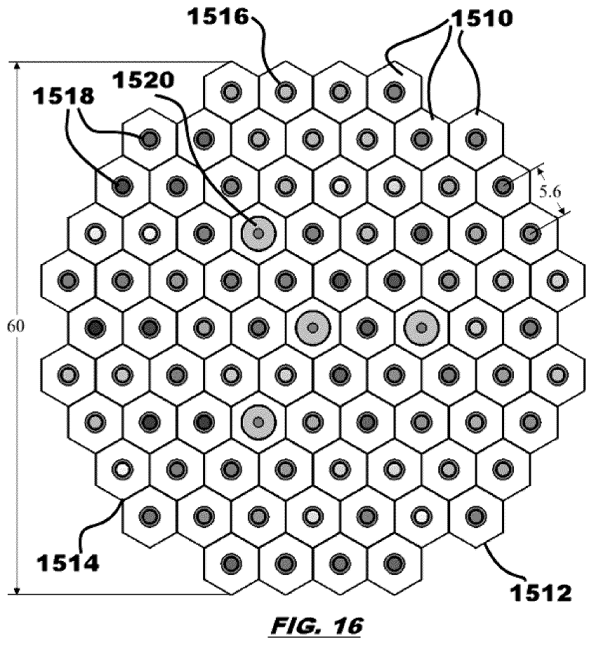

Referring to FIGS. 15, 16, and 17, MINION 1500 core 1504 has the shape 1502 of a right-circular cylinder with a volume of 0.17 m³. The active core 1504 is 60 cm tall and 60 cm in diameter. Surrounded by 20 cm BeO reflector elements 1506 above, below, and around the active core 1504, the core is contained within the central cavity 1508 of the RPV. Helium flows into the upper plenum 1528, then downward through the core, removing the energy generated in the core. In the lower plenum 1526, the coolant flows radially outward into the secondary heat exchange system where the energy will be transferred to the secondary coolant. The core assembly consists of 85 vertical columns of hexagonal moderator blocks 1510 arranged on a uniform triangular pitch. Each hexagonal block 1510 is wrapped with 0.05 cm thick SiC support structure/lattice 1512 and placed in the core in a “honeycomb” array 1514. Holes 1516 are drilled blind into moderator blocks 1510 to house the fuel rods 1518 and the control rod guide tubes 1520. Six control drums 2008 are placed at the outer edge 1523 of the core and four control rod guide tubes 1520 are placed in the active core 1504. Numbers in cm.

### Fuel Column

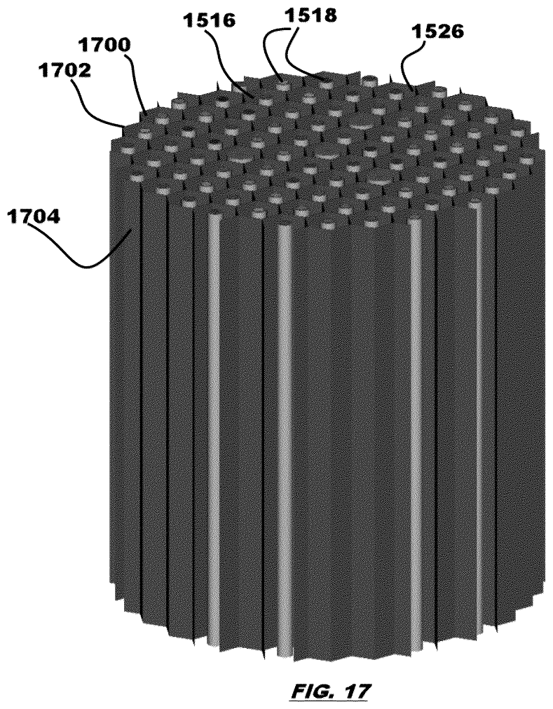

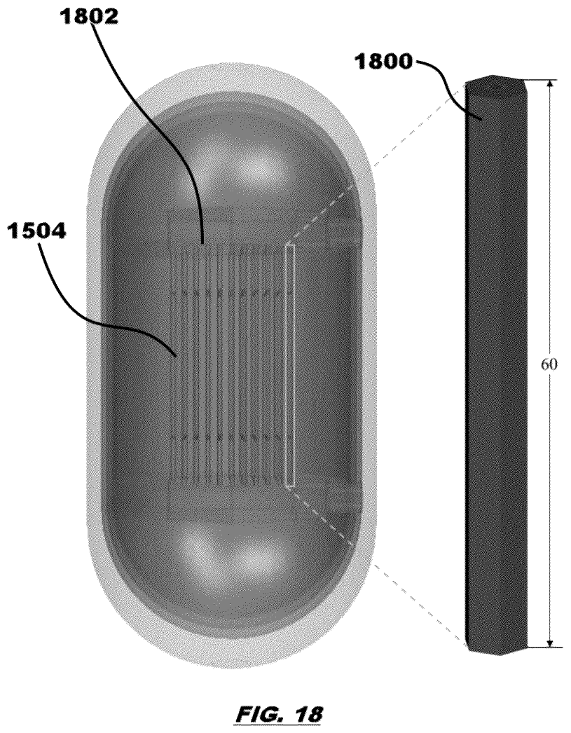

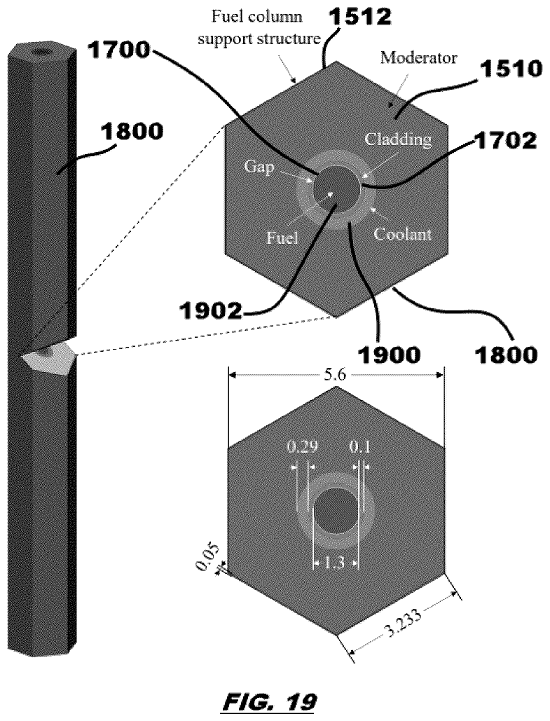

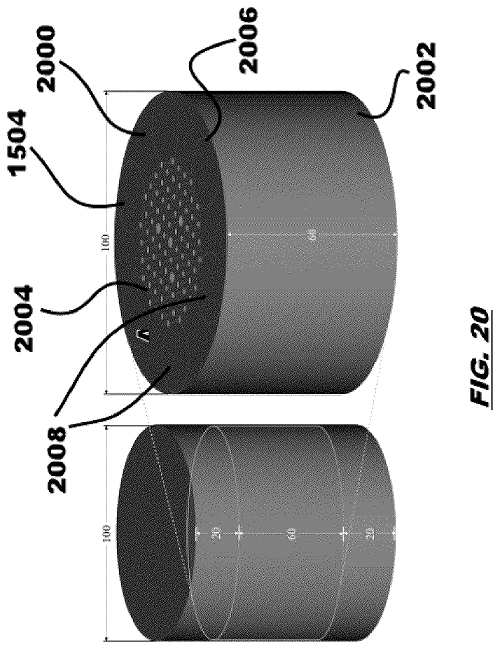

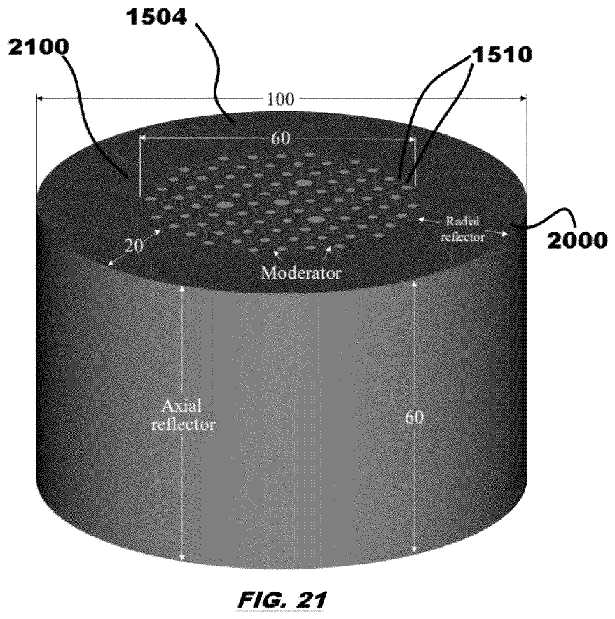

Fuel holes 1516 are drilled blind from the top face of the moderator block and are filled with bonded central fuel rods 1518. There are 81 fuel blocks in the core each containing a central fuel rod 1518, followed by a gap or gap region 1700, surrounded by cladding 1702. See FIG. 17. Each fuel rod 1518 is made up of individual fuel pellets. Pellets are approximately right-circular cylinders 1.3 cm wide. Each fuel pellet is contained within a 1 cm thick annulus cladding 1702. The clad 1704 is sealed at the top and the bottom to prevent FP release to outside. The clad 1704 also makes sure that there is no interaction between fuel and coolant. A 0.01 cm gap 1700 between the fuel and the cladding ensures that. The gap 1700 also allows room for thermal expansion of fuel. Additionally, FPs accumulating over time are contained in the gap 1700 region. During fabrication, the gap 1700 is filled with helium under pressure. This serves several purposes. First, the fillgas improves fuel to cladding heat conductance. Second, it maintains a pressure balance between inside and outside. Third, the background pressure neutralizes sudden pressure changes inside the cladding due to fission gas release. Coolant 1900 flowing outside the cladding 1702 picks up thermal energy produced by the fuel and leaves the active core 1504 through the lower plenum 1526. FIG. 18 shows a fuel column unit cell 1800 and the fuel column distribution 1802 in the core 1504. FIG. 19 shows the geometry and dimension of different regions that make up the fuel column 1800, i.e., fuel 1902, gap 1700, cladding 1702, coolant 1900, moderator 1510, and lattice support 1512.

### Moderator and Reflector

MINION 1500 core 1504 employs prismatic BeO blocks for support and neutron moderation. Rather than using one solid block, the core is divided into separate fuel assemblies to accommodate manufacturing and material stress concerns. Each hexagonal moderator block 1510 is 60 cm tall and 3.2 cm wide across the flats. Each block is clad by a 0.05 cm thick SiC/SiC composite providing support to the lattice structure. 85 such blocks come together in a lattice structure to make a 60 cm wide core 1504. The core 1504 is then shrouded by a 20 cm thick BeO reflector 2000—20 cm thick axially and 20 cm thick radially. This results in a 0.3 m³ right circular BeO cylinder 2002 with 85 internal holes 2004 to house the fuel rods and the control rods, and 6 internal holes 2006 to house the control drums 2008. Like the moderator blocks and reflectors, the control drums are made of BeO.

### Moderator and Reflector

MINION 1500 core 1504 employs prismatic BeO blocks for support and neutron moderation. Rather than using one solid block, the core is divided into separate fuel assemblies to accommodate manufacturing and material stress concerns. Each hexagonal moderator block 1510 is 60 cm tall and 3.2 cm wide across the flats. Each block is clad by a 0.05 cm thick SiC/SiC composite providing support to the lattice structure. 85 such blocks come together in a lattice structure to make a 60 cm wide core. The core is then shrouded by a 20 cm thick BeO reflector 2000—20 cm thick axially and 20 cm thick radially. This results in a 0.3 m³ right circular BeO cylinder 2002 with 85 internal holes 1516 to house the fuel rods and the control rods, and 6 internal holes 2006 to house the control drums 2008. Like the moderator blocks and reflectors, the control drums are made of BeO.

### Reactivity Control System

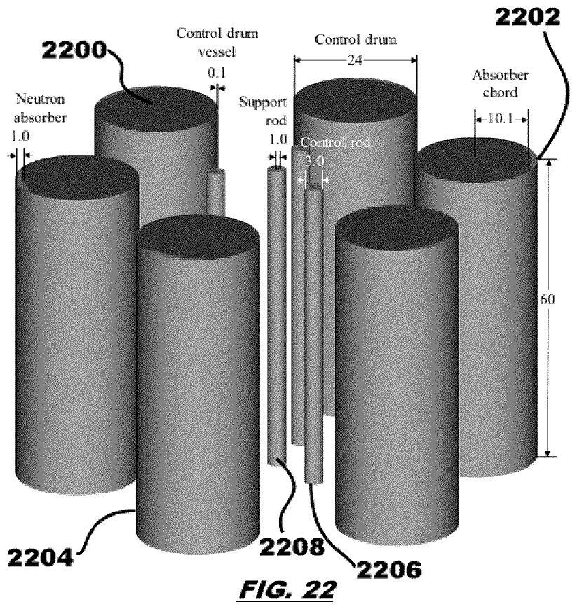

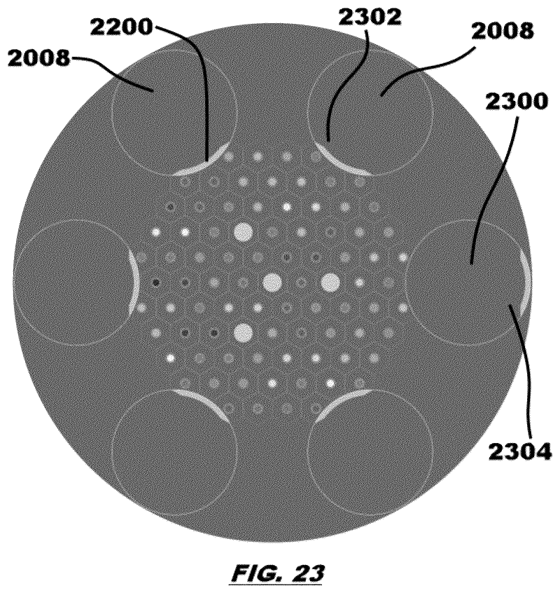

Core reactivity is primarily controlled by six control drums 2008 placed at the outer edge 1524 of the active core 1504. The drums 2008 are 60 cm tall running across the height of the core and 24 cm wide running across and slightly past the width of the side of reflector 2100 into the active core 1504. All six drums 1508 are made with BeO and clad in 0.1 cm thick stainless steel. The B₄C neutron absorber section/absorber 2200, see FIG. 22, forms an arc 2202 and is attached to the drum 2008 on one side 2204. The length of the absorber chords is 10.1 cm, and the thickness is 1 cm. The absorbers 2200 are rotated in and out with respect to the core 1504 by rotating the drums 2008. Under the “drums in” condition, the absorbers 2200 face the core causing the reactivity to sufficiently drop and the reactor to be placed in the shutdown condition. In addition to the six control drums 2008, four control rods 2206, see FIG. 22, each 3.4 cm wide and running across the height of the core 1504, provide additional reactivity control. Similar to the drums 2008, the control rods 2206 are also placed inside a 0.1 cm stainless-steel cladding. A 1 cm wide stainless steel support rod 2208 passing through the center of each control rod 2206 helps to move the rods. The support rods 2208 are moved in and out of the core 1504 by control drives. When inserted, three out of the four control rods 2206 provide enough negative reactivity to cause the reactor to shut down.

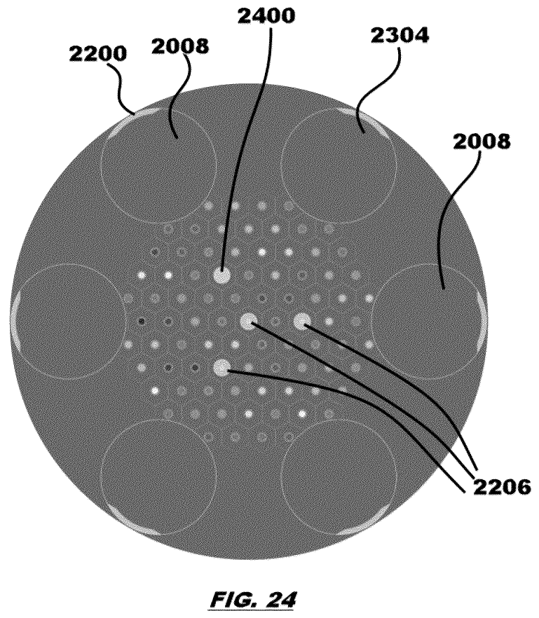

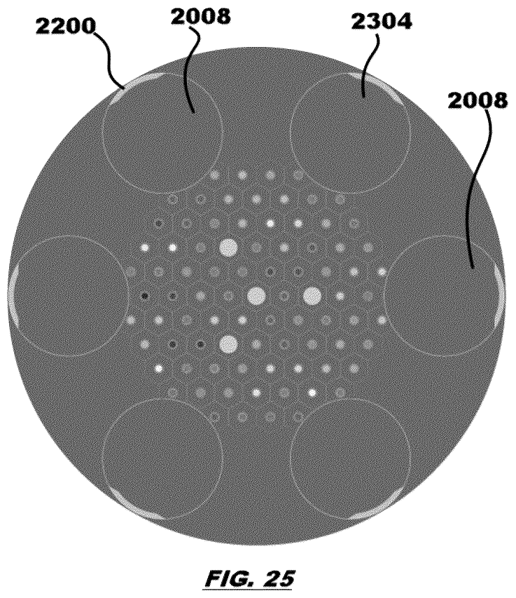

FIG. 23 shows primary shutdown mechanism with redundant reactivity control with five of the six control drums 2008 positioned to face core 1504 in arc inner position 2302. The reactor becomes sufficiently subcritical when all control drums 2008 are rotated out except for the one with the highest reactivity worth 2300 placed in arc outer position 2304. A total of 6 control drums 2008 primarily helps control the reactivity of the core 1504. FIG. 24 shows secondary shutdown mechanism with redundant reactivity control. The reactor becomes sufficiently subcritical when all control rods 2206 are inserted except for the one with the highest reactivity worth 2400. Three of the four control rods 2206 can sufficiently control the reactivity of the core when the primary shutdown mechanism is not functioning. FIG. 25 shows full power operation mode with all control devices in their out position. All 6 control drums 2008 and 4 control rods 2206 are moved away from the core for rated power generation.

### Plena, Barrel, RPV, RCCS

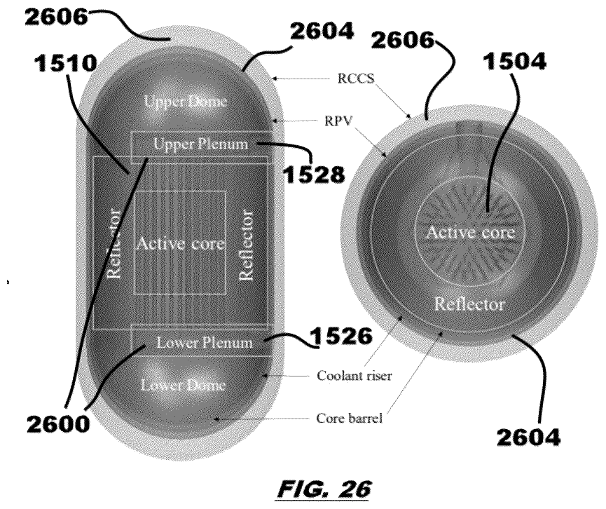

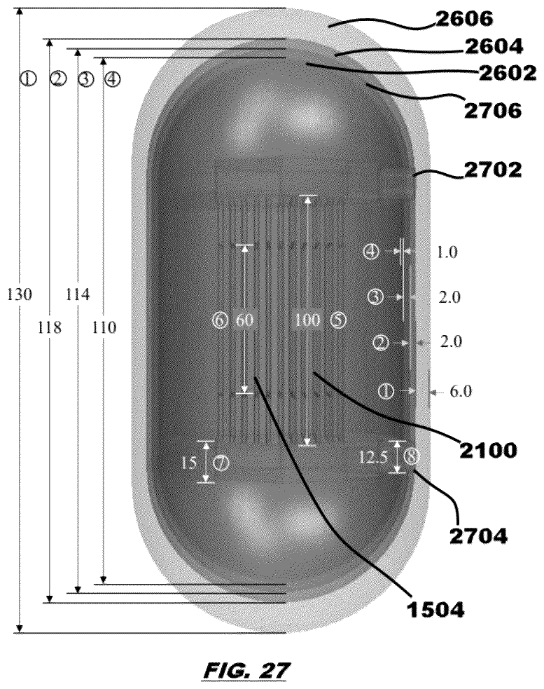

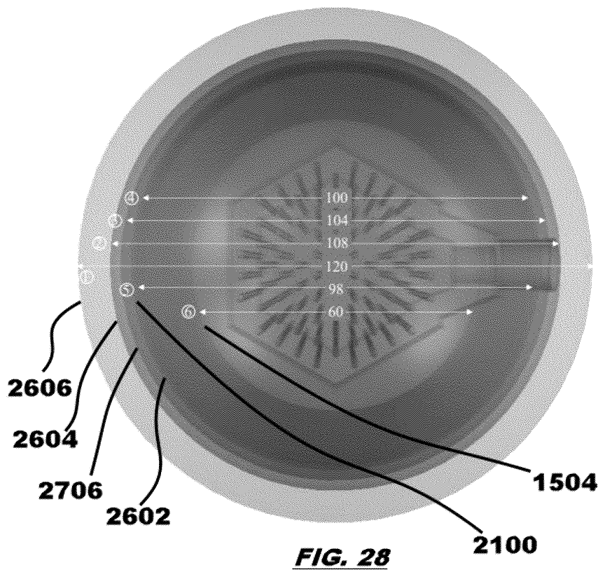

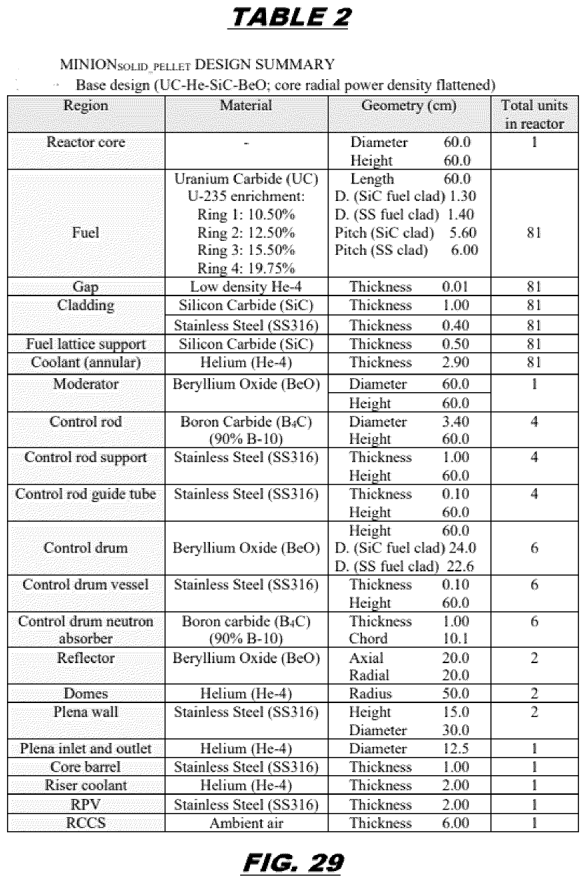

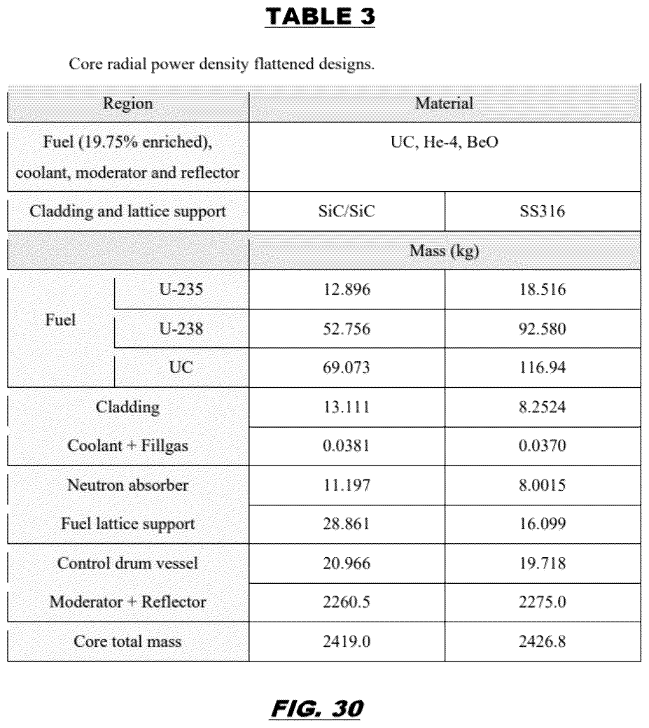

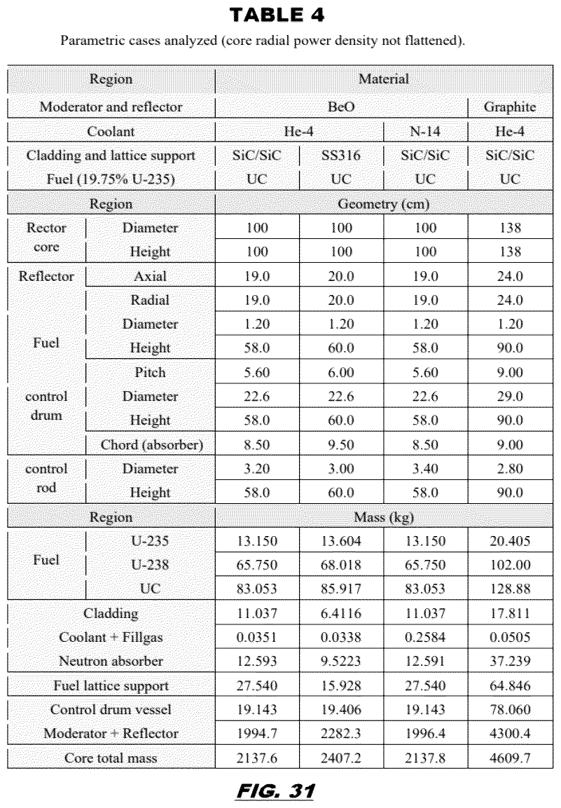

Referring to FIGS. 26 and 27, two approximately 60 cm wide (equals the active core diameter) and 15 cm tall hexagonal plena 2600, upper plenum 1528 and lower plenum 1526, connect to the core coolant channels. The upper plenum 1526 sits on top of the moderator block 1510, and the lower plenum 1526 is underneath the moderator block. Helium flows into the upper plenum 1526 through a 12.5 cm inlet 2702, downward through the core 1504, and exits to the lower plenum 1526. In the lower plenum 1526, the coolant flows radially outward through a 12.5 cm outlet 2704. The core 1504, including the plena 2600, is contained within the central cavity 1508 of the core barrel 2602. The barrel 2602 is 110 cm tall and 1 cm thick. A 2 cm wide gap between the core barrel 2602 and the RPV 2604 surrounding the barrel allows the helium coolant to rise from the bottom of the core 1504. The coolant flows around the core barrel 2602 and keeps it from becoming too hot. The 120 cm tall and 2 cm thick RPV 2604 is the outermost part of the reactor. It can be designed with features to increase radiative and convective heat transfer, such as external fins. This enables greater heat rejection than could be achieved with a smooth cylindrical vessel. Finally, the 130 cm tall and 6 cm wide RCCS 2606 acts as the ultimate heat sink and helps with passive heat removal from the RPV 2604 skin. FIG. 27 shows height and thickness of various parts of MINION: (1) RCCS 2606 (2) RPV 2604 (3) Coolant riser 2706 (4) Core barrel 2602 (5) Reflector 2100 (6) Active core 1504 (7) Plena (8) coolant inlet 2702/coolant outlet 2704. Uncircled numbers refer to dimension in cm. Uncircled numbers refer to dimension in cm. FIG. 28 shows diameters of the various parts of MINION: (1) RCCS 2606 (2) RPV 2604 (3) coolant riser 2706 (4) core barrel 2602 (5) Reflector 2100 (6) Moderator/Active core 1504. Uncircled numbers refer to dimension/diameter in cm. FIG. 29 shows Table 2, MINION solid pellet design summary. FIG. 30 shows Table 3, Core radial power density flattened designs. ADDITIONAL DESIGNS

A number of additional MINION designs are explored to provide a basis for future analysis. These designs are discussed in the following sections.

### Minion Annular_Pellet

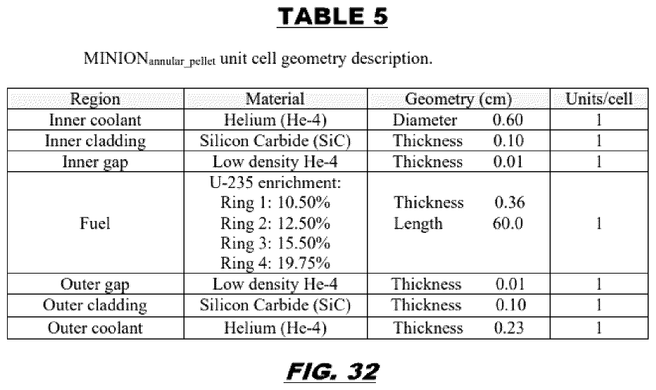

Building upon the MINION solid_pellet design, MINION annular_pellet design is investigated to improve the bulk coolant exit temperature. In the MINION annular_pellet design, annular fuel pellets are used so that the coolant flows through the fuel pellet internal channel in addition to flowing around the pellet. This modification led to a 50° C. higher coolant exit temperature, a 7.5% increase from the MINION solid_pellet design. Similar to MINION solid_pellet design, the annular fuel pellets are surrounded by a 0.1 mm thick cladding with a 1 mm gap between the fuel pellet and the cladding. The SiC fuel casing is then sealed by joining the inner and the outer cladding. The amount of fuel in each pellet is approximately the same as in the MINION solid_pellet design, resulting in least modifications to the MINION solid_pellet design. The size of the active core and the fuel rods remain the same. The pitch is also the same. The axial and radial reflector thickness remain unchanged. FIG. 32 Table 5, MINION annular_pellet unit cell geometry description.

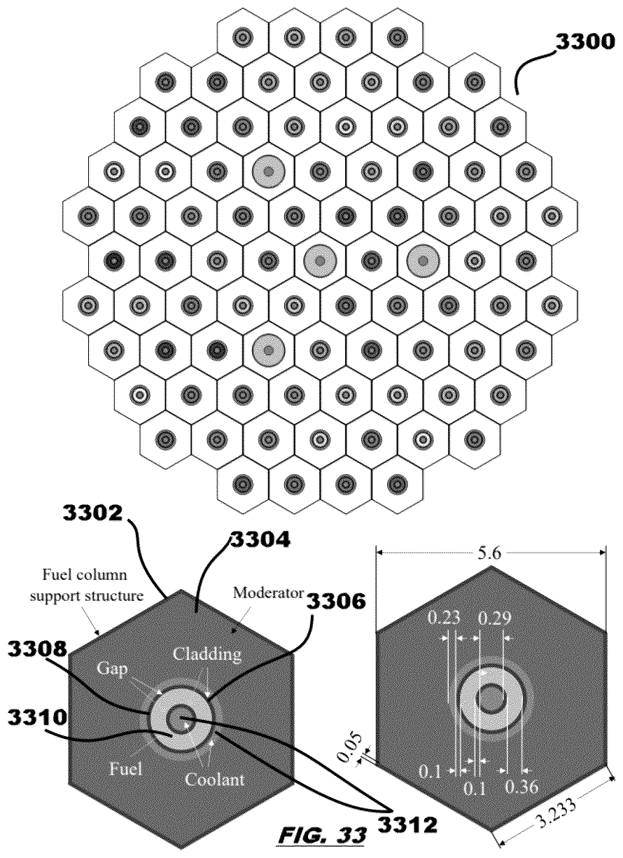

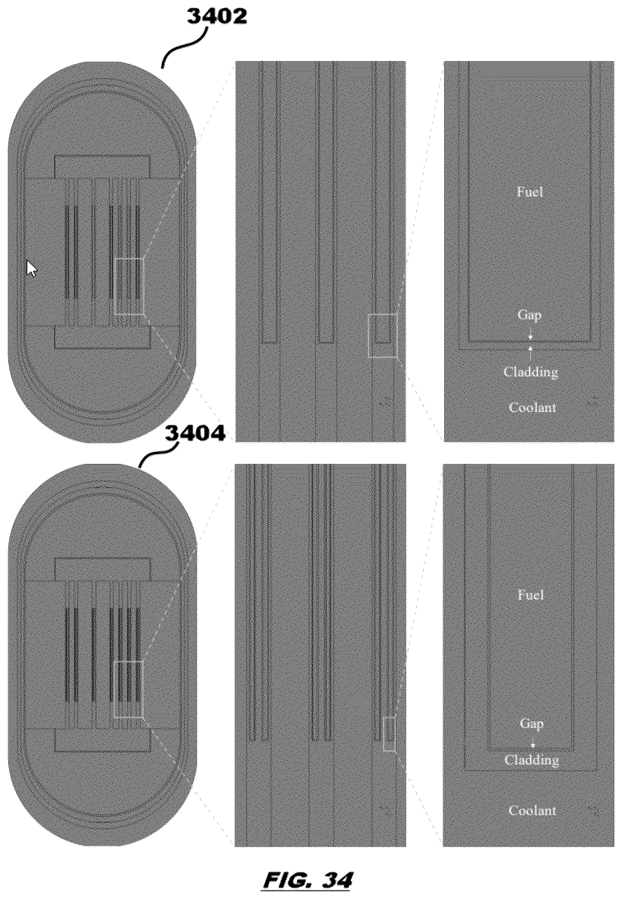

FIG. 33 shows Hexagonal lattice structure of annular-pin fuel assembly 3300 in active core (top) and a unit fuel assembly geometry and material specifications (bottom). Including annular fuel support structure 3302, annular moderator 3304, annular cladding 3306, annular gap, 3308, annular fuel 3310, and annular coolant 3312. Numbers in cm. FIG. 34 shows Axial midplane cross-section view of the fuel rod in MINION solid_pellet 3402 (top) and MINION annular_pellet 3304 (bottom) design.

### Minionleu_Fuel

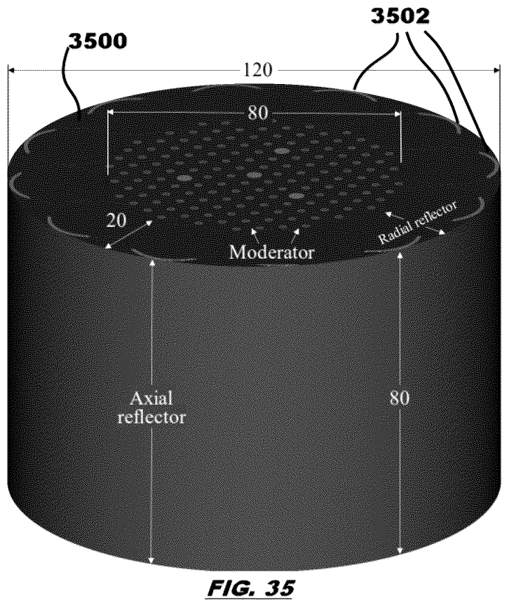

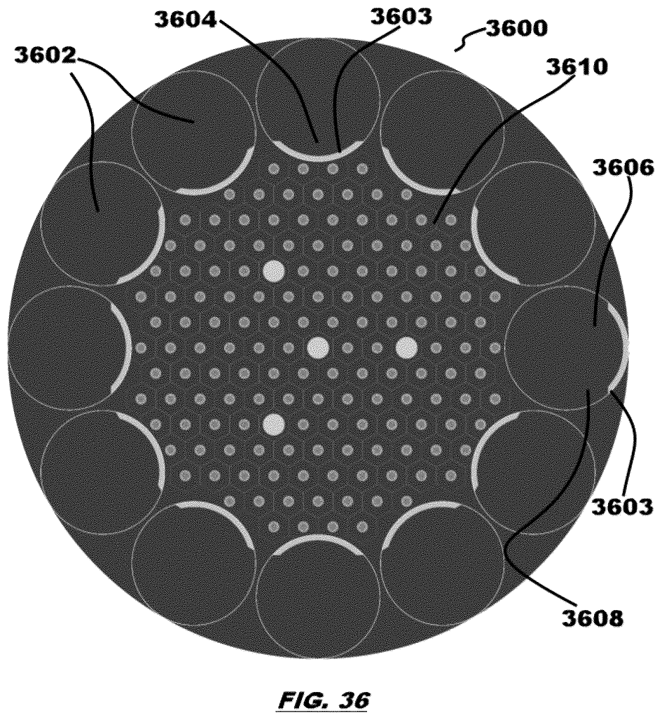

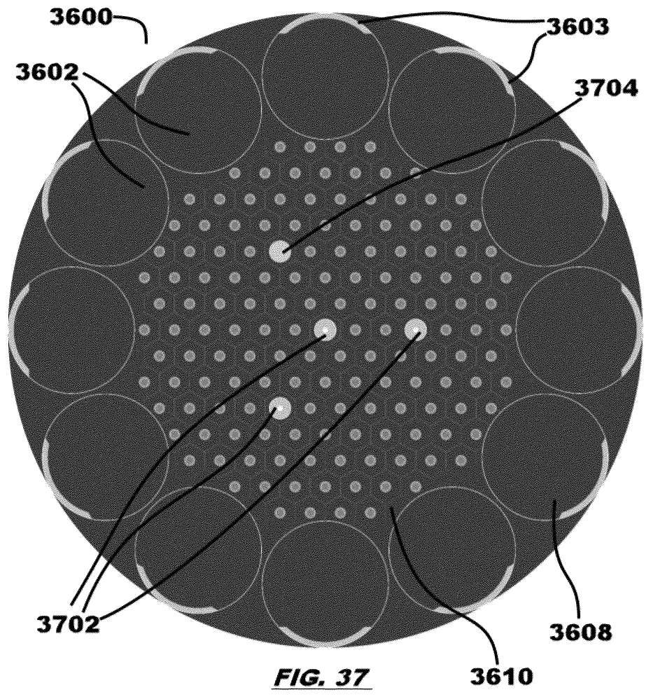

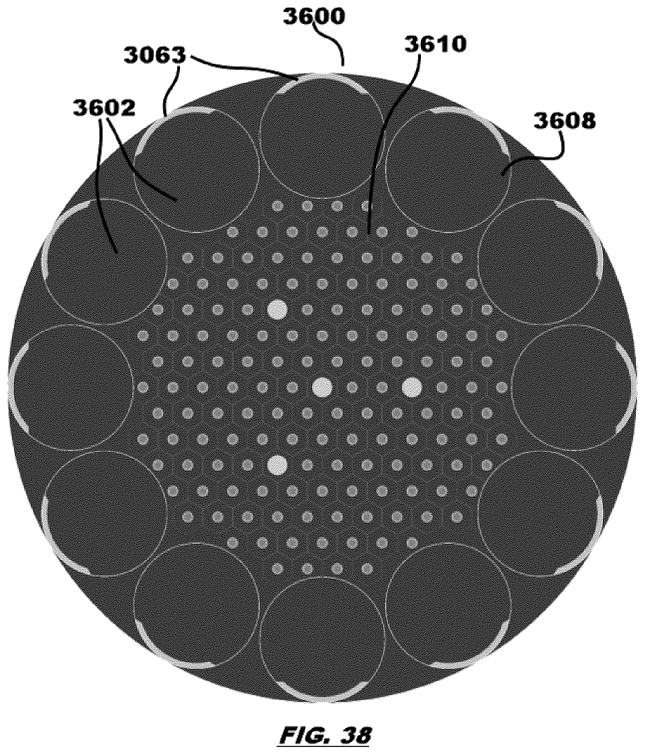

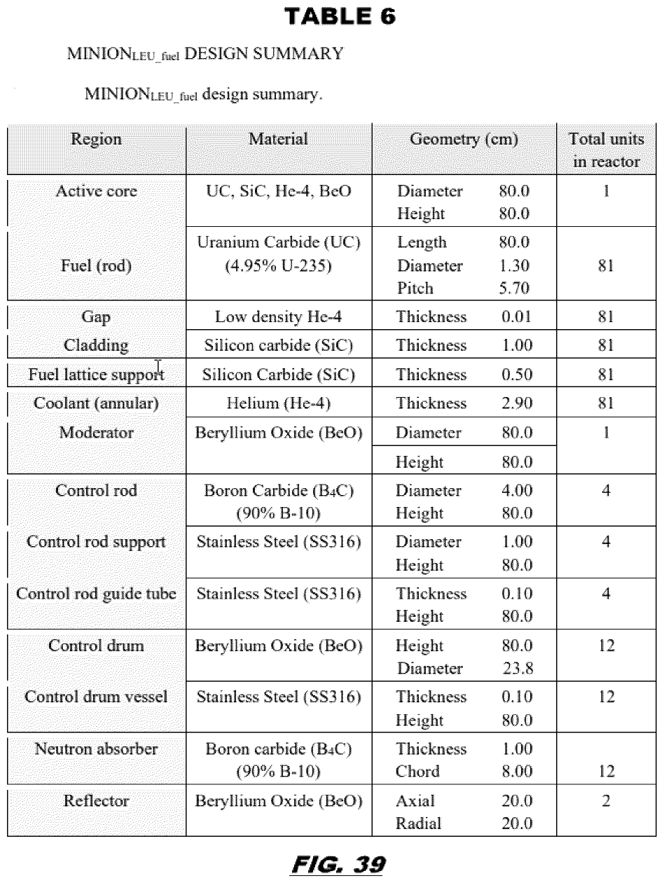

The MINION LEU_fuel design uses 4.95% enriched fuel throughout the core (radial power density not flattened). Thus, the amount of fuel in the core needed to be increased to achieve the core life goal of at least 10 years. As a result, the rector active core size increased from a 60 cm right circular cylinder to an 80 cm right circular cylinder. This involved updating the pitch, the fuel rod size, the number of control drums, the amount of neutron absorbers, and the dimension of neutron absorbers. While the primary and secondary shutdown margins are sufficiently satisfied, and the core-life goal is achieved with little to no excess reactivity. A summary of the design is included in Table 5, FIG. 32. FIG. 35 shows MINION LEU_fuel core 3500 geometry including the leu fuel reflectors 3502. FIG. 36 shows MINION LEU_fuel primary shutdown mechanism 3600 with redundant reactivity control. The reactor becomes sufficiently subcritical when all Leu control drums 3602 Leu arc absorbers 3603 are rotated Leu inward 3604 in except for the one with the highest Leu reactivity worth 3606 remaining with its Leu arc absorber 3603 in Leu outward position 3608. A total of 12 Leu control drums helps control the reactivity of the Leu core 3610. FIG. 37 shows MINIONLEU_fuel secondary shutdown mechanism with redundant reactivity control. The reactor becomes sufficiently subcritical when all Leu control rods 3702 are inserted except for the one with the highest Leu reactivity worth 3704. Three of the four Leu control rods 3702 can sufficiently control the reactivity of the core when the primary shutdown mechanism is not functioning. FIG. 38 shows MINION LEU_fuel core 3500 at full power operation mode with all control devices in their out position. In this mode of operation, all 12 control drums 3602 and 4 control rods 3702 are moved away from the Leu core 3500 for rated power generation. FIG. 39 shows Table 6, MINION LEU_fuel DESIGN SUMMARY.

### Reactor Materials

In nuclear reactor design, compatibility of each fuel assembly with the neutronic and thermohydraulic characteristics of the original core and under accident scenarios must be considered and physical and chemical compatibility and mechanical and thermal-hydraulic response of various materials must be analyzed. Phenomena such as fuel-cladding interactions (FCI), cladding failure, fuel microstructure, eutectic formations, and FP release mechanisms, among others, need to be considered. In particular, the chemical compatibility of cladding with fuels under normal operation and accident conditions is of great importance since the cladding inner surface may come in contact with the fuel. FP transportation and interactions with the cladding constituents and internal interfaces need to be considered for all gaseous and solid FPs. With the recent introduction of accident tolerant fuels (ATF), high-burnup, and increased enrichment for fuels, ATF may impact the progression of severe accidents, release, and transport of radionuclides, with implications on safety and regulatory requirements. Increased core burnup and longer cycle times (compared to LWR designs) from using HALEU fuel will increase neutron fluence and neutron dose and fuel, cladding, and vessel material radiation exposure. Ferritic materials are susceptible to atom displacement by neutrons with 0.5 MeV energy, which increases the risk of brittle failure in ferritic RPVs (USNRC, 2019). For temperatures above 800° C., no steel can be employed. Only high Ni austenitic steels like alloy 800 can be used. Ni-based alloys such as Inconel 617, Haynes 230, and Hastelloy X are also suitable for components such as heat exchangers and power conversion systems outside the core. However, these alloys may face severe irradiation-induced embrittlement and swelling (if in the core. Structural 119 material behavior important for reliable performance includes the following (Cizek et al., 2021).
Thermal creep in multiple product forms, such as thin-walled tubing, thin sheet, thick plate, and rod or bar;
Fatigue, creep-fatigue resistance, and creep crack growth resistance;
Resistance to irradiation effects such as creep, swelling, and embrittlement;
Resistance to environmental degradation from helium impurities: fuel, FPs transmuted elements and thermal aging;
Good fabricability, welding, post-weld thermal annealing, and dissimilar metal joining.

### Fuel: Uranium Carbide

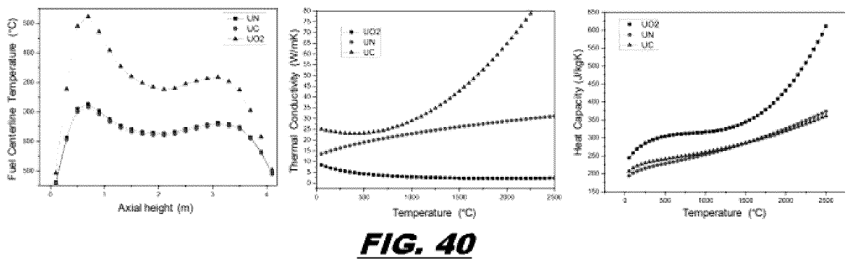

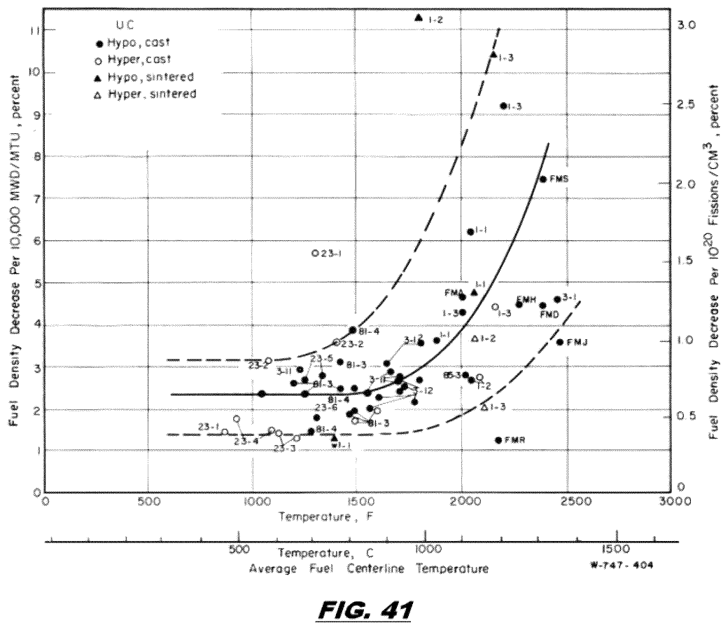

Since the beginning of nuclear power generation, uranium oxide (UO₂) fuel has been the most commonly used nuclear fuel in commercial nuclear reactors. Thus, UO₂ fuel offers vast operating experience and a well-developed fuel cycle. However, UO₂'s poor thermal conductivity, which decreases further at higher temperatures (Grande 2010), has made it unsuitable for high-temperature reactor applications. A number of works studying other oxides, such as ThO₂ and mixed oxides (MOX), and novel fuel forms beyond oxides, such as UC, UC₂, UN, and metallic uranium alloys indicate a trend toward finding an alternative to UO₂ fuels for advanced applications (Grande, 2010; Pascoe et al., 2010; Naidin et al., 2010). UC₂, UN, and UC fuel centerline temperature are significantly lower than UO₂ (FIG. 40), making these fuels a superior choice for high power-density and high temperature applications. Besides, the high thermal conductivity and the high melting point of UN and UC fuels (FIG. 40) allow for compact and high-temperature reactor design, 120 making them good choices for space reactors. Among the three, UC is particularly attractive because of its 30% higher uranium density and six fold greater thermal conductivity. As with UO₂, structural changes in irradiated UC are generally not significant. This is primarily a result of UC's good thermal conductivity and the fuel operating at a smaller fraction of its melting point. Its lower linear expansion coefficient, smallest axial temperature gradient, higher metal atom density, and higher compatibility with cladding materials means that there will be smaller thermal stresses induced in the fuel pellets and cladding, which may reduce the likelihood of fuel pellet cracking and FP release. As with UO₂, fission gas release from UC greatly depends on temperature. Substantial release occurs above 1300-1400° C. Below this temperature, gas release is generally <1%. Below 1000° C., gas release is 0.1% of the amount produced (Reusser, 1982). Hyperstoichiomctric (<4.80 wt % carbon) UC exhibits a minimum isotropic volume increase of approximately 2% per 10 MWd/kgU around 1000° C. (Jones, 1972). As the temperature continues to rise, swelling increases due to the precipitation of fission gas bubbles. Up to 60% of the fission gas generated within carbide fuel is trapped within the defects of the carbide matrix and retained within the matrix (Nickerson & Kastenberg, 1976). As temperature increases further, fission gas generation is balanced by gas release, and swelling slows or ceases.

### Cladding: Silicon Carbide

For over seventy years, zirconium (Zr) alloys have been used as cladding and fuel assembly structural materials of the most common water-cooled reactors like VVER, PWR, CANDU, BWR, and RBMK. Recently, composite cladding has been investigated as a potential alternative. In particular, continuous SiC fiber-reinforced SiC matrix ceramic composites (SiC/SiC composites or SiC composites) are among the candidate alternative materials for the Zr-based alloys with the goal of more accident-tolerant fuels. There are several reasons for this transition from using Zr alloys to SiC composites: the intrinsic behavioral differences between ceramic composites and metallic alloys, the tailorable and 122 anisotropic nature of composite properties, and the complexity of interactions among irradiation-induced evolutions of thermophysical properties. In particular, SiC/SiC composite is being considered for ATF cladding because of its exceptional radiation resistance and outstanding passive safety features (Mankins, 1995; Jayes & Porter, 2007). Compared to Zr-alloys, SiC composites are anticipated to provide lower neutron absorption cross sections, higher fuel burn-ups and higher temperatures, exceptional inherent radiation resistance, lack of progressive irradiation growth, and low induced activation/low decay heat. In case of a severe accident, the margin to melting places the SiC/SiC composites in a more favorable position than the Zr-based alloy claddings. Its low density, high strength, high melting point, high hardness, excellent thermal shock resistance, and superior chemical inertness provide outstanding passive safety features in BDBA scenarios (Mankins, 1995; Hayes et al., 2007). The list of reactor concepts that had employed SiC as the cladding material include Allegro (the year 1964), GFR600 (the year 1968 and 1974), GFR2400 (the year 1968), JAEA GFR (the year 1968), PB-GFR and EM2 (the year 1970 and 2008). Composed of multiple layers, SiC cladding has an enhanced ability to withstand damage and avoid a complete failure of the cladding tube (Kim et al., 2013). Its inner monolithic layer provides strength and hermeticity for the tube. The central composite layer of SiC fibers infiltrated with SiC adds strength to the monolith while providing a pseudoductile failure mode in the hoop direction. The outer SiC coating protects against corrosion. With little or no grain boundary impurities, SiC ceramics maintain their strength to temperatures approaching 1600° C. with no strength loss (the first liquid phase appears within 1600-1700° C.). The high thermal conductivity (approximately as high as aluminum for very pure SiC with no porosity) coupled with low thermal expansion and high strength is 123 what gives SiC exceptional thermal shock-resistant qualities. The crystal lattice of SiC, composed of tetrahedra of carbon and silicon atoms with strong bonds, produces a tough and strong material that is not attacked by any acids or alkalis up to 800° C. In the air, SiC forms a protective silicon oxide coating at 1200° C. and can be used up to 1600° C. Its strong resistance to oxidation in air and air-moisture atmospheres and no unacceptable phase changes have the potential to provide lower fuel operating temperatures and improved safety. SiC is chemically compatible with reactor materials throughout the normal and accident temperature range. There is no possible reaction between SiC/SiC cladding and helium coolant, such as might occur between Zircaloy and water at high temperatures. While SiC is susceptible to reaction with various FP elements in the fuel system, the SiC clad temperature is not sufficient to promote significant interactions due to the reaction kinetics. Studies of high-temperature reactions between UC and b-SiC have shown similar reactivity between the two materials at temperatures above 1500° C. (Ferguson & Walker, 1970; Holleck & Kleykamp, 1962). This is consistent with the findings reported by Silva et al. (2015). When UC granules were coated with b-SiC and subjected to thermal exposure, reactions at temperatures above 1600° C. resulted in the presence of a molten eutectic zone, producing the reaction products UC2, USi₂, and U₃C₃Si₂ (Ferguson & Walker, 1970). The growth kinetics of the reaction layer between uranium and SiC is expected to follow an Arrhenius relationship, with an activation energy of 2.95 eV and a pre-exponential term of 1.34×10⁻⁶ (m²/s) (Ferguson & Walker, 1970; Holleck & Kleykamp, 1962). This would equate to a uranium interaction depth of less than 1 m for exposure times up to 10,000 hours at the temperatures expected for SiC-CMC clad operation. This Arrhenius behavior is only believed to be valid above the temperature where the liquid eutectic phase is present. 124 This extrapolation supports the conclusion that UC and SiC are compatible at temperatures below 1600° C. (Ferguson & Walker, 1970). SiC/SiC composites are being used as a candidate structural material in fusion reactors where a high temperature and high-radiation environment are expected. A multi-year irradiation campaign by the Oak Ridge National Laboratory (ORNL) has shown that SiC remains stable under long-term irradiation (Katoh, 2002; Nozawa, 2009). Additionally, SiC is considered to be permanently stable in nuclear waste. This, coupled with low induced activation/low decay heat, dramatically improves the safety of SNF wet storage, dry cask storage, and repository disposal. While SiC composites are an attractive choice for high-temperature nuclear reactor applications, such as fuel assembly components, core internal and other in-vessel components, control rod drive components, hanger straps for high-temperature and very-high temperature reactors, cladding and other components of gas reactors (Katoh et al., 2018), there are some key issues associated with their application. These issues are mainly related to fiber and matrix stabilities and the relatively poor thermal conductivity of SiC/SiC under neutron irradiation, though matrix processing for porosity control and densification have shown to improve thermal conductivity (Snead et al., 2007). Another significant radiation induced degradation of SiC, which can hurt its performance, is the brittle nature of SiC and swelling. The swelling that occurs between the amorphization threshold (˜150° C.) and the start of the radiation-induced void contribution (˜1000° C.) is known as “transient swelling.” This swelling accumulates at a rate dependent on the irradiation temperature and dose until it reaches a saturation value that depends only on temperature. The approximate magnitude of saturation swelling is ˜2% at 300° C. and ˜0.7% at 800° C. (Snead et al., 2007). This saturation continues up to a dose of ˜70 dpa (Katoh et al., 2018). The effect of neutron 125 irradiation on SiC/SiC composites is summarized in a study by Katoh et al. (2014). In some scenarios, SiC cladding technology is considered a candidate for longer-term deployment due to fabrication challenges and other issues, though fabricability has significantly improved recently. The chemical vapor infiltrated (CVI) SiC/SiC composite technology has demonstrated its capability to produce large components with reasonable reproducibility. General Atomics has produced approximately 1-m-long SiC/SiC composite tubes through a CVI process with adequate straightness, wall thickness uniformity, roundness, and surface roughness. Various techniques for joining SiC-based materials, especially the end plugs in ATF cladding have been studied, developed, and assessed. 3D printing of SiC cladding using the femtosecond laser technology in combination with conventional laser powder bed fusion 3D printing has already shown potential. SiC cylinders of 0.5 inches (12.7 mm) outer diameter were fabricated by laser-powder bed fusion additive manufacturing. The technology readiness level (TRL) of various cladding materials for advanced nuclear fuels summarized by Daniel Shepherd at the UK National Nuclear Laboratory (NNL).

### Moderator/Reflector: Beryllium Oxide

At high temperatures, the two leading candidate moderator materials for helium cooled reactors are beryllia (beryllium oxide, BeO) and graphite. Among the two, BeO produces the highest-worth reflector, providing robust reactivity margins for safety and operation, leading to low fuel and overall system mass. Beryllium metal has the lowest thermal neutron absorption cross-section among all metals. This property, combined with a large scattering cross-section, high melting point, and good strength, makes it an excellent moderator and reflector material. BeO not only has a low neutron absorption cross-section but forms neutron through (α, n), (γ, n), (n, 2n) reactions. High-purity BeO has larger (energy loss by neutron per collision) and a lesser number of collisions for thermalization as compared to graphite. It has very low vapor pressure at high temperatures and shows no detectable variation from the stoichiometric composition. Its physical and mechanical properties are, in most cases, sufficient to meet the basic material and engineering requirements for core components. BeO has exceptional resistance to thermal shock for an oxide ceramic. Some of its outstanding attributes are high thermal conductivity, high refractoriness, compatibility with fuels, and inertness with gas coolants of interest up to 1600° C. Owing to its high thermal conductivity BeO is also used as a matrix of dispersion fuel elements. It is the best moderator among high-temperature oxides. Pure Be can also be a choice as a moderator material, but there are a few advantages of using BeO rather than pure Be. Studies have shown that BeO acts as a better reflector than Be by increasing the core excess reactivity and the reactor operation time (Dawara et al., 2015). The density of beryllium is also a good indicator of relative effectiveness as a moderator and reflector material. The density of beryllium in BeO is about 3.08 g/cm³, while the density of the 129 pure Be is 1.85 g/cm³. The melting temperature of BeO at 2527° C. is much higher than that of Be at 1287° C. It possesses attractive nuclear and high-temperature properties by increasing the thermal and epithermal fluxes in the peripheral assemblies (Manly, 1964).

Although BeO has high thermal conductivity, its thermal conductivity decreases markedly with increasing temperature. However, BeO do not suffer from severe degradation in thermal conductivity when the fast neutron dose is lower than approximately 1019 n/cm² even at 60° C. (Snead, 2005). Data on thermal conductivity of irradiated BeO is still scarce nowadays, however, a consensus is that once cracks appear, the thermal conductivity of irradiated BeO will be greatly reduced (Hickman, 164; Snead, 2005). Additionally, under irradiation and at temperatures <800° C. (˜40% homologous temperature), BeO suffers from a large anisotropic dimensional change. Above ˜35 homologous temperature, the useful temperature for fine-grained BeO increases substantially (Collins, 1964). The dimensional change of BeO leads to rapid microcracking and significant mechanical degrading at less than 1 dpa. Helium forms on grain boundaries at 600° C. and helium bubble formation occurs above 800° C. Although substantial transmuted helium is retained in the structure, helium bubbles may drive the swelling to an unacceptable degree (Wilks, 1968). At ˜1100° C., only 25% of the transmuted helium is released from the ceramic. Although the oxide of beryllium has a low vapor pressure in a dry atmosphere, it vaporizes rapidly in the presence of heat and moisture as a result of the formation of hydroxide.

In dry air Be+%½-»BeOΔH=−610kJ/mol(4.)

In steam Be+H2O-»BeO+H₂ΔH°=−367.8kJ/Mol (4.2)

This is a significant drawback, especially in view of the extreme toxicity of beryllium and its compounds. However, it is important to note that most beryllium oxidation studies have been carried out at low temperatures and low oxygen pressure or low steam partial pressure. In contrast, more severe conditions with temperatures ranging from 400° C. to 1200° C. and a range of pressures from 0 to 10 bars are anticipated in fission reactors. The quality of the material also needs to be considered, as the release of hydrogen is highly dependent on the quality of the material. Using dense beryllium will ensure that its metallic qualities will hold on under prolonged irradiation. The main gaps in the knowledge of beryllium oxidation correspond to the behavior at air or steam pressures beyond the atmospheric pressure and to the influence of the quality of the material. The key points about beryllium interaction with air and water under accident scenarios can be summarized below (Boisset, 1994):
The chemical reaction between beryllium and air or steam leads to protective oxidation, which follows a parabolic yield.
After a certain time and depending on the temperature, pressure, and quality of the material, there is a breakaway, and the oxidation phenomenon becomes linear.
The breakaway occurs when the temperature and pressure are higher, and the material is porous and embrittled. In the case of a beryllium/steam interaction at 750° C., the breakaway occurs after 1 hour at 0.001 atm and after a few minutes at 0.85 atm.

### Coolant: Helium

Gas coolants, especially helium and carbon dioxide, have been widely used in nuclear power plants for quite a long time. However, the required high volumetric flow rates of gas coolants led to design complications and increased costs. This is one of the major disadvantages of carbon dioxide. The increased primary coolant pumping power required for carbon dioxide becomes an economic penalty. At operating conditions of advanced gas cooled reactors, helium produces substantially lower gas forces and requires less pumping power than carbon dioxide (molecular weight 4 vs. 44 kg/mol). Additionally, helium has the most favorable thermophysical and nuclear properties of all gases. Helium is a gaseous fluid that is chemically inert and does not add any effective reactivity. These properties are retained at temperatures well above those limits acceptable for structures and materials. Therefore, there is no limit to allowable temperatures imposed by the coolant itself. However, flow in the reactor passages must be maintained to keep the core, support structure, and components within design limits. Under operating conditions, helium behaves similarly to an ideal gas. Since helium is operated in a supercritical state far from the critical point, significant disruptions in natural circulation, mechanical damage from flashing coolant, or sudden changes in cooling capacity due to minor variations in pressure or temperature should not occur (Waltar, 1981). Helium avoids the radiolytic dissociation problems associated with carbon dioxide. The specific heat of helium is higher than that of carbon dioxide. The thermal conductivity of helium is 10 times greater than that of carbon dioxide. This combination of high thermal conductivity and specific heat coupled with chemical inertness gives helium unique advantages over any other gas, especially at higher temperatures. These characteristics facilitate high heat transfer and reduce the size of heat exchangers. The high outlet temperature of helium coolant makes it possible to achieve very high thermal efficiencies of the plant, making helium the primary coolant in HTGRs. In an operating HTGR, helium is expected to be contaminated by small amounts of gaseous impurities, often nitrogen and argon, but the presence of these contaminants does not cause significant induced activity of helium. However, the presence of impurities such as H₂, H₂O, CO₂, CO, and CH₄ in the gas coolant can lead to various corrosion reactions on the material surfaces. H₂O and CH₄ can induce corrosion reactions at high temperatures, which in turn can affect the tribological behavior of components in sliding contact, such as valves and control-rod drive systems. Oxidation and/or carburization, as well as decarburization, are known to occur in the presence of H₂O and/or CH₄ impurities, which will significantly influence the tribological behavior of the materials in mechanical contact with one another (Wright, 2008; Quadakkers, 1984; Cabet, 2006). To prevent this, the total content of impurities in helium should not exceed 0.01% (Dragunov, 2013). Other requirements involving helium coolant include sheath surface roughening and high operational pressure. The coolant needs to be pressurized in order to improve the heat transfer characteristics and reduce the cost of pumping power. This complicates the design and operation of the primary circuit. The strong diffusivity of helium makes it a challenge as well. The coolant may carry small amounts of radioactive gas escaping through the fuel sheath and radioactive particles adhering to the fuel channels (Lamarsh, 2001). Even with the latest technology, preventing helium leaks caused generally by the aging of the gasket or grand packing is complicated. Another significant drawback of helium coolant is its low capability regarding natural convection. Despite these drawbacks, the favorable thermophysical and nuclear properties of helium and its ability to achieve very high thermal efficiencies have made helium the primary choice for HTGR applications.

### Maximum Allowable Temperature

### Fuel

Design criteria for fuel rods ensure that the fuel integrity is maintained during normal operations and off-normal events. Even under off-normal conditions, the fuel design requirements mandate the preservation of the fuel's integrity, its capacity to cool down, the ability to shut down the reactor, and the ability to maintain the appropriate design limits. The melting point of UC is 2350° C. The maximum homologous temperature, i.e., the ratio of the maximum fuel temperature (fuel centerline temperature) to the melting (or disassociation) temperature of the fuel, for UC fuel is around 0.7. However, fission gas release occurs between 130° and 1400° C. in UC fuel. Below this temperature, gas release is generally <1%. Below 1000° C., gas release is 0.1% of the amount produced (Preusser, 1982). As for the swelling, a 1.45 vol % per at % burnup can be observed below 850° C. At around 1000° C., a free swelling rate of about 1.5 vol % per at % burnup can be observed. At or above 1200° C. (˜½ melting point), fuel is considered unable to bear the mechanical loads resulting from the cladding restraint (Dienst, 1984). Hyperstoichiomctric (<4.80 wt % Carbon) UC exhibits a minimum isotropic volume increase of approximately 2% per 10 MWd/kgU around 1000° C. (Jones, 1972). Breakaway swelling in stoichiometric UC onsets at 1050° C., whereas in hyperstoichiometric UC, it onsets around 1375° C. (Nickerson, 1976).

### Cladding

Cladding temperature is the limiting factor for the maximum global peaking factor and the maximum power-peaking factor at a single point in time in the reactor core during normal, off-normal, accident, upset, and emergency events. Cladding integrity under all scenarios must be maintained to guarantee fuel mechanical stability and the absence of blocked coolant channels, therefore allowing core coolability. Effects that influence the selection of the temperature limit for cladding include melting, strength (including irradiation effects), and oxidation due to air ingress. Of the three effects, the most important factor for retaining design cooling geometry is to assure no clad melting. All the forces acting on the cladding at the time of maximum temperature following a DBDA are very small. Nevertheless, the cladding must retain some strength to assure design cooling geometry. The faulted temperature limit for SiC cladding is a peak cladding temperature (PCT) of 1477 K (1204° C.), determined by ductility tests. (US NRC, 2007). A cladding temperature in excess of 1200° C. affects the integrity of SiC cladding. Even if the reactor is shut down, the decay heat can lead to overheating of the cladding under LOFC accident conditions. FP may be released through ruptured cladding if the fuel temperature is too high. Near-stoichiometric SiC fiber composites exhibit very good mechanical property stability to ˜8 dpa for temperatures as high as 800° C.

### Core Components

In addition to fuel and cladding, the temperature limits for transient conditions are imposed by the core components. Temperatures of metallic primary system components are limited by design bases to assure effective reactivity control. Since there are no acceptance criteria for emergency core cooling systems available yet for HTGRs, the criteria delineated by the U.S. NRC for LWRs are used for reference. According to 10 CFR 50.46 “Acceptance Criteria for Emergency Core Cooling Systems for Light-water Nuclear Power Reactors” (Ref 3-15), the temperature of the flow control valve and plenum element is limited during normal and upset conditions to a maximum of 1000° F. (538° C.) for an LWR design. Temperatures of the control rod cladding and spine cannot exceed 1600° F. (871° C.) for transients longer than 1 hour and 2000° F. (1093° C.) for transients shorter than 1 hour. The temperature of the poison compact must not exceed 4300° F. (2371° C.) under any reactor condition.

### Coolant

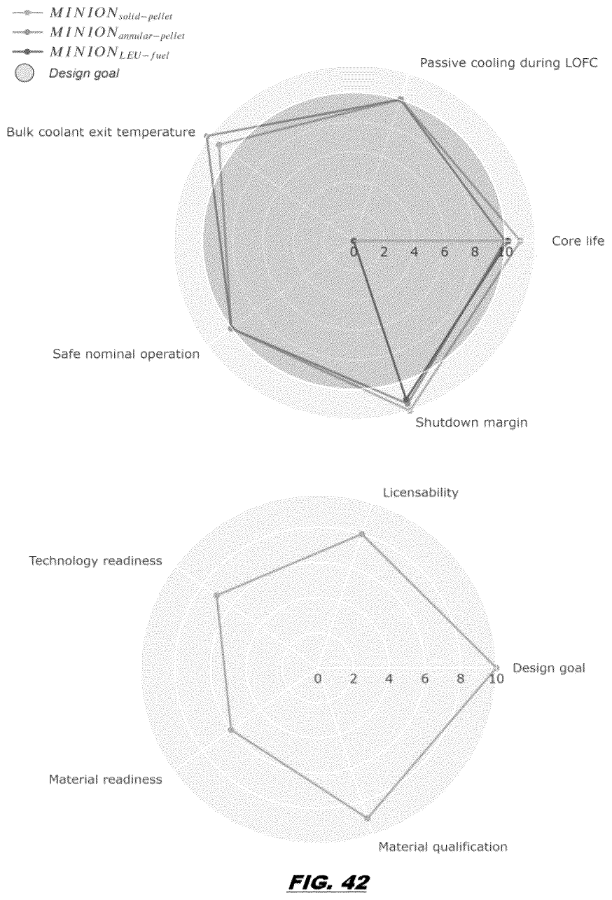

Helium is a chemically inert, single-phase gaseous fluid. These properties are retained even at temperatures well above those limits acceptable for structures and materials. The coolant does not itself, therefore, imposes a limit on allowable temperatures. However, limits are imposed on the coolant so that flow in the reactor passages is maintained to keep the core, support structure, and components within limits on which their designs are based. FIG. 42 shows radar charts showing arbitrary multivariate presentation for each MINION design.

### Methodology

### Neutronics Modeling

The modeling and simulation suite for nuclear safety analysis and design Standardized Computer Analyses for Licensing Evaluation or SCALE (version 6.3 BETA 3) code system's, 3D depletion sequence Transport Rigor Implemented with Time-dependent Operation for Neutronic depletion or TRITON (T6-DEPL) and ce_v7.1 data library are used to deplete the UC fuel (Rearden & Jessee, 2019). SCALE uses ENDF/B-VII.1 nuclear data libraries continuous energy (CE) with enhanced group structures. SCALE's criticality safety analysis is primarily based on the KENO Monte Carlo code for eigenvalue neutronics calculations. Two variants of KENO provide identical solution capabilities with different geometry packages. KENO V.a uses a simple and efficient geometry package for modeling many systems of interest to criticality safety and reactor physics analysts. KENO-VI uses the SCALE Generalized Geometry Package, which provides a quadratic-based geometry system with much greater problem-modeling flexibility but slower runtimes. Both versions of KENO perform eigenvalue calculations for neutron transport primarily to calculate multiplication factors (k_{eff}) and flux distributions of fissile systems and are typically accessed through criticality Safety Analysis Sequence (CSAS). The CSAS sequences implement XSProc to process material input and provide a temperature and resonance-corrected cross-section library based on the physical characteristics of the problem. Modeling and 143 simulation (M&S) of MINION employed the KENO-VI (CSAS6) TRITON depletion sequence (T6-DEPL) for criticality and depletion calculations. As the continuous energy cross-section library is specified in this simulation, the continuous energy cross-sections are used directly with temperature corrections provided as the cross-sections are loaded, and no resonance processing is needed.

### Geometry Specification

The geometry of the reactor core is defined by a hexagonal close-packed lattice. 85 hexagonal arrays of repeating units are stacked side-by-side to create the assembly with a pitch of 5.6 cm. The pitch is the radial distance between the center of two adjacent fuel pins. The fuel pins are defined as cylinders and placed inside the hexagonal units, aka hexagonal cells, defined as hexprisms. The radius of the hexprism, in this case, is its apothem. The height of the hexagonal cells is defined using the modifier list as 2p(H/2), where H is the height of the hexagon. Once the hexagonal cells are defined, they are stacked together in an array to form the core. The ara=parameter defines a reference number for an array and typ=defines the type of array (available in KENO-VI only). nux, nuy and nuz define the number of cell units in the x, y, and z directions. Thus, the core is defined as a 13 by 13 array—13 in the x and 13 in the y direction—of 85 hexagonal cells with 1 array unit in the z-direction. The stacked hexagon (shexagon) layout included in the array definition is used to place the hexprisms alternately. This array type stacks the units so that the faces perpendicular to the x-axis meet. Once the array type and the cells are defined, the array units are filled with materials or mixtures in a group of contiguous storage locations—starting from the bottom, moving left to the right, and then from bottom to top.

The FIDO input method is employed to take advantage of patterns of repetition or symmetry wherever possible. Once the core geometry is defined as an array, the reflector and core barrel regions are defined as right circular cylinders. The core array is then placed such that the origin of the element in row 1, column 1, is located at the center of the core. Once the core is created, control drums are placed in their respective positions in the reflector region. This is accomplished by creating holes in the reflector region and placing the drums in the holes. The drums are defined as cylinders, as described above. The origin of the drums is relocated or translated to new coordinates: xnew, ynew to place the origin of the body at (0, 0). The drums are then truncated using the keyword chord to define a region that will be filled with the neutron absorber material. Each control drum consists of three cylinders that define the drum cladding, the absorber region, and the drum itself. These drums are then placed in the holes in the reflector region. Each hole's origin is selected so that the drums are placed equidistantly in the reflector region. A C++ script 145 is used to locate the origin of the drums. The script accepts two inputs—the number of drums and the distance between the center of the drum and the center of the core—and outputs the coordinate (x, y) of the origin for each drum.

In order to start or shut down the reactor, these drums are rotated 180 degrees so that the absorber region in each drum directly faces away (“drums out” scenario) from or toward (“drums in” scenario) the core 1504. The keyword rotate accomplishes the rotation of bodies with respect to the transverse axis. “rotate a1=A” causes a body to be rotated by an angle of A degrees (counterclockwise) around its origin. For the absorber region in each drum to directly face the reactor core after being placed in their respective holes, each drum is rotated by an increment of 60 degrees, starting with the one at 3 O'clock (the first one is rotated 0 degrees). In order to achieve a complete “drums out” scenario where all six drums are directly facing away from the core, the first drum (positioned at 3 o'clock) is rotated by 180 degrees, followed by the rest, each rotated by an increment of 60 degrees. For the 146 “stuck drum condition,” all drums but one; positioned at 5 o'clock) are rotated so that the absorber region in each drum is directly facing the core except the one stuck. Four control rods introduced as a secondary shutdown mechanism are placed in the core by replacing four fuel rods in the hexagonal moderator blocks. Like the fuel rods, the control rods are defined as cylinders and placed inside the hexagonal units defined as hexprisms. Unlike the control drums, however, the control rods are moved in and out of the core instead of rotating. This is accomplished in two ways. In the complete rods out scenario, the neutron absorber section in the rod is simply replaced with no media. In the case of partial rods out (or rods in) scenario, the rods are moved out of (or inside) the core by small increments. This is achieved by moving the rod origin up and adjusting the length of the rod accordingly. Once the rod is half past the core, the length of the rod is defined simply by adjusting the length of the rod in the +z and −z directions. Moving the drums and the rods in and out by increments was necessary in order to be able to determine the worth of the control drums and the control rods.

### Materials Specification

All geometries defined herein are assigned with materials or mixtures through standard composition specifications in the SCALE input file composition block. The composition input begins with the keywords read comp, followed by standard composition specifications for all mixtures, i.e., UC fuel, SiC cladding, He coolant, BeO moderator, B₄C absorber, and stainless-steel control drum vessel, control rod vessel and reactor pressure vessel. The mixtures are specified based on the standard composition library that contains the data in three sections: basic standard compositions, table of nuclides, and isotopic distribution in elements. Basic standard entries for each composition include standard composition name, mixture ID, density, elements contained in material, weight percent or atoms per molecule of each element contained in material, and temperature. Since the UC fuel is enriched with 19.9% U-235 and the B₄C absorber is enriched with 90% B-10, the fuel and absorber compositions are specified according to their isotopic distribution. Once all the geometries and materials are defined, they are assigned to the geometries by their respective ID as the media. The media card places the materials in the appropriate regions. The region definition vector is used to describe the location of the composition within the current unit. This is done by providing a list of shapes for which the media is either “inside” or “outside,” with a negative sign if “outside” and with a positive (or no) sign when the media is placed “inside” the shape.

### Neutron Transport Scheme

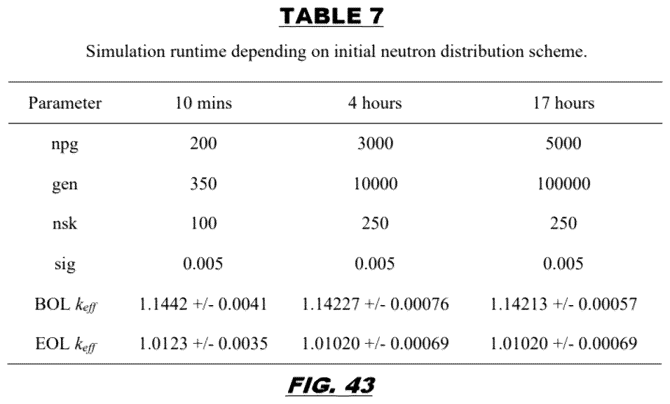

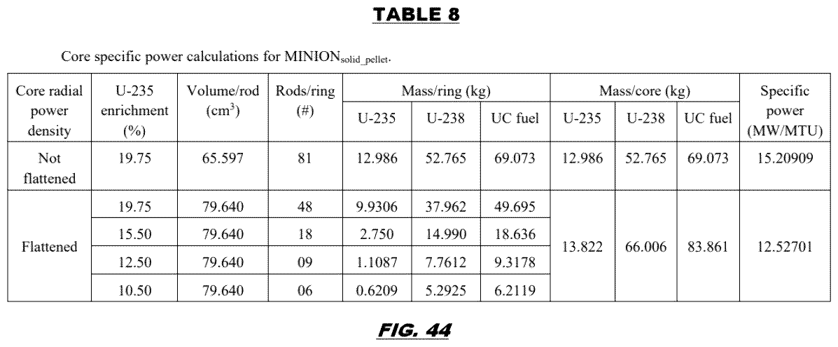

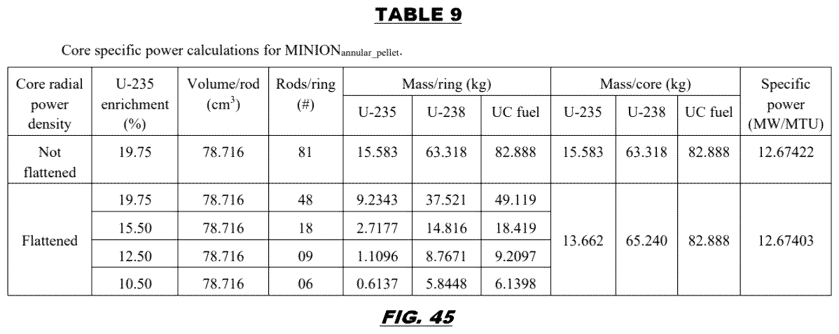

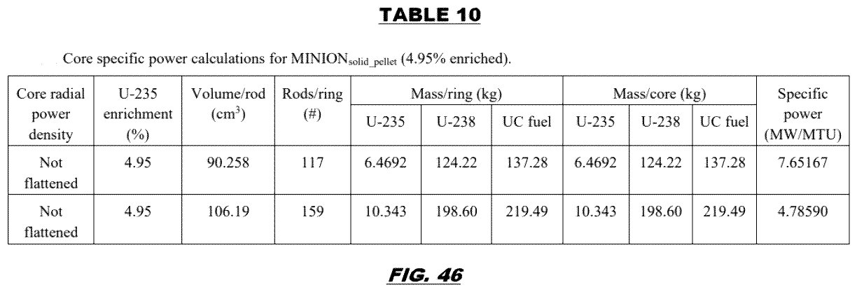

Criticality and depletion calculations are initially done based on a 2D model using a buckling approximation. Including the buckling approximation is important because the analytic sequence tends to overestimate the total flux assuming an infinitely long cylinder. Thus, including buckling in the simulation gives a more reasonable leakage spectrum to 2D models representing 3D systems. In NEWT, dz, deltaz, or height specify the height of the system used to buckling-correct the transport calculation. No buckling correction is performed when the height is set to zero (default). Once sufficient cases have been investigated and a preliminary reference design is identified, the 3D neutron transport scheme KENO is employed to achieve higher fidelity results. The initial neutron distribution is defined in the parameter block as a check. This allows to ensure that no input errors are present without running additional calculations. In this mode, all input is set up as if a full calculation will be run, but the sequence exits without any functional module execution. Param=check is used also to identify the right grid and boundary definition specific to the problem. Once the model is ready, parm=check is updated to param=centrm, the default for TRITON depletion sequences. Next, the initial neutron distribution is carefully selected, as the choice of the initial neutron distribution will determine how long the simulation will take and how accurate and precise the results will be. The default number of generations, defined as gen, is 203. The default number of neutrons per generation, npg, is 1000. The default number of generations (1 through n) to be omitted when collecting results, defined as nsk, is 3. Skipping the initial generations (inactive generations) is required for fission source convergence in the KENO solution so that generational estimates of keff can be included in the final average of the eigenvalue (the active generations). For instance, a model with 1,000 particles per generation (npg=1000) requires at least 240 skipped generations (nsk=240) to allow F*(r) mesh tallies to converge. In order to investigate the accuracy and precision of the results obtained based on the initial neutron distribution of choice, these parameters were changed from their default value to the following: 350 150 10000, and 100000 neutrons per generation with 200, 3000, and 5000 generations requested and 100, 250, and 250 generations omitted, respectively. The forward calculation is stopped when keff has converged to one standard deviation of 0.005. The results are summarized in Table 7, FIG. 43.

Since an initial neutron distribution of 350 neutrons per generation with 200 generations and 100 skipped generations produced results with reasonable accuracy and precision and required three orders of magnitude less run time, these numbers were used as initial parameters to run over 100 simulation cases for parametric analysis. Once the Pareto optimal design is determined, the initial neutron distribution is changed to 5000 neutrons per generation with 100000 generations and 250 skipped generations for a more accurate and precise result. A vacuum boundary condition is applied to all faces to describe the behavior of neutrons when they cross the reactor boundary. This means any neutron exiting the system through the boundary is permanently lost to the system.

### Fuel Depletion Scheme

MINION uses UC fuel 19.75% enriched in U-235. This material, along with the B4C absorber 90% enriched in B-10, is designated for depletion. The depletion scheme includes a series of depletion intervals—time intervals of constant power operation. Generating multiple libraries with depletion intervals provides a more accurate representation of the time-dependent cross-section variation during the burnup analysis. Cross-section processing and transport calculations are performed over ten depletion intervals, and the cross-sections and flux distributions are updated accordingly. Each segment of the cycle is assumed to have the same specific power. The specific power in the basis materials is calculated using the following equation:

$$P = \frac{\dot{P}}{M} \qquad ( 5.1 )$$

where, P is average specific power in the basis material(s) of the assembly, in megawatts per metric tonne of initial heavy metal (MW/MTHM) (typically MW/MTU for uranium only models) and M is the mass of initial heavy metal in metric tonne. The average specific Vacuum boundary condition of left side No return current power is used to determine cycle irradiation time as the ratio of a burnup value in the burnup array to average assembly power. Although optional, a decay interval is included in the depletion scheme following the depletion interval. The irradiation time or the length of depletion interval is included in days. For parametric analysis and design optimization, the amount of fuel in the core was varied by varying the number of fuel rod, rod length, pitch, and reflector thickness. Every time the amount of fuel is varied in the core, the specific power in the basis materials is updated according to equation 3.8. At the same time, the depletion scheme inside the burndata block is updated accordingly. The irradiation time, length of decay interval following the depletion interval, and the number of depletion subintervals for the depletion interval, however, remain unchanged. At the end of the analysis, the design operates at 15.20909 MW/MTU specific power for 10 years with 10 depletion intervals, followed by 1 month of decay. This design is modified and further optimized for power peaking and the final design operates at 12.52701 MW/MTU specific power for 10 years with 10 depletion intervals, followed by 1 month of decay. The core radial power density flattening scheme is described herein. The mass of the heavy metals in fuel is calculated to determine the core specific power, as described below.

Atomic mass of the uranium (U-235 and U-238) in 19.75% U-235 enriched fuel,

$$\frac{1}{{M}_{U}} = \frac{1}{100} ( \frac{19.75}{235.0439} + \frac{80.25}{238.0508} )$$

$${M}_{U} = 237.4509 g$$

Molecular mass of 19.75% U-235 enriched UC fuel,

$${M}_{UC} = 237.4509 + 12.011 = 249.4519 g$$

The percentage of uranium (U-235 and U-238) by mass in UC fuel enriched in 19.75% U-235,

$$w / o = \frac{237.4509}{249.4519} = 95.1891$$

The average density of uranium (U-235 and U-238) in 13 g/cm3 UC fuel enriched in 19.75% U-235,

$${P}_{U} = 0.951891 \times 13 = 12.37458 g / {cm}^{3}$$

The average density of U-235 in 13 g/cm3 UC fuel enriched in 19.75% U-235,

$${P}_{U - 235} = 12.37458 \times 0.1975 = 2.444 g / {cm}^{3}$$

The average density of U-238 in 13 g/cm3 UC fuel enriched in 19.75% U-235,

$${P}_{U - 235} = 12.37458 \times ( 1 - 0.1975 ) = 9.9306 g / {cm}^{3}$$

The average mass of U-235, U-238, and UC in 13 g/cm3 UC fuel enriched in 19.75% U235 in a 1.2 cm wide and 58 cm tall fuel rod,

$${m}_{U - 235} = ( π \times {0.6}^{2} \times 58 ) \times 2.444 = 160.3167 g / rod$$

$${m}_{U - 238} = ( π \times {0.6}^{2} \times 58 ) \times 9.9306 = 651.4135 g / rod$$

$${m}_{UC} = \frac{160.3167 + 651.4135}{0.951891} = 852.7559 g / rod$$

### Power Flattening

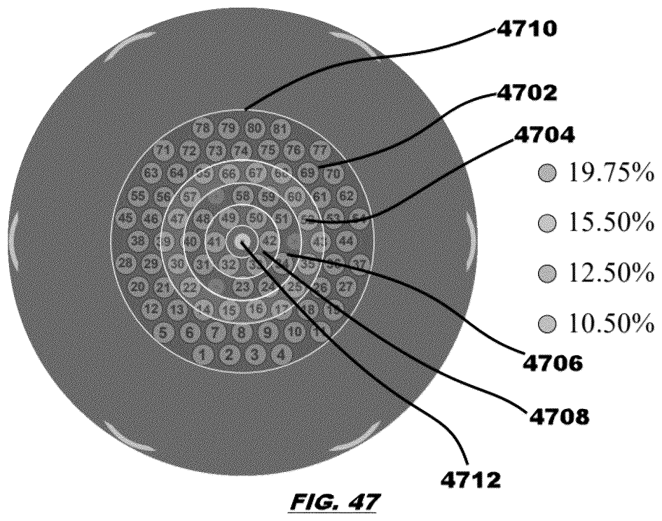

Once the Pareto optimal design is determined based on the neutronic analysis described above, an effort was made to reduce the power peaking in the reactor core. Flattening of power in the core is desirable since a flat radial power profile allows for a higher core average power density, higher coolant exit temperature, and significantly improved economics. However, optimizing the core for power peaking, thus temperature peaking, can be challenging. Artificial intelligence (AI)-based algorithms are being developed to optimize in-core fuel loading patterns using computational search algorithms, especially where thousands of fuel elements are involved. With MINION core having just 81 fuel rods, an effort was made to optimize the design for power density peaking through an iterative reactivity search approach. Of particular interest was how best to reduce the power peaking at the center of the reactor. To that end, the core was split into four concentric sections, with each section having its uniform enrichment decreasing radially in the direction from the periphery to the center, see FIG. 47. SCALE's TRITON depletion scheme was used to determine the power density, reactivity, and material values at the beginning and end of life. The varied fuel enrichment led to a flatter radial power profile, and slightly lower reactivity was observed due to the decreased volume fraction of enriched fuel in the core. To account for the decreased reactivity and to extend the core life past 10 years, the amount of enriched fuel in the core was increased by increasing the fuel pellet diameter from 1.2 cm to 1.3 cm and the fuel rod length from 58 cm to 60 cm. The amount of neutron absorber material also needed to be updated. The resulting design successfully lowered the power peaking while maintaining a core life of 10 years with sufficient excess reactivity. The peak power ratio (maximum to average power) in the uniform fuel enrichment core was 1.237, while the peak power ratio in the varied fuel enrichment core was 1.071, a significant improvement. The total mass of the heavy metals increased from the uniform core to the varied core by 15 kg (69 vs. 84 kg), so the varied fuel core design does not significantly impact the overall fuel cycle cost. In the annular fuel pellet core. FIG. 47 shows optimization of power density for radial power peaking. The core 1504 is split into four sections 4702, 4704, 4706, and 4708 with each section having its own uniform U-235 enrichment: 4702 19.75%, 4704 15.50%, 4706 12.50%, and 4708 10.50% decreasing in the direction from the periphery 4710 to the center 4712.

### Reactivity Control Scheme

The reactivity control mechanism shapes the neutron flux distributions and fission power generation profiles. The presence of a strong neutron absorber in the rotating drums is expected to cause a depression in the neutron flux profile in the core near the absorber regions. When the control drums are rotated toward the core, some of the neutrons escaping the core to the reflector are absorbed by the absorber, effectively reducing the number of neutrons returning to the reactor core and a depression in the neutron flux profile in the vicinity of the absorber regions can be observed. The absorbers face the reactor core and maintain it sufficiently subcritical at startup. To start reactor operation, the neutron absorber segments in the drums are then rotated away from the core. Thus, fewer neutrons are absorbed, and more is reflected back to the core, decreasing the effect of the reactivity in the reactor core. Like with control rods, as the drum approaches the core (the center, in the case of a control rod), its effect becomes greater, and the change in rod worth per degree is greater. Closest to the core (at the center of the core, in the case of a control rod), the rod worth is greatest and varies little with rod motion. From the core to the reactor boundary (from the center of the core to the top or bottom, in the case of a control rod), the drum worth per degree is the inverse of the worth per degree from the reactor boundary to the core.

### Parametric Analysis

An extensive parametric analysis was carried out to optimize the design for the best neutronic performance, size, and mass. The geometry parameters were varied by varying fuel enrichment, fuel pellet diameter, cladding thickness, coolant channel thickness, pitch, fuel rod length, axial and radial reflector thickness, neutron absorber thickness, control drum diameter, and the distance between the control drums and the core (essentially, the radial reflector thickness). Various materials were tested as the cladding, coolant, moderator, reflector, and neutron absorber. Hundreds of cases were run with various combinations of these parameters. Results from this extensive analysis are then used to find the optimal balance of parameters. The Pareto optimal geometry and boundary conditions for the reference design serve as a starting point for the TH analyses of the reactor. The reactor parameters are further adjusted and fine-tuned for effective heat transfer by varying the operating conditions, viz. pressure, temperature, coolant mass flow rate, and coolant flow area. At the beginning of the neutronic analysis of the core, a number of cases were run on SCALE using a variety of combinations of fuel rods (85 vs. 121), fuel type (solid vs. annular pin) core type (regular vs. annular core) reflector thickness (15 cm vs. 20 cm), cladding materials (SiC vs. Stainless steel), and also by changing the core size (diameter and height) by changing pitch. Graphite was used as the moderator, and reflector material as a starting point. Reactor-grade version of Hastelloy X with a low cobalt content for neutron economy is explored as the cladding material and it turned out to be neutronically expensive. Compared with SS316 stainless steel, SiC cladding demonstrated less neutron absorption and better neutron economy, which is consistent with previous findings that discharge burnup greatly decreases with SS316 cladding materials compared to SiC (Oizumi et al., 2014). Additionally, SiC also possesses a high melting point, low chemical activity, and no appreciable creep at high temperatures. Thus, the results are only discussed when SiC was used as the cladding material. However, FIG. 5.8 includes results for both cladding materials.

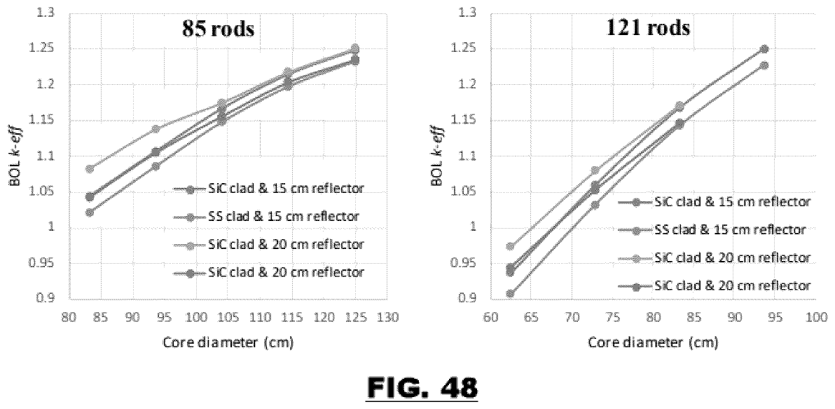

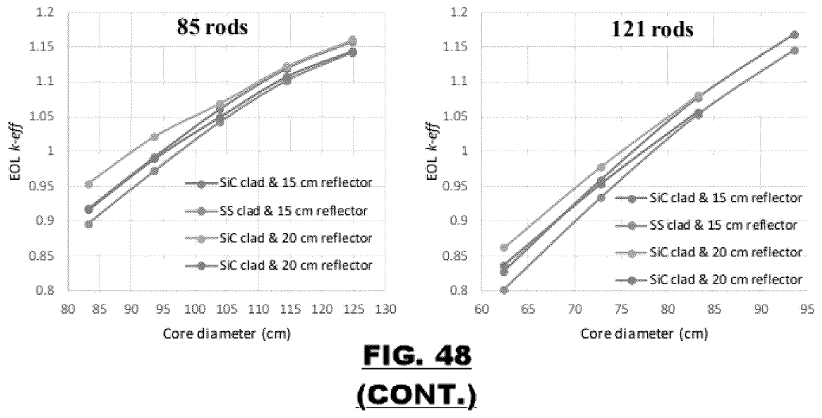

When a higher number of fuel rods were used in the core (121 rods), it significantly decreased the core size by increasing reactivity. However, it also meant a higher HALEU fuel requirement, translating to a higher cost and heavier reactor core. Similarly, increasing the reflector thickness—both axial and radial to maintain the right circular geometry provided better neutron economy by reducing neutron leakage and increasing neutron 160 backscattering, but at the expense of increased reactor size and mass. Thus, the final decision on reflector thickness needed to be made based on the control drum diameter. See, FIG. 48, parametric analysis results of varying the cladding material and thickness, the reflector thickness, and the number of fuel rods in the core.

Since the control drums sit in the radial reflector region and the distance between the core and the control drum absorbers has a strong influence on the neutron flux distributions and fission power generation profiles, an optimum balance among the competing parameters, i.e., the neutron absorber amount, absorber material thickness, control drum diameter, thereby radial reflector thickness, had to be made. In this way, the final radial and axial reflector thickness worked out to be 20 cm. Of course, changing the pitch had one of the greatest implications on reactivity due to changes in neutron moderation. Increasing pitch inevitably increased reactivity, but only up to a certain point for all combinations of geometry and materials. After that point, increasing pitch only increased the size and mass of the core but did not gain in reactivity. For the 10% U-235 enrichment tested initially, 85 fuel rods, and SiC cladding, the optimum pitch was found to be 9.1 cm and 8.7 cm when 15 cm and 20 cm reflectors were used, respectively. When 121 fuel rods were used, the optimum pitch was found to be 8 cm and 7.5 cm when 15 cm and 20 cm reflector was used, respectively. With SS316 cladding and 85 fuel rods, the optimum pitch was found to be 9.6 cm and 9.2 cm when 15 cm and 20 cm reflectors were used, respectively. When 121 fuel rods were used, the optimum pitch was found to be 7.7 cm and 7.5 cm, with a reflector thickness of 15 cm and 20 cm, respectively.

Next, two different core types were investigated, namely regular and annular. The annular core had a moderator region at the center with the fuel rods placed around it, while the regular core had fuel rods uniformly distributed across the core. A number of cases were studied by varying the pitch, number of fuel rods, and the area of the central moderator region. It was determined that the regular core (with 55 fuel rods, at the time) gave the best result. Thus, the geometry and boundary conditions of the regular core were used for further analysis with 3D neutron transport and depletion scheme. Once verified, control drums were placed in the reflector region for reactivity regulation. Since control drums introduce neutron poison into the system, further revision of the geometry and boundary conditions were necessary. A balance between the drum size and reactivity was made, as a bigger drum allows the absorbers to 162 be farther away from the core, increasing neutron flux and reactivity in the core under the “drums out” condition. However, a bigger drum requires a wider side reflector, which increases the size and mass of the reactor. Thus, a delicate balance between the absorber material thickness, control drum thickness, and reflector thickness was made. Once a primary design was determined, scoping studies were carried out by replacing the reflector and moderator materials with BeO and introducing the secondary control rods. This allowed further shrinkage of the reactor core.

### Heat Transfer Modeling

Reactor thermal analyses may be carried out considering the entire core or using a representative fuel rod and coolant channel. Unit-cell methods are commonly used and involve 2D or 3D core heat transfer geometry models and simplified iterative helium TH schemes. This approach allows modeling larger fractions of the core with less computational effort compared to similar CFD models. For MINION, a simplified (unit-cell CFD) core heat transfer model followed by a detailed (full-core CFD) core heat transfer model has been developed using commercial CFD code STAR-CCM+. The geometry of the reactor was divided into two domains—sold and fluid. The heat generated in the solid fuel is transferred through the gap fluid to the solid cladding. The operating pressure in the fluid zone is set to be 3 MPa. Gravity force (acceleration of gravity=9.8 m/s²) is defined in the negative z-direction to consider the gravity-driven force, though gravity-driven force is negligible under forced circulation. During normal operation, the forced circulation flow is expected to have a high Re number. Thus, the turbulence model is selected. The choice of the model focused on the specific physics encompassed in the flow and the established practice for the specific problem (HTGR design), as no single turbulence model is universally accepted as superior for all classes of problems. The field variables solved during CFD simulation are velocity vector, pressure, and temperature (enthalpy). The density, viscosity, specific heat capacity, and thermal conductivity of the compressible fluid have been assigned as the equation of state as per operating temperature and pressure. Note that “compressible flows” and “compressible fluid” are not the same concepts. Compressible flows are characterized by the Mach number of the flow, whereas compressible behavior of fluid refers to the equation of state, such as a change in pressure and temperature leading to changes in density. The property model of each species was input as a form of a polynomial function using data published in peer-reviewed literature and the National Institute of Science and Technology's (NIST's) chemistry Web book. The functions are defined in a Microsoft Excel worksheet and imported as a table into the CFD model. This setup ensured a numerical scheme that was consistent, stable, and convergent at the operating pressure and temperature, which means that when small perturbations cause errors in the numerical method, the property remains bound. Multiple checkpoints are placed throughout the simulation to check convergence progress and accuracy of results by monitoring mass flow, mass imbalance, pressure drop, fluid density, heat transfer through interfaces, and average, maximum, and minimum temperature in each region.

### Unit-Cell Modeling

### Unit-Cell Model Set Up

In order to investigate core heat transfer, initially, a representative fuel cell was studied by modeling one of the 81 hexagonal fuel assemblies. The hexagonal cell includes a fuel rod followed by a gap region surrounded by cladding. The coolant flows through an annular channel between the cladding and the moderator region. The geometry of the fuel cell was produced using dimensions described herein, using STAR-CCM+'s built-in computer aided design (CAD) feature. Each region in the fuel column is created as a geometry part and was assigned separate regions by part surface. This established four contacts and interfaces between the adjacent surfaces: Fuel-Gap interface, Gap-Cladding interface, Cladding-Coolant interface, and Coolant-Moderator interface. The regions fuel, gap, cladding, coolant, and moderator were assigned respective physics continua. UC fuel, SiC cladding, and BeO moderator were assigned to the solid domain, and the He coolant and He gap fillgas were assigned to the fluid domain. The list of models selected to define the solid domain includes solid, three-dimensional, steady, solution interpolation, user-defined EOS, gradients, and segregated solid energy. The fluid domains were modeled as non-reacting gas of helium. The user-defined EOS was chosen as the equation of state. The complete list of models selected to define the liquid domain includes three dimensional, gas, steady, turbulent, gradients, user-defined EOS density, k-epsilon turbulence, realizable k-epsilon two-layer, Reynolds-averaged Navier-Stokes, segregated flow, segregated fluid temperature, solution interpolation, two-layer all y+ wall treatment, and wall distance.

Once all the regions were assigned appropriate physics continua and all the physic continua were assigned appropriate physics models, appropriate material properties were assigned to the materials. The fuel region was assigned as the energy source, and the total heat source was selected as the energy source option. All part surfaces in the hexagonal cell geometry were assigned wall boundary conditions except at the fluid inlet and outlet. The coolant inlet and outlet were assigned the velocity inlet boundary type. At the inlet, the coolant enters at 15 m/s and 250° C. The outlet temperature is calculated using the temperature field function. The initial condition for the domains was set to be as close to the anticipated steady state condition as possible.

### Unit-Cell Meshing

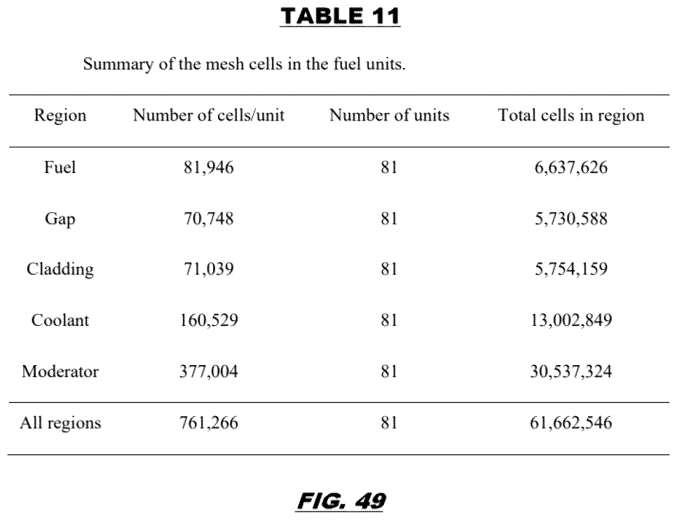

The unit-cell model was optimized for performance and accuracy through mesh refinement and grid independence study. Local mesh refinements were used to achieve appropriate mesh resolutions while preventing excessive mesh sizes. Decreased computation cost while providing sufficient accuracy was ensured by determining critical areas of the computational domain and limiting the finest mesh to those areas. An unstructured mesh was used for most of the domain, while a selectively refined, structured mesh was utilized within the fuel rod. Thin mesher was used across any high aspect ratio geometrical thickness. This allowed the cells in the thin areas to be sufficiently refined. The geometry parts in each fuel column were grouped separately to apply an individual meshing scheme. The following meshers were applied to the fuel rod consisting of the fuel, gap, and cladding: surface remesher, polyhedral mesher, thin mesher, and automatic surface repair. A summary of the meshing results is included in Table 11, FIG. 49. Since the coolant primarily carries the heat generated by the fuel as it flows, the polyhedral mesher is used across all fluid regions. Polyhedra have some added benefits compared to other mesh types, such as faster convergence with fewer iterations, robust convergence to lower residual values, and faster solution runtimes, as they are less sensitive to stretching due to their irregular shape and make much better approximation of gradients as they are bound by many neighbors. On the other hand, polyhedra are usually of much more complex geometry than regular solids, making them candidates for resource-expensive solutions. Prism layer was employed for meshing fluid regions close to the boundaries. This enabled the model to obtain a high mesh resolution along the geometry boundaries.

Polyhedra mesher is used in the fuel, gap, cladding and coolant region with prism layers at the fluid boundary. In the moderator region surrounding the coolant channel, tetrahedra mesher is employed, as tetrahedra can fit complex geometry and acute angles better.

A volumetric growth rate of 1.2 is selected—the industry standard for best results—and the maximum cell size is kept within 80% of the base cell size. As for meshing the vast moderator region, tetrahedra meshers are used since the number of nodes and thereby the number of degrees of freedom required to obtain a converged mesh is much smaller for a tetrahedra mesh. Additionally, tetrahedral elements can fit complex geometry, e.g., curved geometries, acute angles better with little distortion of mesh. This is particularly important because representing circular components with a mesh will always result in an underrepresentation of the circle's area. In addition, thin mesher was used to address any high aspect ratio geometrical thickness.

### Grid and Iteration Independence Study

A grid independence study was carried out to optimize the meshing for the model's performance and accuracy by varying the number of cells in each domain and subsequently comparing the solutions. This process was repeated to find a reasonable meshing scheme that would also return a solution with minimal numerical error. When the solution was unchanged between meshes, it indicated that the base mesh returned the “true” solution. First, the number of cells for the solid domain was varied while keeping the number of cells in the fluid domain fixed at its finest. Once the optimum cell number is identified for each individual region in the solid domain, the method is repeated for the fluid domain. The flow field was established in both cases by obtaining a stable steady-state solution after 5000 iterations. The solution was considered converged when there was little to no relative change in solution for temperature at the coolant outlet (<0.1° C.). When a cell base of 0.008 with a target surface size: percentage of base of 10, resulting in 160,529 cells, was used for the solid domain, an average coolant outlet temperature of 637.6335° C. was obtained. At this point, increasing the number of cells even by 500,000 did not significantly improve the accuracy of results. For a cell base of 0.005, resulting in 660,141 cells, the average coolant temperature at the outlet changed by only 0.089%. The error in solution as a function of meshing is estimated using the following formula.

$$error = \frac{( {T}_{{mesh}_{course}} - {T}_{{exit}_{coolant}} ) - ( {T}_{{mesh}_{fine}} - {T}_{{exit}_{coolant}} )}{( {T}_{{mesh}_{fine}} - {T}_{{exit}_{coolant}} )} \qquad ( 5.2 )$$

Thus, a cell base of 0.008 was used in the solid domain and the mesh in each fuel cell consists of 160,529 cells and a total of 13,002,849 cells in the 81 fuel cells. In all analyses, mesh conformality among fuel, gap, and cladding interfaces was maintained. Once the optimum meshing scheme was determined for the solid domain, it was included in the mesh independence study for the fluid domain. A cell base of 0.006 and a target surface size: percentage of base of 10 resulted in 160,529 cells being used for the fluid domain, an average coolant outlet temperature of 637.6335° C. was obtained.

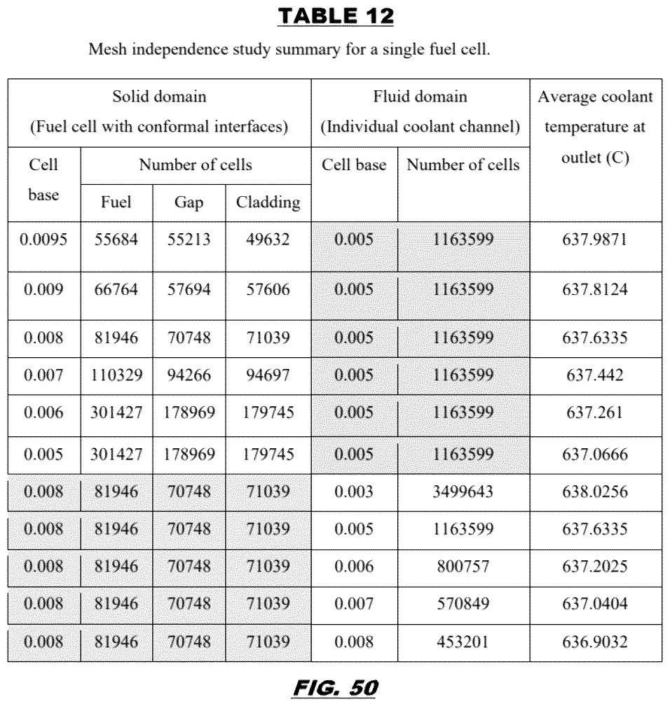

At this point, increasing the number of cells even by 500,000 did not significantly improve the accuracy of results. For a cell base of 0.009 resulting in 660,141 cells, the average coolant temperature at the outlet improved by only 0.086%. Thus, a cell base of 0.006 was used in the fluid domain and the mesh in each fuel cell consists of 160,529 cells and a total of 13,002,849 cells in the 81 fuel cells. Therefore, each fuel cell consisting of fuel, gap, cladding and coolant region consists of a total of 160,529 cells. A total of 13,002,849 cells makes up all 81 fuel cells in the core. A summary of the mesh study is found in Table 12, FIG. 50.

A second study was carried out to confirm that the solution is independent of the number of inner iterations. If the solution is unchanged after varying the number of inner iterations, it will indicate that the least number of inner iterations is returning the “true” solution. Three cases were investigated with the number of inner iterations being 5 (the STAR-CCM+default), 10, and 15. The relative difference between the results obtained using 5, 15, and 30 inner iterations were compared for average bulk coolant temperature, average bulk coolant density, average coolant temperature at outlet, average coolant density at outlet. In all cases, the relative difference was 0.000000000000 (up to 12 decimal points). Thus, increasing the number of inner iterations had no effects on the solution.

### Full-Core Modeling

Once the meshing and heat transfer modeling scheme is determined using a representative fuel cell, the full core model is produced. Fuel rods are placed in the “honeycomb” core at their respective Cartesian coordinates

$$( na , n ( b + c ) )$$

$$and$$

$$( \frac{n}{2} a , \frac{n}{2} ( b + c ) ,$$

where n refers to values between 0 and 85 (85 hexagonal blocks) and a, b, and c are defined according to the following figure, essentially a being the fuel pitch. Once the active core is created, the full coolant fluid volume is generated by joining the coolant channel in the fuel cells to the upper and lower plena 1526 as one single fluid volume. Plena are introduced as part of the fluid domain to enable mixing of coolants after it has passed through individual coolant channels. This enables to take into account the nature of the cold helium flow entering the coolant channels and the hot helium flow exiting the coolant channels. When the coolant passes through the core and the coolant channels, it heats up at different rates due to the individual fuel rods producing power at different rates and the relative position of the fuel rods in the core. This leads to a difference in the heating rate, density, buoyancy, and flow rate for the individual coolant jets leaving the core. As a result, the dynamic viscosity of the coolant affects the flow field differently as a function of temperature. Viscosity also affects the flow mixing and the entrainment of surrounding gas. The azimuthal velocity of the coolant increases the entrainment of the surrounding helium, causing the velocity field to spread radially with distance and to entrain more of the adjacent, cooler gas. This leads to enhanced mixing and heat transfer within the lower plenum 1526.

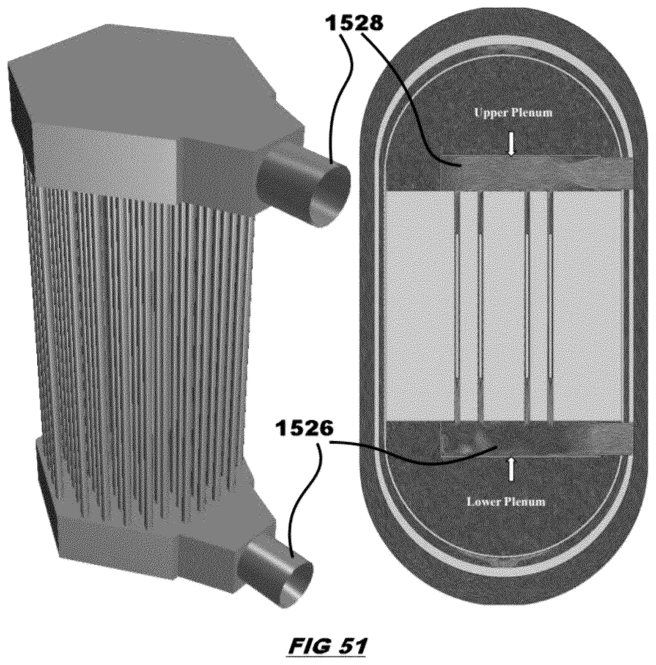

Additionally, there would be regions of high Reynolds number (Re), flow transition and recirculation, vortex interaction and instability, and mixing enhancement/suppression as well as stagnation zones. Another important aspect of including the plena in the core fluid volume relates to transient scenarios. During the loss of flow transient resulting in thermal stratification, the decay heat removal depends on natural circulation. During natural circulation, hot helium rises from the lower plenum 1526 and enters the core, while colder helium flows downward by the effects of gravity. This can lead to a brief development of a thermally stratified front. After the stratification interface has moved above the active core, colder fluid will flow through the core faster, leaving the hotter fluid to stagnate above and impacting the effectiveness of natural circulation. FIG. 51 shows plena are introduced to the full-core model (left) to enable mixing of coolant (right: coolant velocity contour plot) after it has passed through the individual coolant channels with different densities and to accurately model gravity-driven free convection expected in a transient scenario.

All these phenomena are sufficiently captured by allowing the coolant to diverge in the upper plenum 1528, flow through the core 1504, and then converge in the lower plenum 1526. The full-core model includes two additional fluid regions—the core coolant riser and the RCCS. The Upper Plenum Lower Plenum riser coolant flowing through the gap between the core barrel and the RPV typically has a two-fold purpose: (1) carrying the cold coolant to the upper plenum so it can flow top-down through the core and (2) keeping the RPV from becoming too hot by lowering core barrel temperature along its way. In MINION design, the riser coolant fluid volume is not connected to the upper plenum, as it makes fine-meshing of the significantly larger fluid volume computationally prohibitive. The upper and lower dome are filled with helium at atmospheric pressure (0.1 MPa). The RCCS is introduced in the same shape as the RPV to keep the computation cost low. Ambient air flows through the RCCS at atmospheric pressure (0.1 MPa).

### Full-Core Model Set Up

The geometry parts in the full core model are produced using STAR-CCM+'s built-in CAD feature. The complete list of models selected to define these solid domains, e.g., solid moderator, core barrel, plena vessel, and RPV includes solid, three dimensional, gradients, segregated solid energy, and solution interpolation. For the riser coolant and RCCS air fluid domain, user-defined EOS was chosen as the equation of state. The complete list of models selected to define the fluid domain is three dimensional, gas, steady, turbulent, gradients, user-defined EOS density, k-epsilon turbulence, realizable k-epsilon two-layer, Reynolds-averaged Navier-Stokes, segregated flow, segregated fluid temperature, solution interpolation, two-layer all y+ wall treatment, and wall distance. Once all regions were assigned appropriate physics continua and all the physic continua were assigned appropriate physics models, appropriate material properties were assigned to the materials. The heat source is defined for each fuel rod, and the amount of heat each rod generates is set up according to the neutronics analysis. The core coolant enters the upper plenum at 17.5 m/s and 250° C. The coolant in the riser channel enters at a slightly higher velocity (18 m/s) and lower temperature (200° C.) to account for the pressure loss and the heating of the coolant along the way. Air flows around the RPV at a very low velocity (0.5 m/s) to allow the buoyancy effect to establish natural circulation of outside air. The air temperature in the RCCS is set to 40° C., assuming a typical hot summer day. Due to the high temperatures present in the RPV of HTGRs, the decay heat is transferred from the RPV wall to the RCCS predominantly via thermal radiation (˜80-90%) and, to a lesser extent, natural convection (˜10-20%). Therefore, the radiation model is applied to the RPV skin, and the temperature outside RPV is assumed to be constant as a boundary condition. This assumption is proper because the RCCS, an indirect and passive decay heat removal system, surrounds the RPV. Thermal radiation heat transfer in the RCCS can be accurately modeled using view factors. However, modeling the natural convection heat exchange at the RPV wall is challenging because of the high Rayleigh number of turbulent phenomena in the RCCS. The steady-state solution is assumed to have reached convergence when the imbalances in conservation equations (conservation of mass, momentum, energy) are sufficiently small, and coolant density changes in the fluid region and temperature changes in all regions sufficiently reached plateau. The progress of solution is monitored by using monitors and visualizing the solution with scalar displayers and vector displayers. The inner convergence of the algebraic multigrid (AMG) solution of the linear is also monitored for obtaining an efficient solution (and debugging the simulation). The number of inner iterations being executed in a single iteration is generally recommended to be between 2 and 5. Five inner iterations are used. The steady-state simulation is carried out in stages since too many variables are working in a complex matrix trying to reach convergence simultaneously, leading to slow progress and sometimes instability in the solution. Thus, the first 1000 iterations are carried out using variable solid and fluid thermal conductivity, dynamic viscosity, and heat capacity as per operating pressure and temperature, but the fluid density is kept constant. Once the fluid flow is fully developed and the solution has reached convergence, the constant fluid density is turned off, and user-defined EOS fluid density is activated. After around 10,000 iterations, the steady-state solution is sufficiently converged.

The convergence is verified by checking the successive variations of the quantities used as coupling feedback, that is, the fluid density and the fluid and solid temperatures. The quantities are assumed to be converged when, for ten cycles in a row, each distribution value differs by less than 0.1% from its previous value. Numerous checkpoints are placed throughout the simulation to check on convergence progress and accuracy of results by monitoring the mass flow, mass imbalance, pressure drop, fluid density, heat transfer Helium density defined as equation of state Constant helium density through interfaces, and average, maximum, and minimum temperature in each region. The steady simulation was run on 12 GPUs for approximately 160 hours (1920 GPU hours using the following command: select=12: ncpus=48: mpiproc=48). The unsteady simulations ran on the same number of GPUs for approximately 360 hours (4320 GPU hours).

Since the RCCS plays an important role in removing the decay heat from the HTGR during transient events, special attention was paid to ensure that buoyancy-driven circulation has been established in the RCCS.

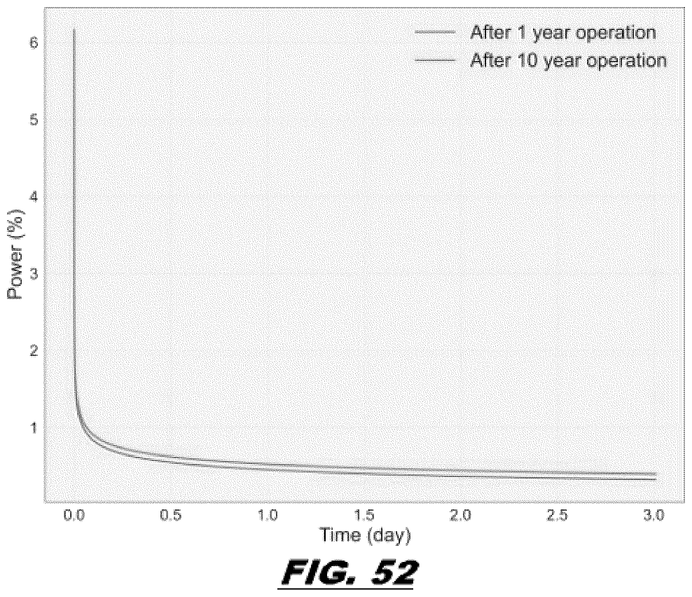

For transient analysis, the implicit unsteady solver is used. Decay heat due to FP and actinide is calculated using Shure's curve (eq. 3.11) and is applied as the heat source to simulate scram. Since MINION has a core life of 10 years and the amount of decay heat at the EOL is slightly higher than at the BOL, see FIG. 52, the higher value (at EOL) is used for the sake of conservative estimation. The heat function is defined in an Excel worksheet, and the results are imported into the CFD model as a table. The fluid velocity at the inlet and outlet is set to zero, and the fluid temperature at the inlet is changed from constant to field function. At this point, the density difference between the cold and hot helium results in free convection—a spontaneous flow arising from nonhomogeneous fields of volumetric (mass) forces (gravitational, centrifugal, Coriolis etc.). The free-convective flows formed inside the plena and the annular coolant channels may be laminar and turbulent.

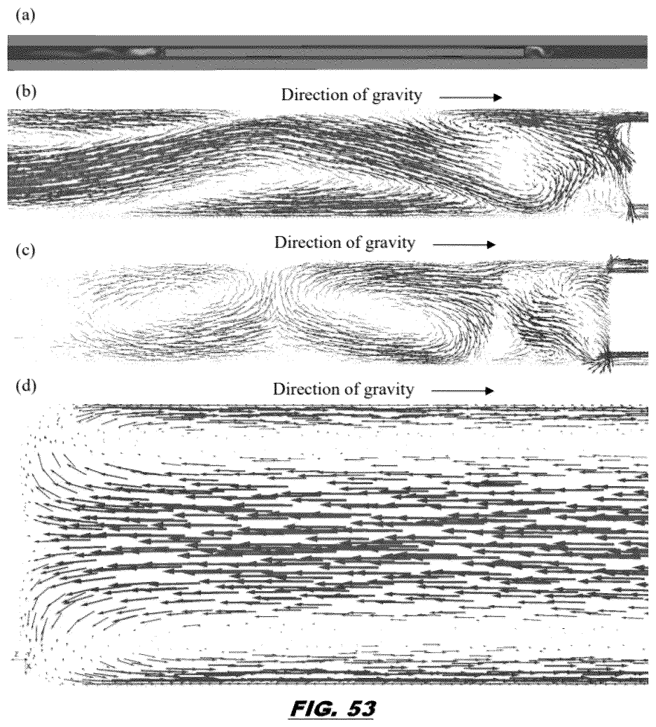

At the beginning of heating the vertical surface, a thin layer of laminar flow is formed, which thickens as it moves along the surface. Eventually, the flow becomes unstable at a certain distance and changes from laminar to turbulent. However, the free convection flow in the narrow cavities of the annular coolant channels is much more complicated. It is possible to have a common fluid flow throughout an entire cavity if one wall is heated and the other cooled. In a fluid layer between a hot lower wall and a cold upper wall, the fluid flow takes on a cellular form (called Benard cells). The fluid ascends from the hot surface to the cold one and descends around the periphery. As the heat flux increases, the cells break down, and the flow becomes turbulent. FIG. 53 shows midplane cross section view of fluid velocity scalar (a) and vector (b, c, d) scenes seen in MINION coolant channels under free convection. The fluid flow changes direction and eddies appear as soon as gravity driven buoyancy establishes natural circulation (b, c). Once natural circulation establishes, the hot helium continues to rise while the cold helium sinks to the bottom of the plena (d).

### Full-Core Meshing

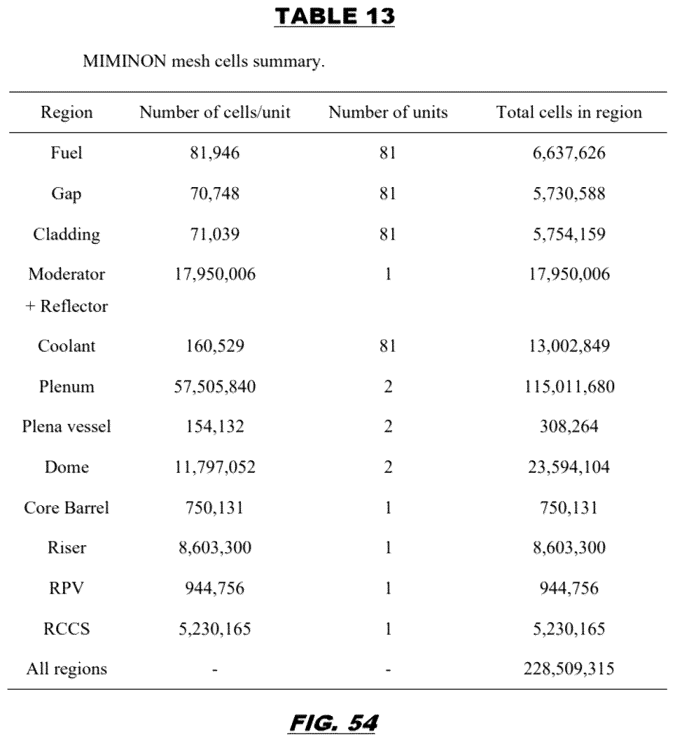

As discussed herein, polyhedra mesher is used in the fuel, gap, cladding and across all fluid regions, i.e., core coolant, gap, riser coolant, and the RCCS, with prism layers at the fluid boundary. Tetrahedra mesher is used everywhere else, i.e., moderator, core barrel, the RPV. Thin mesher is used across any high aspect ratio geometrical thickness and local mesh refinements are used to achieve appropriate mesh resolutions while preventing excessive mesh sizes. A summary of the mesh results is reported in Table 13, see FIG. 54.

### Time Step Selection

For transient simulation, the time-step is usually determined based on the Courant-Friedrichs-Lewy (CFL) criteria, aka the courant number criteria, defined as the under-relaxation factor for the segregated solver in Star-CCM+. The CFL number refers to a dimensionless value used to evaluate the necessary time steps for a transient simulation with a particular mesh size and flow velocity. This value is linked to the CFL stability condition of numerical schemes as

$$c = v \frac{Δ t}{Δ x} \qquad ( 5.3 )$$

where, v indicates the flow velocity, Δt is a representative time step of the simulation, and Ax the characteristic size of the mesh cell (in one dimension). Thus, the Courant number broadly indicates how much the fluid has traveled across a computational grid cell in a unit of time. There are two main implications of using a time step to discretize time. The first concerns the stability of the scheme used for time discretization, while the second concerns the significance of the time step in a physical sense. If the CFL number is greater than one, the information propagates through multiple grid cells at each time step. As a result, the solution may be inaccurate and may result in nonphysical results or divergence of the solution. In most cases, the CFL value between 0.5-0.7 is considered to give the best results. Thus, a maximum value of 0.7 was picked to ensure an accurate and stable solution. In the loss of forced flow scenario, the coolant flows under the force of free convection. The free convection fluid (gas) velocity in the center of a convective flow in parallel to the hot and/or cold surface—at a vertical distance—can be estimated as:

$$v = 0.65 \times {[ \frac{g \times l \times ( Ts - Tc )}{273 + Tc} ]}^{0.5} \qquad ( 5.4 )$$

where, v is velocity in center of flow (m/s), g is acceleration of gravity, 1 is vertical distance from the hot surface (m), dt is the temperature difference between hot surface and environment, Ts is hot surface temperature (° C.), and Te is ambient temperature (° C.). Assuming an average fuel rod surface temperature of 800° C. and down flow coolant temperature of 300° C., the free convection helium velocity in the center of the convective flow is found to be ˜1.5 m/s. For a minimum fluid mesh cell base of 0.006 m and assuming a free convection flow of 1.5 m/s, the supposed ideal time step for the transient simulation from eq. 5.3 is found to be 0.004 s. To further ensure that the selected time step is not too high, the initial time step was set to a quarter of that value, i.e., 0.001 s. In the real sense, however, the velocity vector in the free convection flow is unknown. Additionally, heat diffusion happens at very small lengths and timescales. Therefore, selecting the step size based on the CFL number alone may not be appropriate. The CFL stability condition is used to adapt the proposed scheme by dividing time steps as needed. This is done in accordance with the events that happen during transients and the respective timescale of these events. The events that happen within the first few seconds of the reactor shutdown are summarized:

Events happening within the first few seconds of reactor shutdown.
Fission reaction stops; fuel power generation stops.
Reactor power drops to approximately 7% of rated power.
Decay heat continues to drop at an exponential rate as more and more FPs die.
Forced flow of coolant stops; flow rate drops quickly; flow changes direction.
Density- and gravity-driven buoyancy takes control, establishes natural circulation of the coolant.
In the case of DLOFC accident, pressure drops to the ambient pressure level.
In the case of an air ingress accident, ambient air enters the core, mixes with and eventually replaces the coolant.

Since most of these events happen within the first few seconds of reactor trip and the dissipation of decay heat in the first few hours decreases at an exponential rate, the time steps are ramped up accordingly. A polynomial function (Eq. 5.5) is used to gradually ramp up the time steps in an adaptive fashion, as can be seen in FIG. 5.26. For the first 35 mins, the time step is ramped up using the following equation:

$$Time step = 3 \times {10}^{- 8} \times {( Current time )}^{2} + 1.1 \times {10}^{- 3} \times ( Current time ) + 0.001 \qquad ( 5.5 )$$

After around an hour, there is not many or any event happening at quick succession, and the heat continues to dissipate passively from the fuel rods to the RCCS over many days. Accordingly, the time steps continue to ramp up at a slightly greater rate until the end of the simulation, i.e., 100 hrs. However, A Courant Limit (CL) on maximum time step size is enforced to maintain numerical stability. The CL states that the flow of a phase-out of a cell during a time step cannot exceed the amount of that phase present in the cell at the beginning of the time step. The following equation is used to define the time steps in this range.

$$Time step = 4 \times {10}^{- 3} \times Current time + 105 \qquad ( 5.6 )$$

Like the steady-state analysis, a unit fuel cell is used to primarily determine the time step size. Since the heat generation occurs in the fuel rod, the time steps selected by studying a unit cell are valid for the other parts of the reactor. Close attention was paid to make sure that the number and duration of time steps and the number of time-step increments were adequate to capture each transient scenario discussed above. Once a proper transient scheme is determined, it is applied for the full core transient analyses. A number of full core transient cases are run and monitored to ensure that the scheme is good for additional analyses.

### Equation of State

For accurate analysis of the TH simulation being performed, material properties such as density, thermal conductivity, specific heat, and dynamic viscosity (for fluid) of each material need to be defined accurately. Thus, all material properties are defined as the equation of state as per the operating pressure and temperature using data published in peer-reviewed literature and the NIST's chemistry Web book. Ideally, temperature-dependent material properties will be able to account for the large temperature range between the core inlet and core outlet, as well as the anticipated temperature changes during the transient simulation. Additionally, in a nuclear reactor neutron irradiation leads to changes in the thermal properties of materials. For some materials, such as SiC, irradiation-induced thermal conductivity change can be significant, as neutron irradiation induces obstacles to heat carriers, resulting in a change in thermal conductivity. The mode and effect of irradiation-induced thermal conductivity change, however, can significantly differ for different materials. In the case of BeO materials, the main reason for the decrease in thermal conductivity is due to a change in the average distance traveled by phonons, reducing the thermal conductivity to one-tenth of its original value (Price, 1975; Maruyama, 1992; Snead, 1995; Gallego, 2006). On the other hand, the thermal conductivity of SiC is influenced by the interaction between phonons and lattice defects. The damage caused by irradiation significantly reduces lattice defects to 5-14% of their original value at different temperatures (Rohde, 1991; Snead, 2005; Akiyoshi, 2006). In metals, the movement of free electrons is the primary means of heat transfer, and the thermal conductivity of metals depends on the electrical conductivity defined by the Wiedemann-Franz law (Parrott, 1975). Uranium and beryllium follow this law. Their thermal conductivity sees detectable changes due to irradiation but rapidly recovers at high irradiation temperatures due to the annealing effects. Beryllium can experience a sharp decline in thermal conductivity at low temperatures by several hundred percent, but at room temperature, the reduction can be rapidly and completely recovered.

### Results

### Neutronics

Neutronic analysis of the base design led to a core of 96 cm³ right circular cylinder with 81 fuel rods, each 60 cm tall. The critical core weighs 2.419 metric tons and requires 83.861 kg UC fuel (13.822 kg U-235 and 66.006 kg U-238) to operate with enough excess reactivity for at least 10 years. MINION core has a radial power peaking factor of 1.233, which drops to 1.071 after power density flattening of the core. The suite of neutronics simulations and analysis performed to verify that the reactor core design met requirements is mainly broken down into two categories: (1) Reactivity control studies to gauge the feasibility of the concept and ensure shutdown criteria, (2) Performance metric studies to gauge characteristics of interest of the design.

### Reactivity Control

MINION is designed to operate and shut down with sufficient safety margin. Five of the six control drums and three of the four control rods can make the reactor subcritical to satisfy the SFC. A strong neutron absorber in the rotating drums and moving control rods is expected to cause a depression in the neutron flux profile in the MINION core near the absorber regions.

When control drums are rotated toward the core (or control rods are inserted), some of the neutrons escaping from the core to the reflector are absorbed by the absorber, effectively reducing the number of neutrons returning to the reactor core. As a result, a depression in the neutron flux profile in the vicinity of the absorber regions can be observed.

### Temperature Reactivity Coefficients

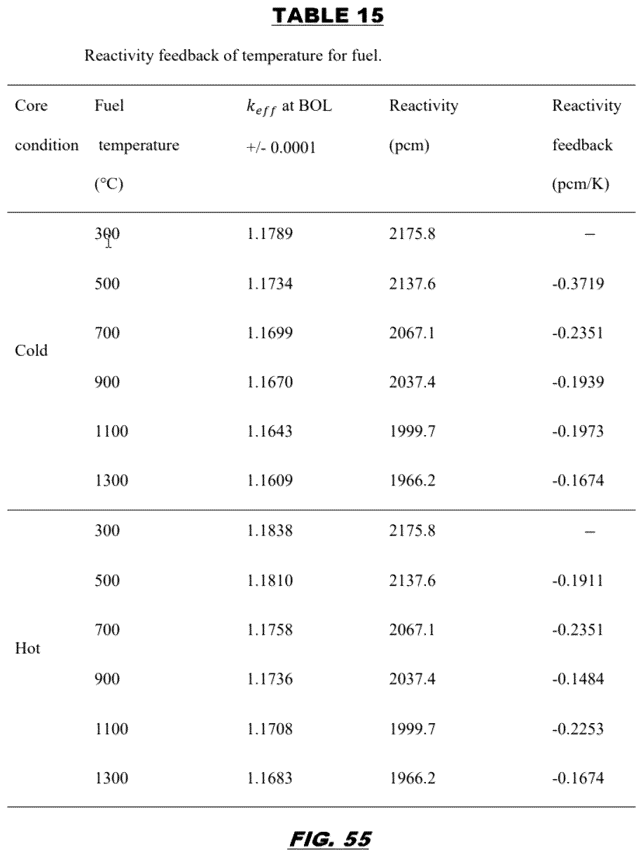

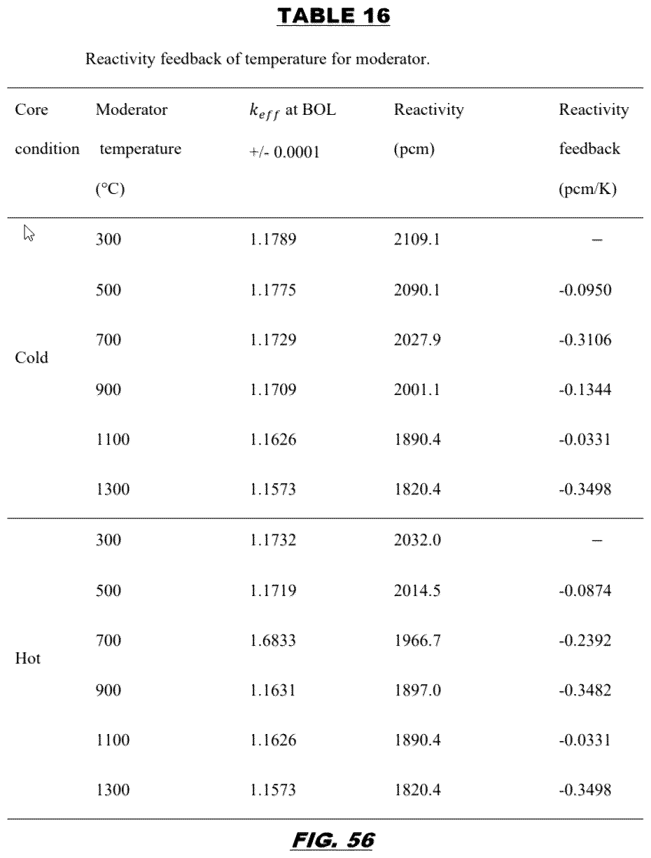

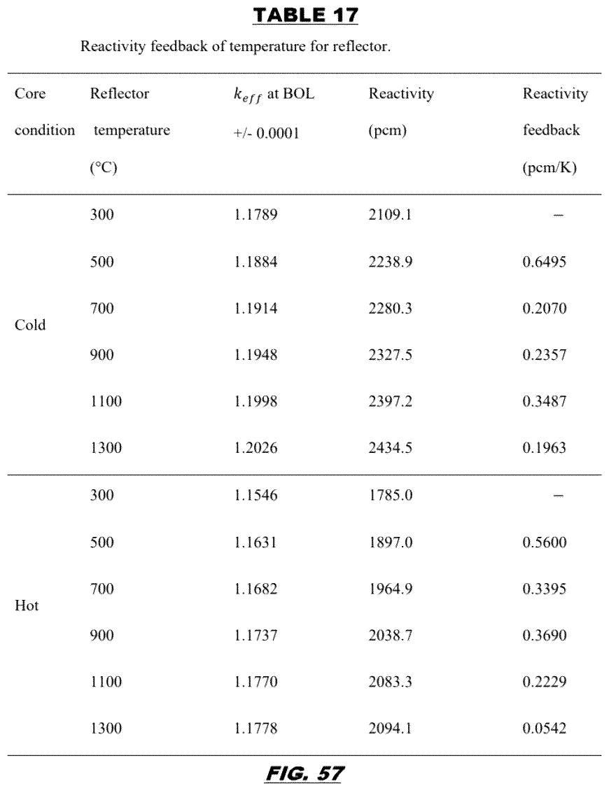

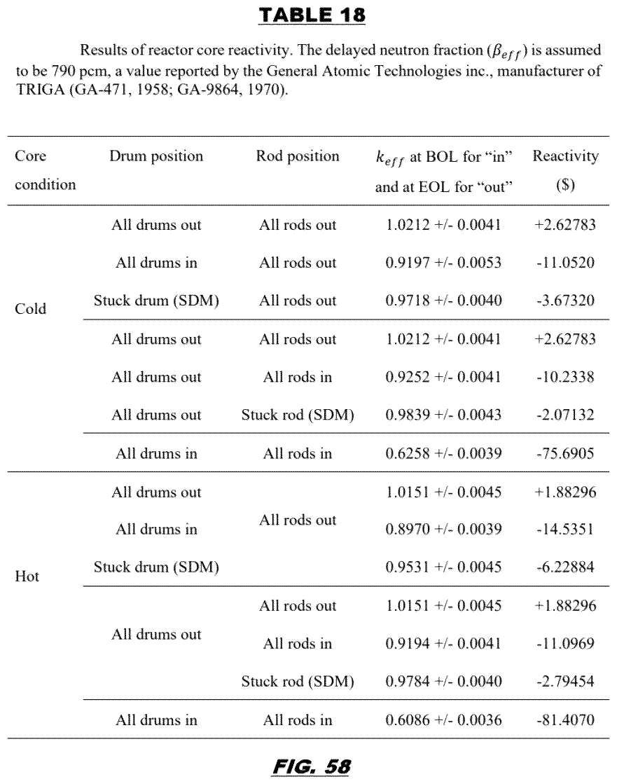

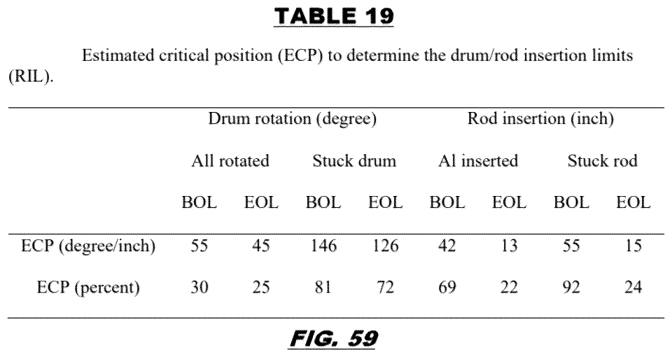

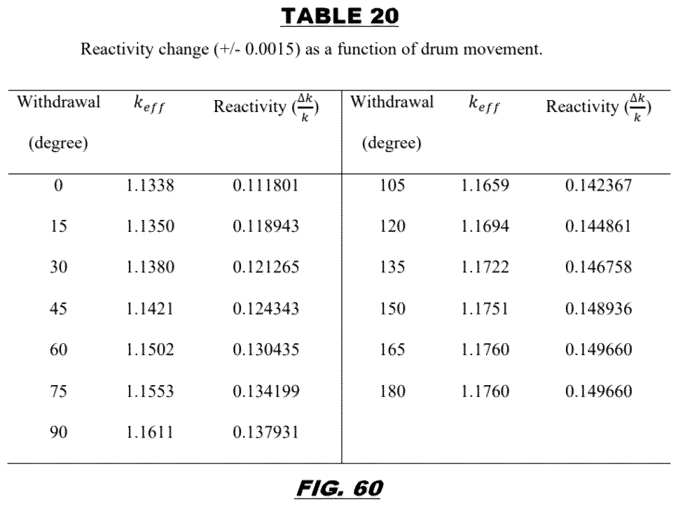

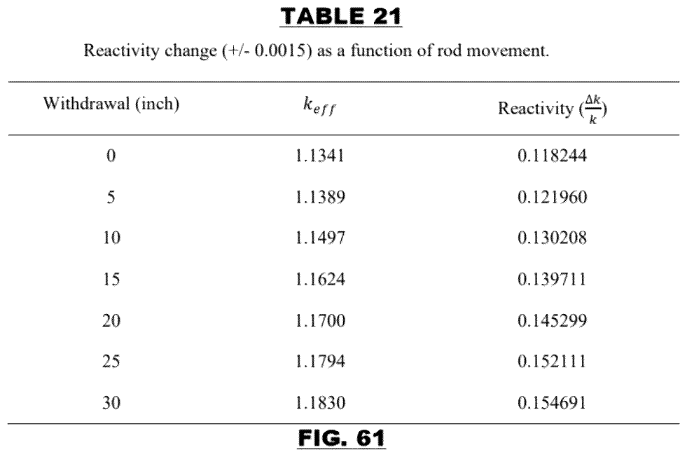

Material-wise temperature coefficients are calculated for fuel, moderator, and reflectors with all other materials set at a fixed temperature and perturbing only the temperature of the material of interest. Reactivity feedback of temperature were calculated under two core conditions, cold and hot. Under the cold condition, all core materials are kept at 10° C. and the temperature of the material under investigation is varied by 200° C. Under the hot condition, all core materials are kept at their respective hot full power (HFP) operational temperature and the temperature of the material under investigation is varied by 200° C. The k_{eff} at BOL is used to calculate the reactivity. Finally, the reactivity feedback for each material is calculated using eq. 3.31. The material-wise temperature coefficients are listed in Tables 15-17, see FIGS. 55-57.

### Reactivity Temperature Defect

The reactivity temperature defect is calculated as the difference in reactivity between the reactor with all drums and rods moved outwards with all materials at their expected operating temperatures and all drums and rods moved inwards and all materials at cold temperature (10° C.). The reactivity of the core at operating temperature drums-out and rods-out must be supercritical. By necessity, the critical position of the drums and the rods must be less than fully moved outward. The reactor in cold zero power is the most reactive since the core has a net negative temperature reactivity coefficient and the fuel is fresh. Cold zero power drums- and rods-in is then the reactivity of the core before startup and accounts for the increase in reactivity at cold temperatures and the negative reactivity with drums-in, the shutdown orientation. At a minimum, the reactivity at cold zero power drums- and rods-in must be subcritical. In theory, if the reactivity between cold zero power drums- and rods-in and operating temperature drums- and rods-out is exactly equal, the temperature defect is worth exactly the net reactivity swing of the control drums. Therefore, the difference in reactivity between cold zero power drums- and rods-in (subcritical) and operating temperature drums- and rods-out (supercritical) is then the margin on reactivity after overcoming the temperature defect. The reactivity at operating temperature drums and rods-out is net excess reactivity available for core lifetime, reactivity maneuvers, and criticality safety margin after overcoming the temperature defect. The results of this analysis are shown in Table 6.4. The table shows that MINION has sufficient excess reactivity at the end of full power operation ($1.9) and sufficient sub-criticality at hot and cold clean shutdown conditions ($10-15). In the stuck drum and rod scenarios, the core is still sufficiently subcritical in hot and cold conditions ($2-6).

The reactivity in the hot operation condition is less than in the cold condition due to the fuel's Doppler broadening effect and the core's thermal expansion. The reactivity feedback for temperature is calculated for various core regions, namely fuel, moderator, and reflector, as reported in Tables 15-17, see FIGS. 55-57. The reactivity coefficients are negative for all core materials, which indicates the inherent safety characteristics of MINION. Additionally, in principle, the reactor has sufficient control authority to regulate reactivity solely with control drums or control rods. The effective multiplication factor of the core at the end of full power operation is 1.01512+/−0.00019. Under the primary and secondary shutdown conditions, the value is 0.97182+/−0.00049 and 0.98397+/−0.00045, respectively.

### Reactivity Control Device Worth

Control drum reactivity curves are computed independently in a series of simulations with the reactor at operating conditions, and the control drum angle perturbed from 0° (fully inwards, shutdown position) to 180° (fully outwards, most reactive position) in increments of 150 (total 12 steps). Control rod reactivity curves are computed similarly from the fully inwards shutdown position to the fully outwards most reactive position in increments of 5 cm (total 12 steps).

### Critical Drum and Rod Position

The core becomes subcritical for a drum rotation of 146 degrees (81% in) at BOL and 126 degrees (70% in) at EOL. When all six control drums are rotated, the reactor becomes subcritical for a rotation of mere 55 degrees (30% in) at BOL and 45 degrees (25% in) at EOL. If none of the control drums works, three of the four control rods (with the highest reactivity worth rod being unavailable) can make the reactor subcritical for a rod insertion of 55 cm (92% in) at BOL and 15 cm (24% in) at EOL. When all four rods are inserted, the reactor becomes subcritical for 42 inches insertion (70% in) at BOL and 13 inches (22% in) at EOL.

### Reactor Performance

### Power Peaking

Assembly-wise fission power production is tallied and mapped over the full core geometry in FIG. 6.5. The core is split into four sections, with each section having its own uniform U-235 enrichment decreasing in the direction from the periphery to the center. Note that four assemblies produce no power, as they are empty channels reserved for inserting the SSR. In the power not-flattened design, the average pin power is 12.3092 kW. The maximum pin power of 15.67 kW is found in fuel rod 42. Thus, the power peaking factor is 1.27304. In the power flattened design, the average pin power is 12.1669 kW and the maximum pin power of 13.0300 occurs in fuel rod 23. Thus, the power peaking factor drops to 1.0709. The calculations were run using 10,000 and 100,000 particle histories and the result difference is negligible.

### Fuel Burnup

Evolution of the effective multiplication factor with burnup shows the neutronic behavior. Note that this is computed at the beginning of the corresponding depletion step and not computed over decay steps. The core remains above the margin adjustment for reactivity throughout the entire operation. The k_{eff} value continually decreases from reactor start-up through the end of cycle due to fission poison build-up, primarily Xenon-135 and Samarium-149. The final k_{eff} value after 10 year's full power operation is 1.01512+/−0.00019, which indicates that the MINION core meets the requirement of operating life. The burnup at the end of operation is 45 GWd/MT.

### Design and Performance Summary

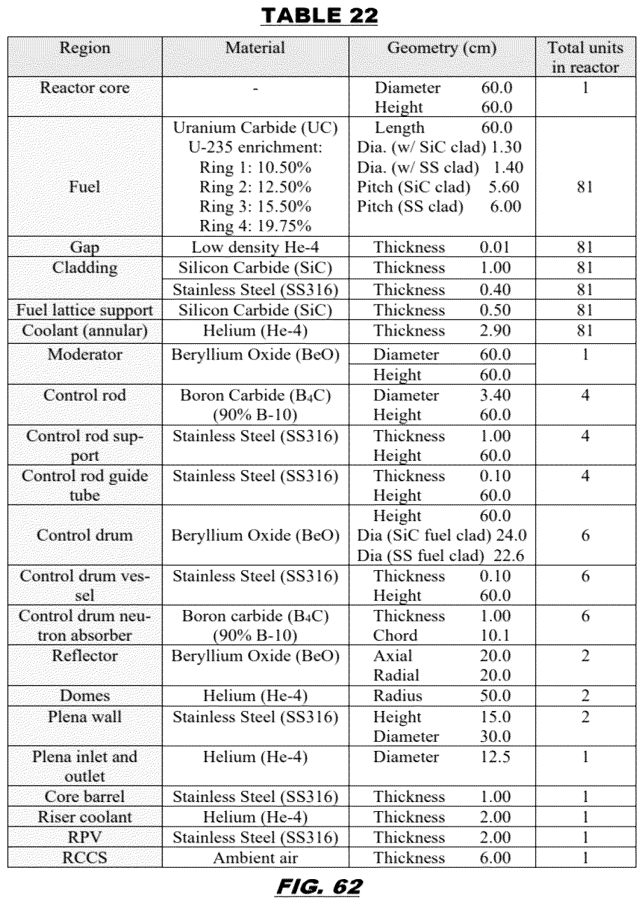

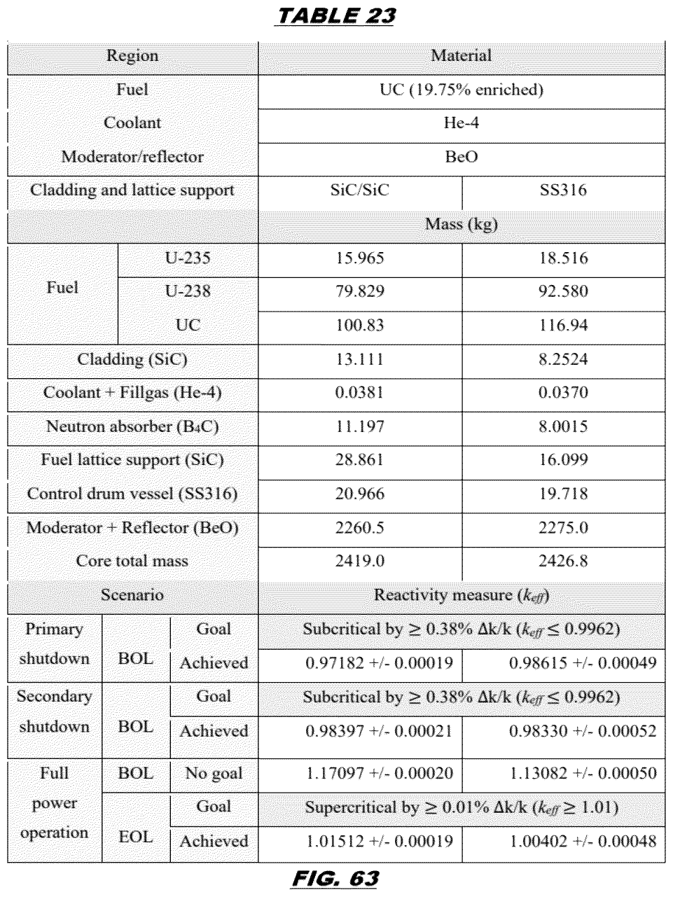

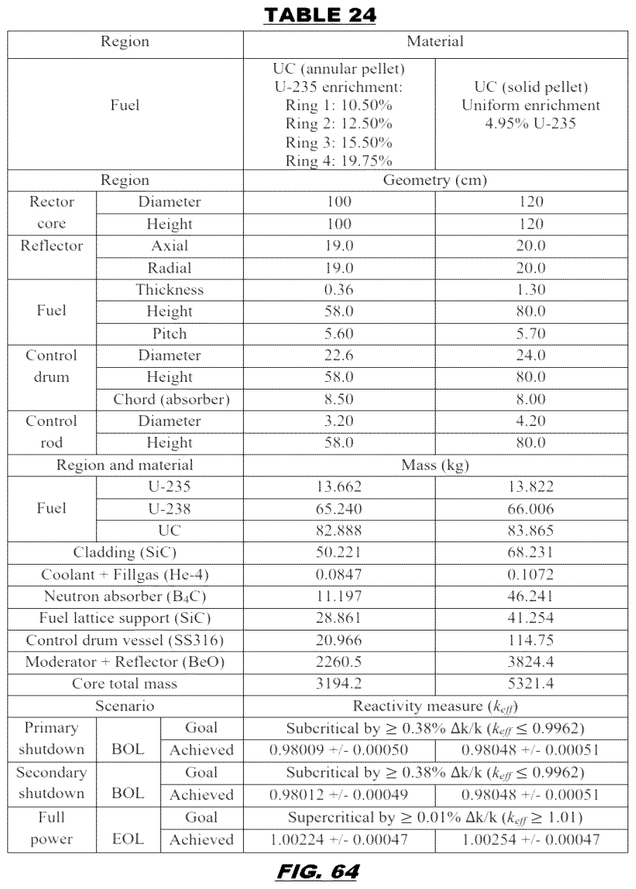

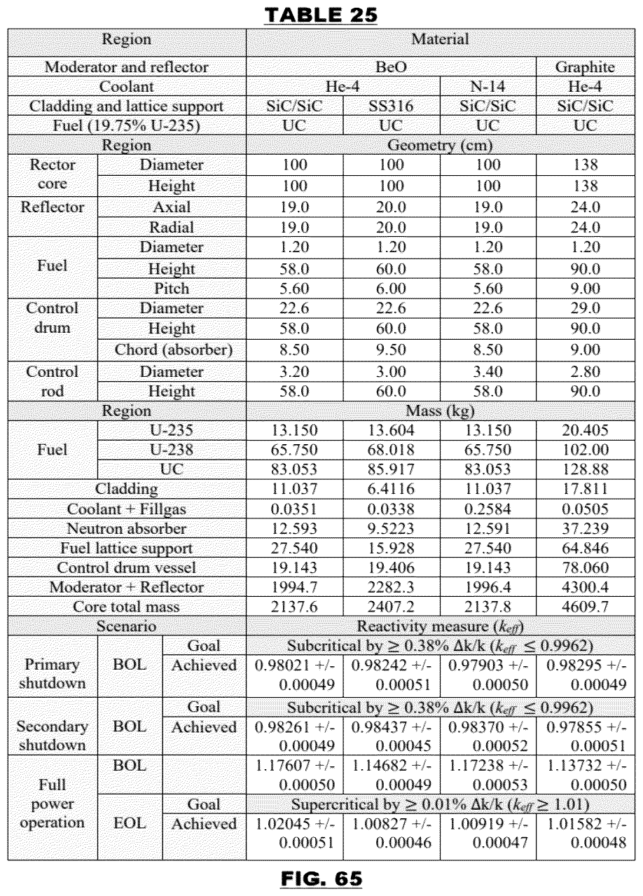

A summary of all the designs analyzed is included in Tables 22-25, see FIGS. 62-65. This includes results for the base design or the reference design (also referred to as the MINION solid_pellet design) and the two additional designs (the annular fuel pellet design referred to as MINION annular_pellet and the solid pellet design that uses 4.95% U-235 enrichment, referred to as MINION LEU_fuel). Results from the parametric cases analyzed using various geometry and materials are included in Table 25, see FIG. 65.

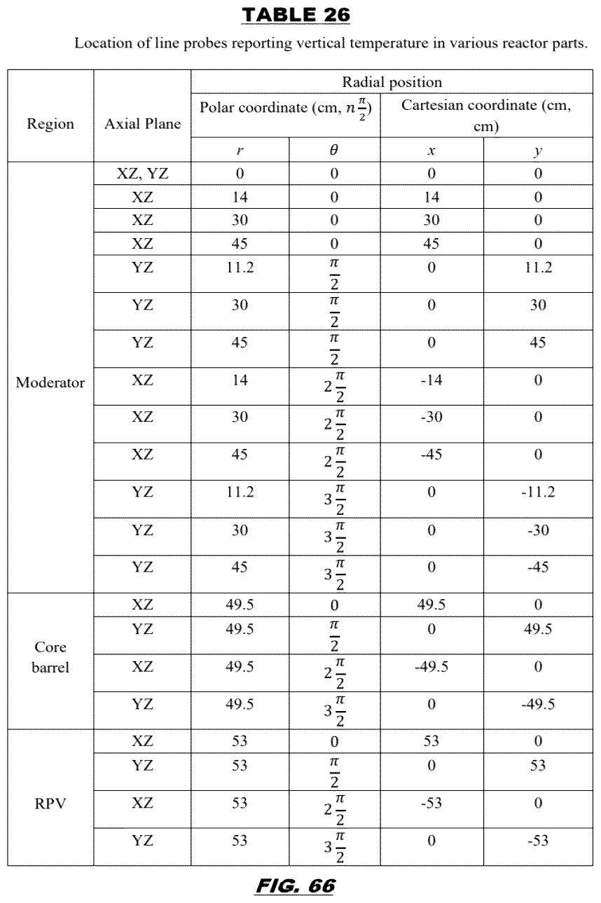

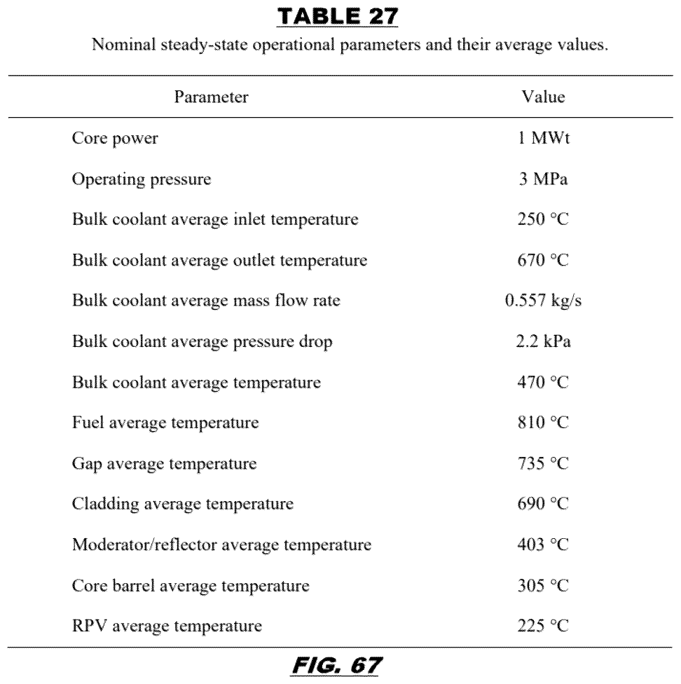

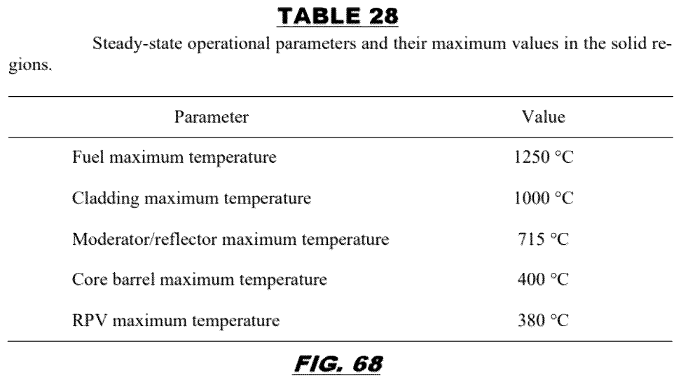

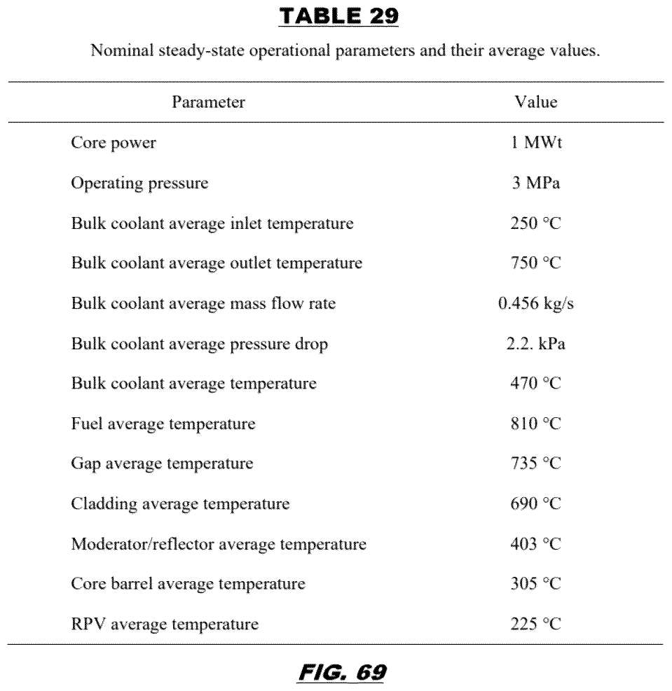

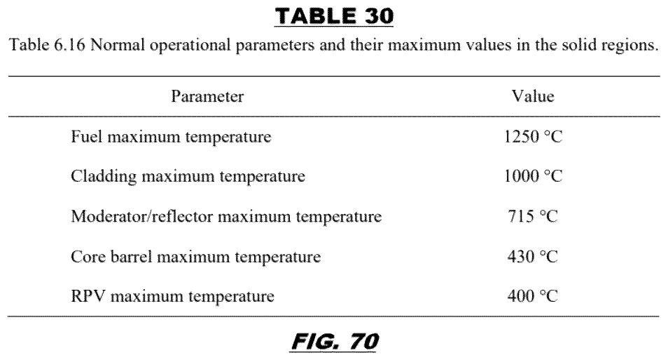

THERMAL HYDRAULICS Thermal hydraulics results of interest include the average and maximum temperature at various parts of the reactor during normal operation and off-normal events and whether these values exceed the acceptable margins and compromise safe operation. Therefore, the temperature distribution inside MINION under various conditions are monitored. Axial and radial temperature distributions in the solid regions are plotted using temperature probes along the beltline region of the reactor, the hottest part. Sixteen line probes pass through the small circles shown in FIG. 6.12. Eight radially equidistant probes pass through the moderator and the reflector region along the XZ plane. The final probe goes through the center of the moderator block, essentially through the center of the reactor. Similarly, two probes along the XZ plane and one along the YZ plane go through the core barrel and the RPV and report their vertical temperature. The location of the probes is referred to using the polar coordinate system (FIG. 6.9). The coordinate of the probes are listed in Table 26, see FIG. 66.

### Steady State

### Minionsolid_Pellet Design

MINION is designed to generate 1 MW thermal power from 81 fuel rods, with each rod generating roughly 12 kW in the power-flattened design. Therefore, the coolant needs to remove around 12 kW of thermal energy from the fuel rod surface through the cladding by means of conjugate heat transfer. At steady state, an average coolant mass flow rate of 0.557 kg/s resulting in a pressure drop of 2.21 kPa accomplishes that. Most of the 1000 kW heat generated in the fuel is transferred to the coolant, and the remaining heat transmits through various interfaces to the RCCS. Around 3.5% of the core heat (35 kW) dissipates through the RPV to the RCCS.

The oscillations observed may be attributed to flow instability in channels cooled by forced flow of helium (Johnson and Jones, 1976). Three distinct modes of oscillation can be identified from a large body of literature on cryogenic and higher temperature fluids: Density wave oscillations (Friedly et al., 1967; Jones and 219 Peterson 1975), acoustic oscillations (Thurston et al., 1967; Krishnan and Friedly, 1967), and pressure drop or Helmholtz oscillations (Maulbetsch and Griffith, 1969). The temperature profile of MINION at the steady state is shown in FIG. 6.14-6.18. The average and maximum fuel temperature observed in the core during the steady state is 810° C. and 1200° C., respectively. Fuel temperature peaks along the axial centerline in the individual fuel rod due to the radial power distribution shape. Axially, the bottom part of the fuel rod reaches maximum temperature due to axial power peaking from heat removal by coolant. The fuel rod temperature decreasing in the direction of the coolant inlet from the coolant outlet indicates that the forced circulation is strong enough to bring the maximum fuel temperature to the bottom of the fuel column.

At the maximum operating fuel temperature of 1200° C., structural changes are generally not expected or significant due to UC's good thermal conductivity, lower linear expansion coefficient, and smallest axial temperature gradient. Substantial fission gas release is also not expected at that temperature, which occurs above 1300-1400° C. The maximum homologous temperature for the UC fuel is 0.5 (˜½ melting point). Therefore, the fuel should exhibit minimal deformation, isotropic volume increase, and swelling during steady-state operation. Moreover, only a small fraction (<0.1%) of the fuel in the core reaches temperatures as high as 1200° C. During the steady state, the cladding reaches an average and maximum cladding temperature of 690° C. and 1000° C., respectively. The maximum cladding temperature appears near the bottom, where the fuel rod is the hottest and is 200° C. below the faulted temperature limit for SiC/SiC composite cladding. A small amount of “transient swelling” may occur around that temperature, but the rate depends on the irradiation dose and temperature. For the BeO moderator and reflector, the average and maximum temperature observed during the steady state is 403° C. and 715° C., respectively. The hottest region appears near the lower plenum and is 1900° C. below (<⅓ melting point) the melting temperature of BeO at 2527° C. While BeO retains high thermal conductivity, high refractoriness, compatibility with fuels, and inertness with the coolant up to 1600° C., anisotropic dimensional change is expected around that irradiation temperature.

The remaining components in the core, i.e., control drum and control rod vessels, core barrel, and RPV, are made of metal alloy stainless steel (316L). The faulted temperature limit for stainless steel is approximately 600° C. for prolonged exposure (also dependent on the level of irradiation exposure). At steady state, the average and maximum RPV temperature observed is 255° C. and 380° C. The average and the maximum core barrel temperature is 305° C. and 400° C. In both regions, the maximum temperature occurs in the beltline region and are within the material faulted temperature limits. The coolant enters the core at a mass flow rate of 0.557 kg/s. The pressure drop at the outlet is 2.2 kPa. The maximum and minimum coolant temperature on the outlet cell surface is 689° C. and 620° C., respectively, resulting in the average temperature being 670° C. The average density of helium in the upper plenum and the lower plenum is 2.8 kg/m³ and 1.2 kg/m³, respectively. The coolant is hottest at the bottom of the fuel column on the clad-coolant interface and becomes cooler both in the axial and radial directions.

MINION_{SOLID_PELLET} & MINION_{ANNULAR_PELLET} RESULTS COMPARISON

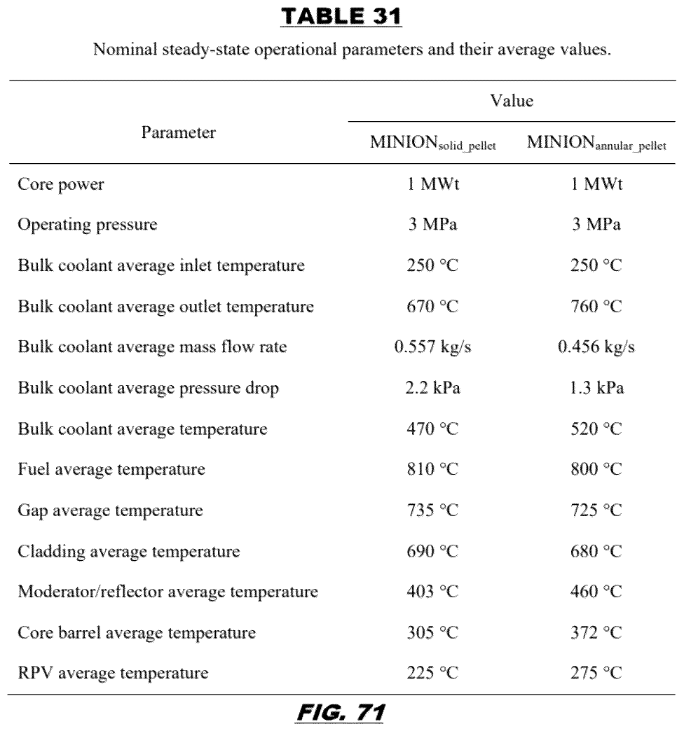

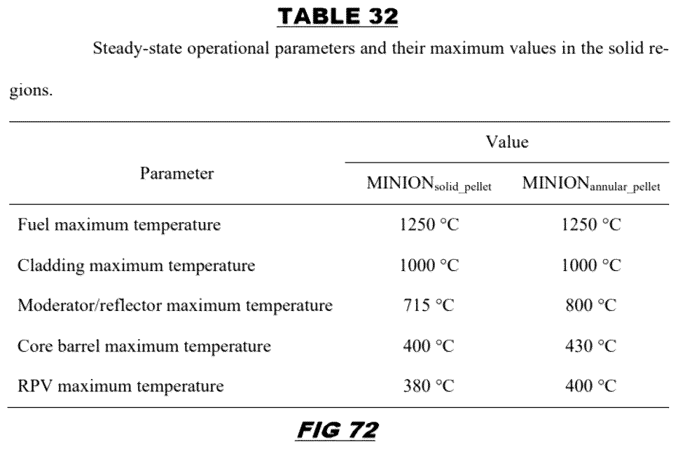

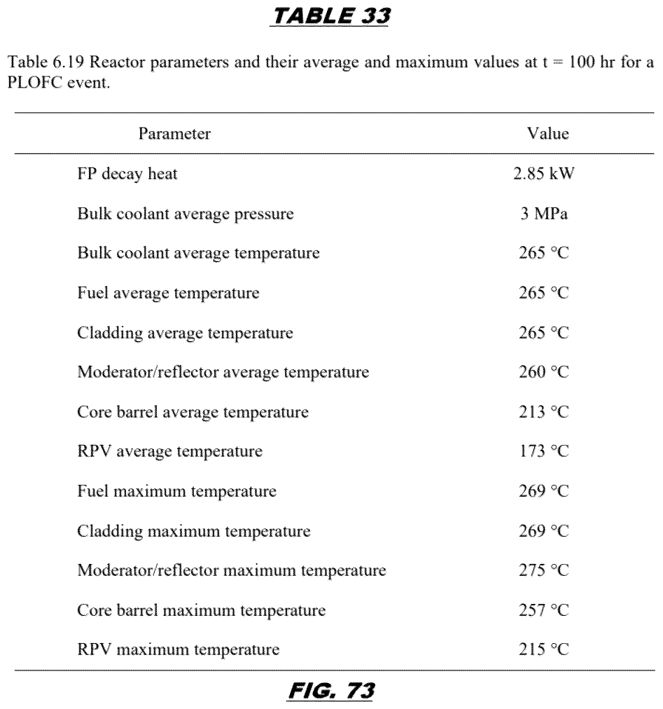

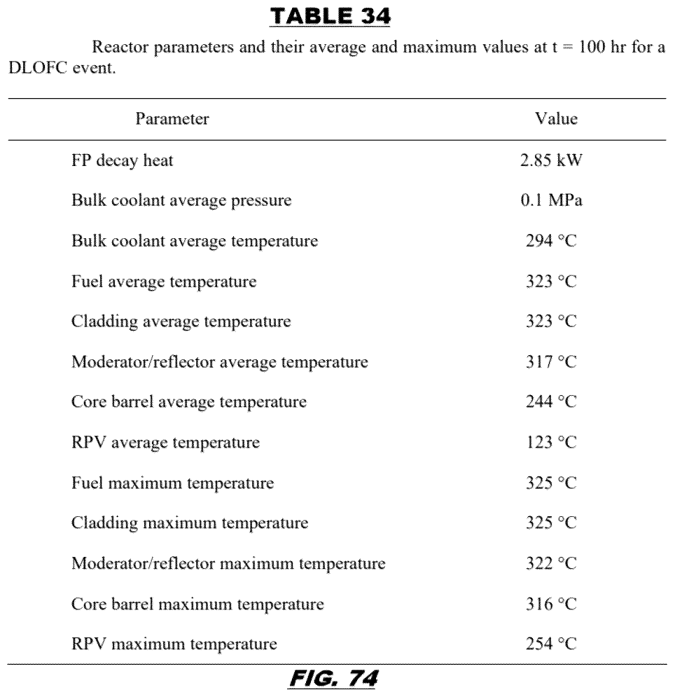

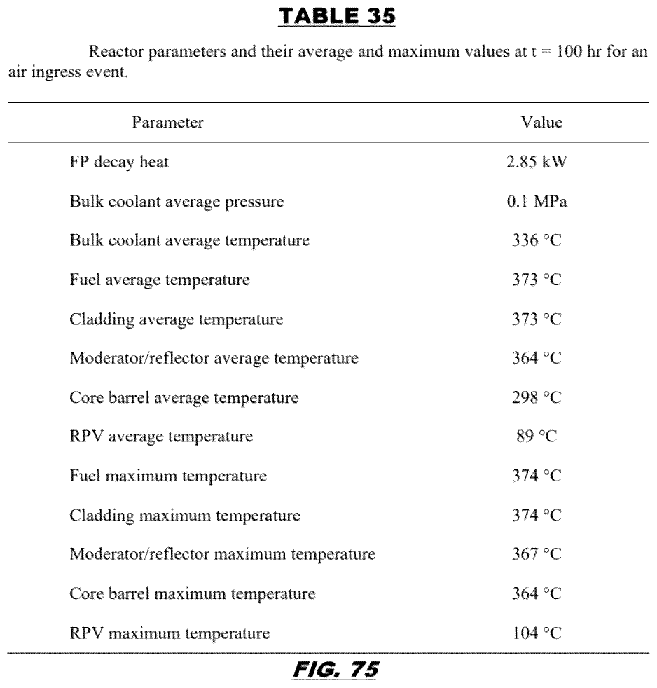

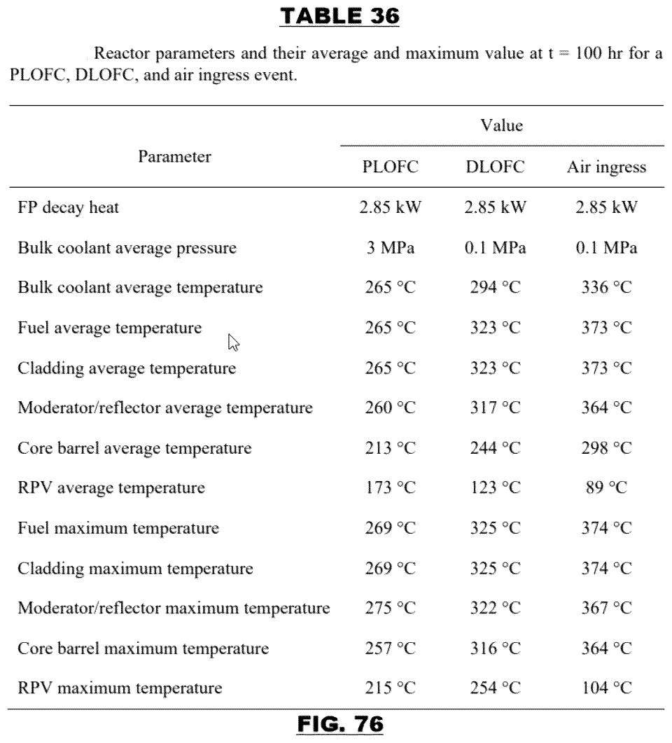

An annular fuel pellet design allows the fuel to cool down further by allowing the coolant to flow through an inner channel in addition to over its surface. This led to a higher core coolant exit temperature for a reduced coolant mass flow rate while the fuel maximum temperature is maintained at the same temperature as the solid pellet design, i.e., 1000° C. The coolant temperature at exit is 15% higher at 760° C. than its solid pellet design counterpart. A summary of the results is listed in Tables 31-32, see FIGS. 71-72.

### Accident Scenarios

The heat and temperature profile in the core was analyzed during a time range of 100 hours after the PLOFC, DLOFC, and air ingress accidents. At the onset of the transients, the flow cycle reversed, shifting the hot region upwards and allowing the lower regions to cool down. The reversal occurs only in the central core channels at the beginning and slowly spreads outwards until the intracore natural convection cycle is fully developed. The maximum core temperature decreases as the peak temperature region shifts upwards into previously colder regions, resulting in a temperature redistribution in the core. At the end of 100 hours, the temperature across the reactor reaches a near-steady state, particularly in the active core region. Initially, the temperature drop follows the decay heat curve. Over the next few hours, the core temperatures drop at a rate of about 5° C./min reaching a plateau of around 300° C. The inflection point of core temperature appears at around 100 h after the accident initiation around when the heat removal rate becomes larger than the heat generation rate in the core. Most decay heat is removed passively through conduction and radiation to the RCCS. The low power density (6 W/cc) of MINION, along with the large thermal inertia provided by the beryllia moderator and reflector, as well as the large surface-to-volume ratio of the reactor core, ensure the passive removal of decay heat. The peak fuel and cladding temperature do not exceed their nominal operating values at any point during the transients. These results demonstrate that core heat removal under accident conditions is sustained only by physical phenomena such as natural convection and radiation.

### PLOFC

During a PLOFC accident, the maximum core temperature decreases as the peak temperature region shifts upwards into previously colder regions. The upper dome becomes hotter than the lower dome as the hot coolant rises and the cold coolant continues to sink (FIG. 6.28). The average and maximum fuel temperature drops to approximately 400° C. within the first few seconds and continues to drop over the next few days. The maximum temperatures in the core still occur in the fuel rods, the source of the decay heat. After 100 hours, the fuel and cladding temperatures are nearly in equilibrium with the surroundings. The maximum fuel and cladding temperature is 269° C. and the average fuel and cladding temperature is 265° C. The moderator temperature, including the reflectors, varies by 20° C., axially and radially. The maximum and average moderator and reflector temperatures are 275° C. and 260° C., respectively. The maximum and average core barrel temperatures are 257° C. and 213° C., respectively. The maximum RPV temperature after 100 hr is 215° C. and the average RPV temperature is 173° C. At 100 hr, 13.35 kW heat dissipates from the core through the RPV to the RCCS, 38% lower than the steady-state value. The axial and radial temperature distribution in the solid regions of MINION is plotted along the beltline region. As discussed above, the moderator and reflector temperatures are relatively uniform in the axial and radial directions, with slight deviation near the coolant outlet (θ=0). Overall, the hottest part remains at the core center (r=0) and drops gradually toward the periphery (r=45). A similar trend is observed in the core barrel and the RPV. In each solid region, the vertical temperature profile has a bow shape, with the hottest part being at the center and decreasing axially. The temperature skew toward the coolant outlet still exists at the (0, 0) positions, but the temperatures are more strongly segregated in the radial direction. A similar trend is observed in the core barrel and the RPV.

### DLOFC

Accurate progress of depressurization during a DLOFC accident is difficult to predict, as the rate of depressurization depends upon the size and location of the break. Therefore, the depressurization event is not explicitly modeled in this work. Additionally, the bulk of depressurization happens within the first few minutes of the reactor trip. Thus, assuming complete depressurization at t=0 does not significantly alter the heat deposition scenario over the 100 hours. To simulate the depressurized condition in the core, user-defined equations of state as a function of pressure (0.1 MPa) are applied to the fluid regions. Similar to the PLOFC accident, the onset of natural circulation slowly leads to the upper dome becoming hotter than the lower dome (FIGS. 6.32 and 6.34). The fuel and cladding temperatures reach near equilibrium with the surrounding at the end of the 100 hr period. The maximum fuel and cladding temperature is 325° C., and the average fuel and cladding temperature is 323° C. The moderator temperature, including the reflectors, varies by 10° C., axially and radially. The maximum and average moderator temperatures are 322° C. and 317° C., respectively. The maximum and average core barrel temperatures are 316° C. and 244° C., respectively. The maximum RPV temperature after 100 hr is 254° C., and the average temperature is 123° C. At 100 hr, 7.7 kW heat dissipates from the core through the RPV to the RCCS, 77.8% lower than the steady state value. The axial and radial temperature distribution in the solid regions of the reactor is plotted along the beltline region. As discussed above, the moderator and reflector temperatures are relatively uniform in the axial and radial direction, with slight deviation near the coolant outlet (0=0). Overall, the hottest part still appears at the center (r=0) and drops gradually toward the periphery (r=45). In each solid region, the vertical temperature profile has a bow shape, with the hottest part being at the center and decreasing axially. The temperature skew toward the coolant outlet still exists at the (0, 0) positions, but the temperatures are more strongly segregated in the radial direction (FIG. 6.33). A similar trend is observed in the core barrel and the RPV.

### Air Ingress

Similar to the DLOFC accident, the depressurization event is not explicitly modeled for the air ingress accident. The 100% mass fraction of helium in the core is replaced with air. User-defined equations of state are applied to simulate the depressurized and air-ingressed conditions in the core and the coolant riser at 0.1 MPa. At the onset of the transient, the reversed flow cycle due to natural circulation pushes the hot region upwards until the intracore natural convection cycle is fully developed. The fuel and cladding temperatures reach near equilibrium with the surrounding at the end of the 100 hr period. The maximum fuel and cladding temperature is 374° C., and the average fuel and cladding temperature is 373° C. The moderator temperature, including the reflectors, varies by only 10° C., axially and radially. The maximum and average moderator temperatures are 367° C. and 90° C., respectively. The maximum and average core barrel temperatures are 364° C. and 298° C., respectively. The maximum RPV temperature after 100 hr is 104° C., and the average RPV temperature is 90° C. At 100 hr, 3.96 kW heat dissipates from the core through the RPV to the RCCS, 88.7% lower than the steady state value. The axial and radial temperature distribution in the solid regions of the reactor is plotted along the beltline region. Unlike the PLOFC and DLOFC accidents, the vertical temperature profile in the solid regions is relatively uniform in the lower part of the reactor and spreads out in the upper part of the reactor. The axial and radial temperature distribution in the solid regions of the reactor is significantly more uniform under depressurized conditions than the pressurized conditions.

### Accident Scenarios Comparison

Thermal results are compared for the PLOFC, DLOFC, and air ingress accidents assuming that the reactor is vertical in its standard position throughout the transients. An additional scenario is investigated where the reactor is lying on its side (horizontal) during the transient. MINION being a mobile reactor, this is a reasonable anticipated operational occurrence. When this happens, the direction of gravity will change, leading to a coolant circulation and temperature distribution pattern different from the standard scenario where the reactor is vertical. In the horizontal reactor, the upper dome is no longer expected to be the hottest part, and the beltline region is expected to experience an asymmetric distribution of temperature. This is investigated for all three transient cases discussed above, i.e., PLOFC, DLOFC, and air ingress accident. In the CFD model, the direction of gravity is updated to be orthogonal to the XZ plane (gravity acting toward π/2). The simulation is then run for 100 hours.

### Vertical Reactor

Significant differences between the results of the PLOFC, DLOFC, and air ingress accidents are observed, as one would expect. The reactor is most effective at passively removing the decay heat under the PLOFC condition, followed by the DLOFC and air ingress conditions. This is primarily due to the higher density of helium under the pressurized condition, as the mass flow rate increases because of an increase in the density difference. Although the air has a significantly higher (7×) density compared to helium at atmospheric or depressurized conditions (1.21 vs. 0.166 kg/m³), the absolute viscosity of helium at room temperature is slightly greater than that of air (1.94×10⁻⁵ kg/m-s vs. 1.83×10⁻⁵ kg/m-s at 20° C.). Absolute viscosity determines resistance in flow, especially under natural circulation. The higher absolute viscosity of helium leads to an 8 times higher kinematic viscosity, which is the ratio of absolute viscosity to density, for helium compared to air (11.69×10⁻⁵ vs. 1.52×10⁻⁵ m²/s). The difference in kinematic viscosity between air and helium leads to a difference in the Reynolds number. Additionally, the heat capacity of helium at atmospheric conditions is 5 times higher than air (5.2 vs. 1.0 kJ/kg-K at 25° C.). Specific heat (Cₚ) is the amount of energy required to raise 1 kg of a substance by one-degree centigrade. The thermal diffusivity is a measure of how fast heat spreads through a given material. The thermal diffusivity of air is 9 times less than that of helium. All of this leads to the highest core temperature during the air ingress accident, followed by the DLOFC and the PLOFC accidents. Since the heat transfers most slowly during the air ingress accident, all core materials are in near temperature-equilibrium after 100 hr of the accident and the difference between the maximum and average core material temperatures is insignificant. This difference becomes larger toward the edge of the reactor since the temperature gradient is the greatest there. Although the maximum and the average temperature in each region, e.g., fuel, cladding, moderator, and core barrel, is highest during the air ingress accident, followed by the DLOFC and the PLOFC accident, this trend reverses near the RPV, the outermost reactor region. This owes to lower density and lower heat capacity air and depressurized helium flowing between the core barrel and the RPV through the coolant riser. Additionally, these fluids replacing pressurized helium in the core slow down heat transfer in the core region. While the moderator and core barrel temperature initially go up in all three accident scenarios, the RPV cools down in all three cases, indicating that the rate of heat removal by the RPV is almost always higher than the rate of heating. The temperatures are uniform in both axial and radial directions.

### Horizontal Reactor

Inevitably, the behavior of heat transfer is affected by the change in fluid motion due to the change in direction of gravity. At the end of the 100 hr, the horizontal reactor is relatively cooler in all three transient scenarios compared to when it is vertical. This is due to the larger heat transfer area on the “upper” part of the reactor (note that the flank of the reactor is now its upper side), where the hot fluid is accumulating. This results in a faster heat transfer and a relatively cooler reactor, compared to when the reactor is vertical. This trend is observed in all three transient scenarios. However, the difference between the vertical and horizontal reactor temperature distribution becomes increasingly smaller from the PLOFC to the DLOFC to the air ingress event for reasons discussed herein.

### CONCLUSIONS

### NEUTRONICS

(1) MINION is a compact mobile nuclear reactor capable of producing 1 MW thermal power for at least 10 years. The critical core weighs 2.419 metric tons and requires 83.861 kg UC fuel (13.822 kg U-235 and 66.006 kg U-238) to operate through the end of cycle. The core has a radial power peaking factor of 1.071, which drops from 1.233 after radial power density flattening of the core.

(2) MINION can operate and shut down with sufficient safety margin. Five of the six control drums (with the highest reactivity worth drum being unavailable) are capable of making the reactor subcritical with a rotation of 146 degrees (81% in) at BOL and 126 degrees (70% in) at EOL. When all six control drums are rotated, the reactor becomes subcritical for a rotation of 55 degrees (30% in) at BOL and 45 degrees (25% in) at EOL.

(3) If none of the control drums works, three of the four control rods (with the highest reactivity worth rod being unavailable) can make the reactor subcritical for a rod insertion of 55 cm (92% in) at BOL and 15 cm (24% in) at EOL. When all four rods are inserted, the reactor becomes subcritical for an insertion of 42 inch (70% in) at BOL and 13 inch (22% in) at EOL.

(4) The conservative design approach of MINION ensures enhanced safety and utmost reliability. Increased gap and cladding thickness are employed in the fuel rod design. Redundant reactivity control is included in both primary and secondary shutdown mechanisms (GDC requires one). Additionally, both shutdown systems are capable of holding the reactor core subcritical under cold conditions (GDC requires one).

(5) The annular fuel pellet design achieved criticality and core-life goals with minimal modifications to the MINIONsolid_pellet design. The only modification involved updating the fuel pellet and the coolant channel dimension. Five of the six control drums and three of the four control rods are capable of making the reactor subcritical with the highest reactivity worth drum and rod being unavailable. The reactor is able to operate for 10 years with little to no excess reactivity. Further modification to the design is needed to achieve the EOL criticality goal.

(6) When LEU fuel with 4.95% enriched U-235 is used in the MINIONsolid_pellet design (core radial power not-flattened), the rector active core size increased from a 60 cm right circular cylinder to an 80 cm right circular cylinder. This involved updating the pitch, the fuel rod size, the amount of fuel, the number of control drums, the amount of neutron absorbers, and the dimension of neutron absorbers. In the MINIONLEU_fuel design, the primary and secondary shutdown margins are sufficiently satisfied, and the core-life goal is achieved with little to no excess reactivity. Further modification to the design is needed to achieve the EOL criticality goal.

### Thermal Hydraulics

### Steady State

(1) During the normal operation of MINION, the average and maximum fuel temperature is 810° C. and 1200° C., respectively. The peak fuel (centerline) temperature is approximately 100-200° C. less than the fission gas release temperature for UC fuel (<⅓ melting point).

(2) The average and maximum cladding temperature is 690° C. and 1000° C., respectively. The maximum cladding temperature is 200° C. below the faulted temperature limit for SiC/SiC composite cladding. The maximum cladding temperature appears near the bottom of the cladding, where the fuel rod is the hottest.

(3) The average and maximum moderator temperature is 403° C. and 715° C., respectively. The hottest region appears near the lower plenum and is 1900° C. below the melting point of BeO (<⅓ melting point).

(4) The average and the maximum core barrel temperature is 305° C. and 400° C. The average and maximum RPV temperature is 225° C. and 380° C. The maximum barrel and RPV temperature occur in the beltline region. The faulted temperature limit for stainless steel barrel and RPV is approximately 600° C. for prolonged exposure. Around 3.5% of the core heat (35 kW) dissipates through the RPV to the RCCS.

(5) The average coolant exit temperature is 670° C. Coolant enters the core at an average rate of 0.557 kg/s, and the average coolant pressure drop at the exit is 2.21 kPa.

(6) The annular fuel pellet design led to a 15% increase in the bulk coolant exit temperature. The coolant exit temperature increased to 760° C. for a reduced mass flow rate 299 of 0.456 kg/s and with a pressure drop of 1.34 kPa. The only design modification to MINION_{solid_pellet} design involved updating the fuel pellet and the coolant channel dimension.

### Accident Scenarios

(1) MINION is coldest during a PLOFC accident and hottest during an air ingress accident, with the DLOFC accident being the intermediate case.

(2) After 100 hr, the fuel temperature and the cladding temperature are nearly in equilibrium. For PLOFC, DLOFC, and air ingress accidents, the maximum fuel and cladding temperatures are 269° C., 325° C., and 374° C., respectively. The average temperatures are 265° C., 323° C., and 373° C., respectively.

(3) The maximum moderator temperature at 100 hr for PLOFC, DLOFC, and air ingress accidents are 275° C., 322° C., and 367° C., respectively. The average temperatures are 260° C., 317° C., and 364° C., respectively.

(4) The maximum core barrel temperature at 100 hr for PLOFC, DLOFC, and air ingress accidents are 257° C., 316° C., and 364° C., respectively. The average temperatures are 213° C., 244° C., and 298° C., respectively.

(5) The maximum RPV temperature after 100 hr for PLOFC, DLOFC, and air ingress accidents are 215° C., 254° C., and 104° C., respectively. The average temperatures are 173° C., 123° C., and 89° C., respectively.

(6) The amount of heat dissipating through the RPV to the RCCS during the PLOFC, DLOFC, and air ingress accidents are 13.35 kW, 7.77 kW, and 3.96 kW, respectively. These values are 38%, 77.8%, and 88.7% lower than their steady-state value.

(7) The low power density (6 W/cc) of MINION, along with the large thermal inertia provided by the beryllia moderator and reflector, as well as the large surface-to-volume ratio of the reactor core, ensure passive removal of decay heat through conduction and radiation.

(8) Since the peak fuel and cladding temperature do not exceed their nominal operating values at any point during the transients, no external cooling mechanism is required for MINION under postulated accident scenarios, equipment failures, or malfunctions.

(9) Should the reactor fall to its side during one of the postulated transient events, this does not lead to degradation in the passive cooling of the reactor. In all three transient events, i.e., PLOFC, DLOFC, and air ingress event, the horizontal reactor is always cooler compared to the vertical reactor, axially and radially.

### Material Properties

URANIUM CARBIDE Although the density of solids is not greatly dependent on temperature, the temperature dependent relationship is applied considering the high temperature at which nuclear reactors operate, especially the transient scenarios. Density of UC obtained by measurement of linear expansion coefficient in the temperature range from 0 to 2800° C. is defined by the following correlation (Kotelnikov, 1978; Preusser, 1982):

$$ρ ( \frac{kg}{{m}^{3}} ) = 13630 \times ( 1 - 3.117 \times {10}^{- 5} T - 3.51 \times {10}^{- 9} {T}^{2} ) \qquad ( A \text{.1} )$$

where T is temperature in K. The molar heat capacity, the amount of heat required to raise the temperature of 1 mole of the fuel by 1 K, is especially important in nuclear fuel materials where neutron cross-sections (hence reactivity) are temperature dependent. Krikorian proposed equation 2 to represent the variation of heat capacity as a function of temperature in UC1.0 between 298 and 2000 K.

$${C}_{p} ( \frac{J}{K mol} ) = 55.96 + 7.62 \times {10}^{- 3} T - 10.13 \times {10}^{- 5} {T}^{- 2} \qquad ( A \text{.2} )$$

Vasudevamurthy and Nelson (2022) recommended using Eq. (5) to represent the variation of cp with temperature for UC_{1.0}. This equation suggested by an International Atomic Energy Agency panel takes into account the low-temperature heat capacity data presented by other authors, including Westrum and Farr, and high-temperature heat capacity measurements by Harrington and Rowe, Otteing and Storms over an extended temperature range of 300 to 2400 K.

$${C}_{p} ( \frac{J}{K mol} ) = 61.64 - 22.35 \times {10}^{- 4} T - 41.81 \times {10}^{- 7} {T}^{- 2} - 9.92 \times {10}^{5} {T}^{- 2} \qquad ( A \text{.3} )$$

Leitnaker and Godfrey (1967) have conducted experiments on UC in a temperature range between 298.15 and 2800 K and provided eq 2 to calculate the specific heat of UC, where T is the temperature in K and the specific heat and enthalpy are in J/kg K and J/kg, respectively. The average percent error associated with Eq. (18.19) is ±0.84%.

$${C}_{p} ( \frac{J}{kg K} ) = 6 \times {10}^{- 15} {T}^{5} - 6 \times {10}^{- 11} {T}^{4} + 2 \times {10}^{- 7} {T}^{3} - 3 \times {10}^{- 4} {T}^{2} + 0.2655 T + 147.34 \qquad ( A \text{.4} )$$

Coninck et al. (1975) provided a thermal conductivity and temperature correlation for stoichiometric UC, which can be used to determine the thermal conductivity for a temperature range between 85° and 2250° C., in W/m K.

$$k ( \frac{W}{m K} ) = 100 [ 0.195 + 3.57 \times {10}^{- 8} {( T - 1123.15 )}^{2} ] \qquad ( A \text{.5} )$$

$$1120 K < T < 2520 K$$

### Helium

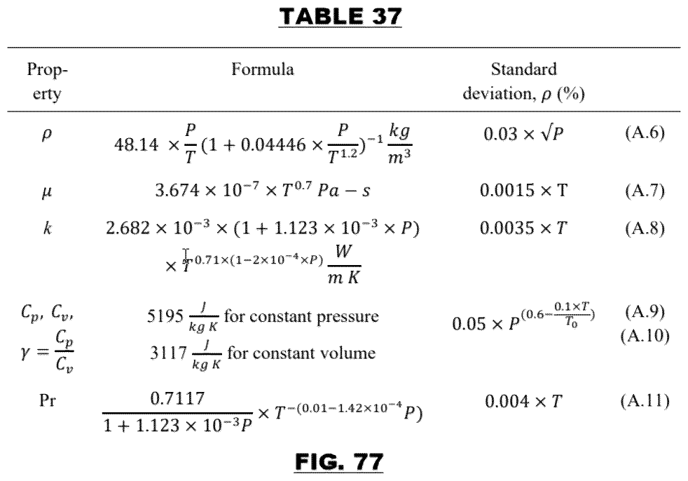

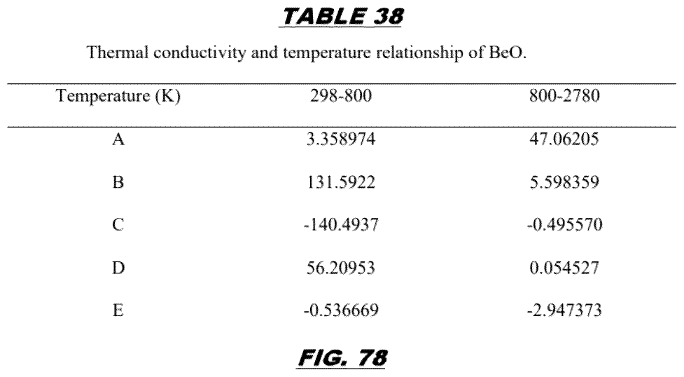

Helge Peterson has done an estimation of the properties of helium for the ranges of pressure and temperature applicable to helium-cooled reactor design. A summary of data for helium at 1 to 100 bar and 273 to 1800 K is outlined based on the theory for the properties and the data calculated from intermolecular potential functions. The formulas are described in Table 37, see FIG. 77.

### Beryllium Oxide

Properties for the BeO reflector were taken from Carniglia and Hove (1961). The density of 99% pure BeO is 2,977.92 kg/m³ and it does not strongly depend on temperature. Nevertheless, the temperature dependent relationship is applied considering the high temperature at which nuclear reactors operate and the transient scenarios.

$$ρ ( \frac{kg}{{m}^{3}} ) = - 0.00001 \times {T}^{2} - 0.0806 \times T + 3017.5 \qquad ( A \text{.12} )$$

$$cp ( \frac{J}{mol - K} ) = ( 3.358974 + 131.5922 \times \frac{T}{1000} - 140.4937 \times {( \frac{T}{1000} )}^{2} + 56.20953 \times {( \frac{T}{1000} )}^{3} - \frac{0.536669}{{( T / 1000 )}^{2}} \qquad ( A \text{.13} )$$

The thermal conductivity and temperature relationship of BeO is used from the work of chase (1998).

$$k ( \frac{W}{m - K} ) = 1.13 \times {10}^{5} \times {T}^{- 1.067} \qquad ( A \text{.14} )$$

### Silicon Carbide

The theoretical density of SiC is 3210 kg/m³. Temperature dependence of SiC density is calculated using the following polynomial function, created based on literature data.

$$ρ ( \frac{kg}{{m}^{3}} ) = 8 \times {10}^{- 9} \times {T}^{2} - 4 \times {10}^{- 4} \times T + 3.1614 \qquad ( A \text{.15} )$$

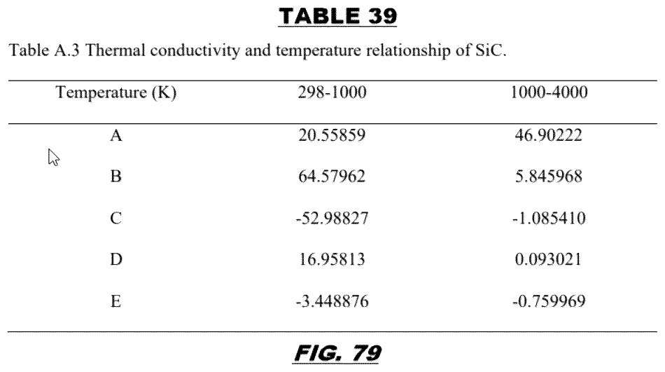

The solid phase specific heat capacity of SiC is calculated using the Shomate equation, according to the NIST database.

$${C}_{p} ( \frac{J}{kg - K} ) = A + ( B \times T ) + ( C \times {T}^{2} ) + ( D \times {T}^{3} ) + \frac{E}{{T}^{2}} \qquad ( A \text{.16} )$$

where T is temperature (K)/1000. The values for the constants are provided in Table 39, see FIG. 79.

Joshi et al. (2000) calculated the temperature dependent thermal conductivity of silicon carb and compared the results with available experimental data by assuming and showing that 6H-SiC thermal conductivity can roughly be used for the 4H-SiC thermal conductivity as well.

$$k ( \frac{W}{m - K} ) = 4.5 \times {10}^{5} \times {T}^{- 1.29} \qquad ( A \text{.17} )$$

Previous works revealed a strong decrease in thermal conductivity of SiC after irradiation (Munro, 1997). However, the magnitude of the reduction of thermal conductivity decreased with increasing irradiation temperature. A tentative result of thermal conductivity change for ° CVD-SiC during neutron irradiation reported by Yamada and Snead shows that thermal conductivity of monolithic ° CVD 3-SiC decreased in the early stage of irradiation and saturated. The saturated thermal conductivity was about 35% of the initial value of SiC for 700° C. irradiation. Snead et al. (2007) reported similar thermal conductivity for SiC in the saturatable and non-saturatable regime and is used in this disclosure.

BERYLLIUM OXIDE Density of BeO is calculated using the following polynomial relationship.

$$ρ ( \frac{kg}{{m}^{3}} ) = {10}^{- 5} \times {T}^{2} - 8.06 \times {10}^{- 2} \times T + 3017.5 \qquad ( A \text{.18} )$$

Heat capacity is calculated using the following formula based on the data reported by Hou et al. (2022).

$${C}_{p} ( \frac{J}{kg - K} ) = 5.31 \times {10}^{7} \times {T}^{2} + 0.67 \times T + 1414.2 \qquad ( A \text{.19} )$$

BeO has one of the highest thermal conductivity ceramics and can withstand the radiation environment at high temp. The thermal conductivity of beryllium oxide is exceptionally high, in fact, higher than that of most refractory materials. At temperatures below about 500 K it exceeds the thermal conductivity of beryllium.

BeO does not suffer from severe degradation in thermal conductivity when the fast neutron dose is lower than approximately 1019 n/cm² even at 60° C. (Snead, 2005). The estimated values of thermal conductivity of irradiated BeO at higher temperatures, based on simple defect scattering effects on thermal conductivity and without the consideration of internal interfaces (Hickman, 1964). These data are used to calculate the BeO thermal conductivity using the following formula.

$$k ( \frac{W}{m - K} ) = 1.13 \times {10}^{5} \times {T}^{- 1.067} \qquad ( A \text{.20} )$$

### Stainless Steel (Ss316)

The thermal conductivity for SS316L is given by Equation 11 (Mills 2002).

$$k = 6.308 + 2.716 \times {10}^{- 2} T - 7.301 \times {10}^{- 6} {T}^{2} \qquad ( A \text{.21} )$$

where k is the thermal conductivity (W/m-K) and T is the temperature (K). The trend shows an increase in thermal conductivity with temperature until about 1,800 K. The specific heat is given by Equation 12 (Mills 2002).

$${C}_{p} 428.46 + 0.1816 T \qquad ( A \text{.22} )$$

where Cₚ is the specific heat (J/kg-K) and T is the temperature (K). The trend is a linear increase with temperature
****

### THE FOLLOWING ARE HEREBY INCORPORATED BY REFERENCE IN THEIR ENTIRETY TO THE EXTENT NOT INCONSISTENT HEREWITH

Akiyoshi M., I. Takagi, T. Yano, N. Akasaka and Y. Tachi, “Thermal conductivity of ceramics during Irradiation,” Fusion Eng. Des., vol. 81, pp. 321-325, (2006).
Alexander J. Huning, Sriram Chandrasekaran, Srinivas Garimella, a review of recent advances in HTGR CFD and thermal fluid analysis, Nuclear Engineering and Design,
Volume 373, 2021, 111013, ISSN 0029-5493, doi.org/10.1016/j.nucengdes.2020.111013
Aneesh, A. M.; Sharma, A.; Vyas, K. N.; Chaudhuri, P.; Srivastava, A. Thermal-hydraulic characteristics and performance of 3D straight channel based printed circuit heat exchanger. Appl. Therm. Eng. 2016, 98, 474-482.
ARIS, Advanced Reactor Information System, International Atomic Energy Agency (IAEA). August, J. K., Hunter, J. J. 2008. Relicensing Fort St. Vrain: How the HTGR Design Basis Was Rediscovered, pp. 109-125.
Beck, J. M., ° C. B. Garcia, and L. F. Pincock. (2010). High Temperature Gas-Cooled Reactors Lessons Learned Applicable to the Next Generation Nuclear Plant. INL/EXT-10-19329. Idaho Falls, ID: Idaho National Laboratory. osti.gov/scitech/biblio/1023461.
Beyer, ° C. E., ° C. R. Hann, D. D. Lanning, F. E. Panisko, and L. J. Parchen. 1975. GAPCONTHERMAL-2: A computer Program for calculating the Thermal Behavior of an Oxide Fuel Rod, BNWL-1898, Battelle Northwest Laboratory, Richland, WA.
Blessing D. L. and Kirkland J. (2006). Design considerations and conceptual Designs for Surface Nuclear Power Systems for the Moon and Mars”, Proceedings of Space Technology and Applications International Forum—STAIF, Albuquerque, NM, USA, February 12-16, pp. 920-931.
Boisset L., G. L. Fiorini, G. Marbach, ° C. Latg6, W. Gulden; control of accidental situations internal to the torus Boisset L., “Analysis of beryllium/air and beryllium/steam reactions”, Technical report ceA/DRN/DER/STML/LEPE/94-454 (1994).
Chang, ° C.-Y.; Chen, W.-H.; Saw, L. H.; Arpia, A. A.; Carrera Uribe, M. Preliminary safety analysis of a Printed circuit Heat Exchanger with a Novel Mirror-Symmetric channel Design. Energies 2021, 14, 4252. doi.org/10.3390/en14144252.
Cizek, J.; Kalivodovi, J.; \hat{ }Jane\hat{ }cek, M.; Strisky, J.; Srba, 0.; Mackovi, A. Advanced Structural Materials for Gas-Cooled Fast Reactors-A Review. Metals 2021, 11, 76. doi.org/10.3390/met11010076
Collins G. Radiation effects in BeO. 1964. p. 69-86.
Braun, J., et al., “Chemical compatibility between UO2 fuel and SiC cladding for LWRs: Application to ATF (Accident-Tolerant Fuels),” Journal of Nuclear Materials, Vol. 487, 380-395, 2017
Brey H. L., “Developmental history of the gas turbine modular high temperature reactor”, IAEA TCM on gas turbine power conversion system for modular HTGRs, November 14-16, 2000, Palo Alto, California.
Brey H. L. (1987), Fort St. Vrain circulator operating experience, IAEA Specialists' meeting on gas-cooled reactor coolant circulator and blower technology. San Diego, ca (USA), 30 November—2 Dec. 1987.
Briger P. and Cinotti L. (2019). The LFR-AS-200 and the LFR-TL-X, GAIN-EPRI-NEIUS NIC micro-reactor workshop, June 18-19, 2019.
Bruckner T., I. A. Bashmakov, Y. Mulugetta, H. chum, A. de la Vega Navarro, J. Edmonds, A. Faaij, B. Fungtammasan, A. Garg, E. Hertwich, D. Honnery, D. Infield, M. Kainuma, S. Khennas, S. Kim, H. B. Nimir, K. Riahi, N. Strachan, R. Wiser, and X. Zhang (2014). Energy Systems. In: climate change 2014: Mitigation of climate change. contribution of Working Group III to the Fifth Assessment Report of the Intergovernmental Panel on climate change, Cambridge University Press, Cambridge, United Kingdom and New York, NY, USA.
Cabet, et al. High temperature corrosion of structural materials under gas-cooled reactor helium Mater. corros., 57 (2006), p. 147
Chase, M. W., Jr., NIST-JANAF Themochemical Tables, Fourth Edition, J. Phys. chem. Ref. Data, Monograph 9, 1998, 1-1951.
Copinger, D. A., Moses, D. L., Cupidon, L. R., Fort Saint Vrain Gas cooled Reactor Operational Experience, ORNL/TM-2003/223, 2004, doi.org/10.2172/1495207.
Dawahra S., K. Khattab, G. Saba. Investigation of BeO as a reflector for the low power research reactor. 2015
Dienst W. 1984. Swelling, densification and creep of (U, Pu) ° C. fuel under irradiation. Journal of nuclear materials 124: 153-158. DOE-HDBK-1019/2-93; DOE Fundamentals Handbook Nuclear Physics and Reactor Theory.
Dragunov A., Eugene Saltanov Igor Pioro Brian Ikeda Marija Miletic Anastasiia Zvorykina (2013), Investigation of Thermophysical and Nuclear Properties of Prospective coolants for Generation-IV Nuclear Reactors July 2013 DOI:10.1115/ICONE21-16020 conference: 2013 21st International conference on Nuclear Engineering EIA (2019), U.S. Energy Information Administration, International Energy Outlook 2019.
Ferguson and Walker, 1970 I. F. Ferguson, D.E.Y. Walker The high temperature reaction between uranium monocarb and β-silicon carb J. chem. Soc. A (1970), p. 4
Farr J. D., J. E. Huber, E. Head, E. Charles. The preparation of uranium monocarb and its heat of formation J. Phys. chem. (1959), pp. 1455-1456.
Ferguson and Walker, 1970 I. F. Ferguson, D.E.Y. Walker The high temperature reaction between uranium monocarb and β-silicon carb J. chem. Soc. A (1970), p. 4
Forsberg, ° C. W., Peterson, P. F., Kochendarfer, R. A. (2008), Proceedings of ICAPP ′08 Anaheim, ca USA, Jun. 8-12, 2008 Paper 8026.
Friedly J. C., J. L. Manganaro and P. G. Kroeger, NAS8-21014, NASA Marshall Space Flight Center, Huntsville, Alabama, Oct. 1967.
Gallego, N. ° C., T. D. Burchell and J. W. Klett, “Irradiation Effects on Graphite Foam,” Carbon, vol. 44, pp. 618-628, (2006).
Garnier, J. E. and S. Begej. 1979. Ex-Reactor Determination of Thermal Gap and contact conductance Between Uranium Dioxide: Zircaloy-4 Interfaces; Stage I: Low Gas Pressure, NUREG/CR-0330, PNL-2696, Pacific Northwest Laboratory, Richland, WA.
GDC, 2018; U.S. Nuclear Regulatory commission Regulatory Guide: Guidance for Developing Principal Design criteria for Non-light-water Reactors.
General Atomic, “Technical foundation of TRIGA”. San Diego, California (1958) (GA471).
General Atomic, “Safeguards Summary Report for the New York University TRIGA Mark I Reactor”, San Diego, California (1970). (GA-9864).
Gerczak, T. J., Jake W. McMurray, Assessment of SiC-CMC compatibility with components of actinide fuel systems, Annals of Nuclear Energy, Volume 128, 2019, Pages 127-139, ISSN 0306-4549, doi.org/10.1016/j.anucene.2018.12.030.
Grande, 2010 L. C. Grande Thermal Aspects of Using Alternative Nuclear Fuels in Supercritical Water-cooled Reactor Faculty of Energy Systems and Nuclear Science. University of Ontario Institute of Technology, Ontario (2010), p. 131.
Harrington H., G. Rowe, The Enthalpy and Heat capacity of Uranium Monocarb to 1200° C. US Atomic Energy commission (1964)
Hao Zhao, Dahuan Zhu, Khurrum Saleem chaudri, Suizheng Qiu, Wenxi Tian, Guanghui Su, Preliminary transient TH analysis for new coated UN and UC fuel options in SCWR, Progress in Nuclear Energy, Volume 71, 2014, Pages 152-159, ISSN 0149-1970, doi.org/10.1016/j.pnucene.2013.11.008.
Hayes, S. L. and D. L. Porter, INL (2007) “SFR Fuel Performance and Approach to Qualification”, Presentation to DOE/NRC Seminar Series on Sodium Fast Reactors, 27-28 November.
Hickman B. S., A. W. Pryor The effect of neutron irradiation on beryllium oxide J. Nucl. Mater., 14 (1964), pp. 96-110
Holleck, H. Kleykamp Thermodynamics of multi-component systems containing UC and PuC J. Nucl. Mater., 32 (1962), p. 19.
Hou, M.-D., Xiang-wen Zhou, Bing Liu, Part II: A systematic review of the neutron irradiation effects Author links open overlay panel, doi.org/10.1016/j.net. 2022.10.020
IEA (2020), World Energy Outlook 2020. International Energy Agency. Paris iea.org/reports/world-energy-outlook-2020.
IAEA (2006). Fast Reactor Database 2006 Update”, International Atomic Energy Agency—IAEA, TECDOC-1531.
IAEA (2005). The Role of Nuclear Power and Nuclear Propulsion in the Peaceful Exploration of Space. International Atomic Energy Agency—IAEA, Pub 1197 (2005).
IAEA (2019). International Atomic Energy Agency: IAEA Safeguards Glossary—2001 Edition, International Nuclear Verification Series No. 3, “Table-IL: Significant Quantities,” Vienna, Austria, 2002, page-23.
IAEA (1990). Gas cooled reactor design and safety. International Atomic Energy Agency. Technical report series No. 312, Vienna. IF (2007), GEN IV International Forum—2007 Annual Report, www.gen4.org/PDFs/annual_report2007.pdf.
Incropera, F. P., Dewitt, D. P., Bergman, T. L., and Lavine, A. S., Fundamentals of Heat and Mass Transfer, John Wiley & Sons, Inc., 6th ed., 2006.
Jie Wei et al. Modified Embedded Atom Method Potential for Modeling the Thermodynamic Properties of High Thermal conductivity Beryllium Oxide. DOI:10.1021/acsomega.9b00174 ACS Omega 2019, 4, 6339-6346.
Jones M. C. and R. G. Peterson, J. Heat Transfer Trans. ASME Series C, 97, 521 (1975).
Jones M. C. and W. W. Johnson, Heat Transfer and Flow of Helium in Channels-Practical Limits for Applications in Superconductivity, National Bureau of Standards, 1976.
Krishnan V. S. and J. C. Friedly, Proceedings of the 5th International Heat Transfer Conference, Tokyo, 1974.
Kadak, Andrew; Bazant, Martin (2004). Pebble Flow Experiments For Pebble Bed Reactors, 2nd International Topical Meeting on High Temperature Reactor Technology, Beijing, china, Sep. 22-24, 2004.
Katoh, H. Kishimoto, and a. Kohyama, “The Influences of Irradiation Temperature and Helium Production on the Dimensional Stability of Silicon carb,” J. Nucl. Mater., 307-311, 1221 (2002); doi.org/10.1016/S0022-3115(02)01062.
Katoh, Y., et al., continuous SiC fiber, ° CVI SiC matrix composites for nuclear applications: Properties and irradiation effects. Journal of Nuclear Materials, 2014. 448(1-3): p. 448-476.
Katoh, Y., et al., Dimensional stability and anisotropy of SiC and SiC-based composites in transition swelling regime. Journal of Nuclear Materials, 2018. 499: p. 471-479.
Kays, W., Crawford, M., and Weigand, B., convective Heat and Mass Transfer, McGraw-Hill Higher Education, Boston, Massachusetts, 4th ed., 2005.
Kendall, J. M., and R. E. Bullock (2004). Advanced coated Particle Fuel Options. Global Virtual, LLC, Prescott, Arizona, Sigma Science Inc., Albuquerque, New Mexico, 2nd International Topical Meeting on High Temperature Reactor Technology, Beijing, china.
Kim, H. G. et al., “Development Status of Accident-tolerant Fuel for Light Water Reactors in Korea,” Nuclear Engineering and Technology, 48, 1-15, 2016. Stempien, J. et al., “Characteristics of composite Silicon carb Fuel cladding After Irradiation Under Simulated PWR conditions,” Nuclear Technology, 183, 13-29, July 2013.
Kiryushin A., N. G. Kodochigov (2002), GT-MHR project, Proceedings of the conference on high temperature reactors, Petten, Netherlands, Apr. 22-24, 2002.
Kotelnikov R. B. et al. High Temperature Nuclear Fuel/2nd ed.—M.: Atomizdat, 1978. Preusser T. Modeling of carb Fuel Rod.—Nuclear Technology, 1982, Vol. 57, PP. 343-371.
Kumar K. N., A. Tourlidakis, P.Pilidis (2000), Performance review: PBMR closed cycle gas turbine power plant, IAEA TCM gas turbine power conversion systems for modular HTGRs, Nov. 14-16, 2000 in Palo Alto, California.
LaBar. M. P. (2002), The Gas Turbine—Modular Helium Reactor: A promising option for near term deployment. General Atomics report No. GA-A23952.
Lamarsh R. J. and Baratta A. R., Introduction to Nuclear Engineering (3rd Edition), Prentice-Hall (2001), ISBN-10: 0201824981.
LEWIS H. D. & KERRISK J. F. 1976. Electrical and thermal transport properties of uranium and plutonium carbs.
Lisowski, D., Qiuping Lv, Bogdan Alexandreanu, Yiren Chen, Rui Hu, Tanju Sofu Nuclear Science and Engineering Division Argonne National Laboratory, Lemont, IL 60439.
Shepherd, D. (2015), Technology readiness level (TRL) assessment of cladding alloys for advanced nuclear fuels, UK National Nuclear Laboratory (NNL), United Kingdom structural Materials For Innovative Nuclear Systems (Smins-3), Nea/Nsc/Wpfc/Doc(2015)9
Mankins, J. C., NASA (1995), “Technology Readiness Levels”, NASA White Paper, 6 April.
Manly, W. D., Utilization of BeO in reactors. J. Nucl. Mater., 14 (1964), pp. 3-18
Maruyama T. and M. Harayama, “Neutron Irradiation Effects on the Thermal conductivity and Dimensional change of graphite Materials,” J. Nucl. Mat., vol. 195, pp. 44-50, (1992).
Maulbetsch J. S. and P. Griffith, Proceedings of the Symposium on Two-Phase Flow Dynamics, vol I, p. 799 EURATOM Report 4288e, Brussels, 1969.
Melese, G., Katz, R. 1984. Thermal and flow design of helium-cooled reactors, DOE/NBM-5007607.
Mills, K. ° C. 2002. Recommended Values of Thermophysical Properties for Selected commercial Alloys. Woodhead Publishing. MIT (2018). Massachusetts Institute of Technology, The Future of Nuclear Energy in a Carbon-Constrained World.
Moore R. A. et al., “HTGR experience, programs, and future applications”, Nuclear engineering and design 72 (1982), pp. 153-174.
Moormann, R., A safety re-evaluation of the AVR pebble bed reactor operation and its consequences for future HTR concepts, Forschungszentrum Jiilich, Germany, ISSN 0944-2952, Jill-4275.
Munro, R. G. (1997), Material Properties of a Sintered a —SiC Journal of Physical and chemical Reference Data 26, 1195 (1997); doi.org/10.1063/1.556000
Murray, L. R., Holbert, K. E., Nuclear Energy (Eighth Edition), 2020, MRP, Microreactor Program, Idaho National Laboratory.
Nader, M. A., Investigation of BeO as a reflector for PWR. International congress on Advanced in Nuclear power Plants, vol. 1 (2011), pp. 15-20.
Naidin et al., 2010 M. Naidin, I. Pioro, R. Duffey*, S. Mokry, L. Grande, B. Villamere, L. Allison, A. Rodriguez-Prado, S. Mikhael, K. Chophla Super critical Water-cooled Nuclear Reactors (SCWRs) Thermodynamic cycle Options and Thermal Aspects of Pressure-channel Design (2010) IAEA-CN-164-5S03.
NAP (2020). Preliminary Feasibility Study for Small Modular Reactors and Microreactors for Puerto Rico. Nuclear Alternative Project. Report No. 20-0001 Rev 0, May 11, 2020.
Nautilus (2018). Nautilus: The First Nuclear Submarine. large.stanford.edu. Retrieved 2021-09-21.
NEI (2019). cost competitiveness of Micro-reactors for Remote Markets. Nuclear Energy Institute.
NEI (2018). Roadmap for the Deployment of Micro-reactors for US Department of Defense Domestic Installations. Nuclear Energy Institute.
Next Generation Nuclear Plant Phenomena Identification and Ranking Tables (PIRTs) NUREG/CR-6944, Vol. 1 ORNL/TM-2007/147, Vol. 1
Nickerson G. M. & Kastenberg W. E. 1976. Preliminary assessments of carb fuel pins during mild overpower transients in LMFBRs. Nuclear Engineering and Design 36: 209-233.
Nozawa, T., Katoh, Y, and Snead, L. L., “The Effect of Neutron Irradiation on the Fiber/Matrix Interphase of Silicon carb composites,” J. Nucl. Mater., 384, 195 (2009); doi.org/10.1016/j.jnucmat.2008.11.015.
Nozawa, T. et al., “Recent Advances and Issues in Development of Silicon carb composites for Fusion Applications,” J. Nucl. Mater., 386-388, 622 (2009); doi.org/10.1016/j.jnucmat.2008.11.015.
Nguyen, Tien (2020). Powering Human Settlements in Space. ACS central Science 2020, 6 (4), 450-452 DOI: 10.1021/acscentsci.0c00382.
Oetting F., J. Navratil, E. Stroms The chemical thermodynamic properties of nuclear materials: (II) high temperature enthalpy of the uranium carbs J. Nucl. Mater., 45 (1972), pp. 271-283.
O. H. Krikorian, Thermal Expansion of High Temperature Materials U.S. Atomic Energy commission, Livermore, ca (1960) UCRL-6132.
Oizumi, A., Akie, H., Iwamoto, N., Kugo, T. (2014) Evaluation of neutron economical effect of new cladding materials in light water reactors, Journal of Nuclear Science and Technology, 51:1, 77-90, DOI: 10.1080/00223131.2014.849210.
Olson, ° C. A. and Boman, L. H. (1975). Three dimensional thermal effects in PWR fuel rods. Proceedings of the American Society of Mechanical Engineers, Winter Meeting.
ONE: Office of Nuclear Energy. INFOGRAPHIC: How Much Power Does A Nuclear Reactor Produce? 31 Mar. 2021. Digital. 1 Jan. 2022.
Parrott J. E. and A. D. Stuckes, Thermal conductivity of solids, p. 45, Pion Limited, London (1975).
Pascoe et al., 2010° C. Pascoe, A. Milner, H. Patel, W. Peiman, G. Richards, L. Grande, I.
Pioro Thermal aspects of using uranium dicarb fuel in an SCWR at maximum heat flux conditions ASME conference Proceedings 2010 (2010), pp. 767-774.
Patankar S V, Spalding DB (1972), A calculation procedure for heat, mass and momentum transfer in three-dimensional parabolic flows. International Journal of Heat and Mass Transfer, 15(10):1787-1806.)
Petersen, H. (1970). The properties of helium: Density, specific heats, viscosity, and thermal conductivity at pressures from 1 to 100 bar and from room temperature to about 1800 K. (Denmark. Forskningscenter Risoe. Risoe-R; No. 224).
P. L. 115-248, Section 2; amending Section 951 of the Energy Policy Act of 2005 (42 U.S.C. 16271).
Preusser T. 1982. Modeling of carb fuel rods. Nuclear Technology; (United States): 57 Price R. J., “Thermal conductivity of Neutron-Irradiated Reactor graphites,” Carbon, vol. 13, pp. 201-204, (1975).
Quadakkers, et al. Thermodynamic and kinetic aspects of the corrosion of high-temperature alloys in high temperature gas-cooled reactor helium Nucl. Technol., 66 (1984), p. 383.
Rearden, B. T. and Jessee, M. A., Eds., SCALE code System, ORNL/TM-2005/39, Version 6.3 BETA 3, Oak Ridge National Laboratory, Oak Ridge, Tennessee (2018).
Rohde, M. “Reduction of the Thermal conductivity of SiC by Radiation Damage,” J. Nucl. Mat., vol. 182, pp. 87-92, (1991).
Snead L. L. and T. D. Burchell, “Thermal conductivity Degradation of graphite due to Neutron Irradiation at Low Temperature,” J. Nucl. Mat., vol. 224, pp. 222-229, (1995).
STR: Standard Technical Specifications (2012); NUREG-1433 Volume 1 Revision 4.0. Shropshire, D., Black, G., Aradjo, K. (2021). Global Market Analysis of Microreactors. Market Analysis. Idaho Falls: Department of Energy.
Shropshire, D. (2004), Lessons Learned From GEN I Carbon Dioxide cooled Reactors. Arlington, Virginia.
Simnad M T, Meyer R A, Zumwalt L R, editors. Beryllium oxide: review of properties for nuclear reactor applications. Nuclear applications of nonfissionable ceramics. Washington DC: American Nuclear Society; 1966.
Silva, ° C. M. et al. chemical reactivity of ° CVC and ° CVD SiC with UO2 at high temperatures J. Nucl. Mater., 460 (2015), pp. 52-59
Snead L., David Sprouster, Bin Cheng, Nick Brown, Caen Ang, Edward M Duchnowski, Xunxiang Hu & Jason Trelewicz (2022) Development and potential of composite moderators for elevated temperature nuclear applications, Journal of Asian ceramic Societies, 10:1, 9-32, DOI: 10.1080/21870764.2021.1993592. Journal of Nuclear Materials 371 (2007) 329-377.
Snead L. L., Takashi Nozawa, Yutai Katoh, Thak-Sang Byun, Sosuke Kondo, David A. Petti, Handbook of SiC properties for fuel performance modeling, Journal of Nuclear Materials, 2007. 371(1-3): p. 329-377
Snead L. L., S. J. Zinkle Use of beryllium and beryllium oxide in space reactors AIP conf. Proc., 746 (2005), pp 768.
Snead, L. L., S. J. Zinkle and D. P. White, “Thermal conductivity Degradation of ceramic Materials due to Low temperature, low Dose Neutron irradiation,” J. Nucl. Mat., vol. 340, pp. 187-202, (2005).
Steiner, H. (1977), Heat transmission during start-up in carb fuel pins provided with average to large fabrication gaps. KfK-2472.
Sterbentz, J. W. (2007), Low-Enriched Fuel Design concept for the Prismatic Very High Temperature Reactor core. Proceedings of ICAPP 2007 Nice, France, May 13-18, 2007 Paper 7098.
Stroms E., J. Huber The Heat of Formation of Uranium carb J. Nucl. Mater., 23 (1) (1967), pp. 19-24
Todreas, N., and G. Jacobs. 1973. “Thermal contact conductance of Reactor Fuel Elements,” Nuclear Science and Engineering, 50:283.
Testoni R., Bersano A., Segantin S. (2021), Review of nuclear microreactors: Status, potentialities and challenges, doi.org/10.1016/j.pnucene.2021.103822.
Thurston R. S., J. D. Rogers and V. J. Skoglund, Advances in Cryogenic Engineering vol. 12 p. 438 (Plenum Press, New York and London 1967).
Timothy M. Schriener and Mohamed S. El-Genk. comparison of Reactivity control Systems for the Submersion Subcritical Safe Space (SA4) Reactor. AIP conference Proceedings 969, 348 (2008); doi.org/10.1063/1.2844987.
Tochio, D., Atsushi Shimizu, Shimpei Hamamoto & Nariaki Sakaba (2014) Helium leak and chemical impurities control technology in HTTR, Journal of Nuclear Science and Technology, 51:11-12, 1407-1412, DOI: 10.1080/00223131.2014.921126
U.S. Atomic Energy commission, (second ed.), Tipton (Ed.), cr, vol. 1, Interscience Publishers, New York (1960), p. 897 (chapter 44).
U.S. NRC (2019). Appendix G to Part 50-Fracture Toughness Requirements. Technical report. Retrieved Jul. 22, 2021 from nrc.gov/reading-rm/doccollections/cfr/part050/part050-appg.html.
USNRL (2000). The Little Book of Big Achievements. United States Naval Research Laboratory.
Vasudevamurthy G., Andrew T. Nelson, Uranium carb properties for advanced fuel modeling—A review, Journal of Nuclear Materials, Volume 558, 2022, 153145, ISSN 0022-3115, doi.org/10.1016/j.jnucmat.2021.153145.
VERRALL R. A., M. D. VLAJIC, and V. D. KRSTIC “Silicon carb as an Inert-Matrix for a Thermal Reactor Fuel,” J. Nucl. Mater., 274, 54 (1999); doi.org/10.1016/S0022-3115(99)00089-6.).
Waltar, A. E. and Reynolds A. B., 1981. Fast breeder reactors, Pergamon Press, USA, 853 pages.
Westrum E., ° C. Barber Uranium mononitride: heat capacity and thermodynamic properties from 5 to 350K J. chem. Phys., 45 (2) (1966), pp. 635-639.
Wilks R. S. Neutron-induced damage in BeO, Al₂O₃ and MgO-a review. J Nucl Mater. 1968; 26:137-173.
Wright, R., Kinetics of Gas Reactions and Environmental Degradation in NGNP Helium (2008) INL/EXT-06-11494.
Wullaert, R. A., Fackelmann, J. M., and chubb, W. An Evaluation of UC-PuC for Sodium cooled Fast Reactors. United States: N. p., 1967. Web. doi:10.2172/4388690.

Various modifications and variations of the described methods, nuclear reactors, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A mobile nuclear microreactor comprising:
at least one reactor cavity cooling system at least partially surrounding at least one reactor pressure vessel:
the at least one reactor pressure vessel comprising:
at least one active core further comprising;
a plurality of hexagonal moderator blocks arranged in at least one hexagonal lattice array within the at least one active core;
wherein the plurality of hexagonal moderator blocks have at least one hole drilled in each to contain either at least one fuel rod or at least one control rod;
wherein the at least one active core is at least partially surrounded by at least one reflector;
wherein at least one control drum is placed at an outer edge of the active core;
wherein the at least one control drum includes at least one neutron absorber arc;
at least one upper plenum configured as an inlet for at least one coolant positioned above the at least one active core; and
at least one lower plenum configured as an outlet for the at least one coolant positioned below the at least one active core.

2. The mobile nuclear microreactor of claim 1, wherein the reactor is transportable from a first location to a second location without requiring disassembling the mobile nuclear microreactor.

3. The mobile nuclear microreactor of claim 1, wherein the at least one reflector is comprised of Beryllium Oxide.

4. The mobile nuclear microreactor of claim 1, wherein the at least one coolant comprises Helium.

5. The mobile nuclear microreactor of claim 1, wherein the at least one control drum is configured to rotate to change position of the at least one neutron absorber arc with respect to the at least one active core to control power generation of the at least one active core.

6. The mobile nuclear microreactor of claim 5, wherein the at least one control rod is positioned within the at least one active core in combination with changing position of the at least one neutron absorber arc to control power generation of the at least one active core.

7. The mobile nuclear microreactor of claim 1, wherein the at least one neutron absorber arc comprises Boron Carbide.

8. The mobile nuclear microreactor of claim 1, further comprising at least one coolant riser contained within the reactor pressure vessel.

9. The mobile nuclear microreactor of claim 1, wherein at least a subset of the plurality of hexagonal moderator blocks define at least one annular channel configured to allow coolant to flow within the hexagonal moderator blocks containing the at least one annular channel.

10. The mobile nuclear microreactor of claim 1, wherein the at least one active core is formed into at least two discrete sections with each discrete section having a unique Uranium-235 enrichment.

11. A method of making a mobile nuclear microreactor comprising:
configuring at least one reactor cavity cooling system to at least partially surround at least one reactor pressure vessel:
configuring the at least one reactor pressure vessel to comprise at least one active core;
arranging a plurality of hexagonal moderator blocks in at least one hexagonal lattice array within the at least one active core;
forming at least one hole in each of the plurality of hexagonal moderator blocks to contain either at least one fuel rod or at least one control rod;
at least partially surrounding the at least one active core with at least one reflector;
placing at least one control drum at an outer edge of the active core;
configuring the at least one control drum to include at least one neutron absorber arc;
configuring at least one upper plenum as an inlet for at least one coolant and positioning the at least one upper plenum above the at least one active core; and
configuring at least one lower plenum as an outlet for the at least one coolant and positioning the at least one lower plenum below the at least one active core.

12. The method of making a mobile nuclear microreactor of claim 11, further comprising configuring the reactor as transportable from a first location to a second location without requiring disassembling the mobile nuclear microreactor.

13. The method of making a mobile nuclear microreactor of claim 11, further comprising wherein the at least one reflector is comprised of Beryllium Oxide.

14. The method of making a mobile nuclear microreactor of claim 11, further comprising wherein the at least one coolant comprises Helium.

15. The method of making a mobile nuclear microreactor of claim 11, further comprising configuring the at least one control drum to rotate to change position of the at least one neutron absorber arc with respect to the at least one active core to control power generation of the at least one active core.

16. The method of making a mobile nuclear microreactor of claim 15, further comprising positioning the at least one control rod within the at least one active core in combination with changing position of the at least one neutron absorber arc to control power generation of the at least one active core.

17. The method of making a mobile nuclear microreactor of claim 11, further comprising wherein the at least one neutron absorber arc comprises Boron Carbide.

18. The method of making a mobile nuclear microreactor of claim 11, further comprising configuring at least one coolant riser within the reactor pressure vessel.

19. The method of making a mobile nuclear microreactor of claim 11, further comprising configuring at least a subset of the plurality of hexagonal moderator blocks to define at least one annular channel configured to allow coolant to flow within the hexagonal moderator blocks containing the at least one annular channel.

20. The method of making a mobile nuclear microreactor of claim 11, further comprising forming the at least one active core into at least two discrete sections with each discrete section having a unique Uranium-235 enrichment.
